(19) United States
(12) Patent Application Publication
(10) Pub. No.: US 2025/0126269 A1
(43) Pub. Date: Apr. 17, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Na ZHANG, Beijing (CN); Jizheng XU, Los Angeles, CA (US); Kai ZHANG, Los Angeles, CA (US); Mehdi SALEHIFAR, Los Angeles, CA (US); Li ZHANG, Los Angeles, CA (US)

(21) Appl. No.: 18/991,081

(22) Filed: Dec. 20, 2024

Related U.S. Application Data
(63) Continuation of application No. PCT/CN2023/101714, filed on Jun. 21, 2023.

(30) Foreign Application Priority Data
Jun. 21, 2022 (WO) PCT/CN2022/100260

(51) Int. Cl. H04N 19/139; H04N 19/103; H04N 19/147; H04N 19/176; H04N 19/184

(52) U.S. Cl. CPC H04N 19/139; H04N 19/103; H04N 19/147; H04N 19/176; H04N 19/184

(57) ABSTRACT

Embodiments of the present disclosure provide a solution for video processing. A method for video processing is proposed. The method comprises: determining, for a conversion between the current video block and a bitstream of the video, a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding the current video block; and performing the conversion based on the set of motion candidates.

### CROSS REFERENCE TO RELATED APPLICATIONS

This application is a continuation of International Application No. PCT/CN2023/101714, filed on Jun. 21, 2023, which claims the benefit of International Application No. PCT/CN2022/100260, filed on Jun. 21, 2022. The entire contents of these applications are hereby incorporated by reference in their entireties.

### FIELDS

Embodiments of the present disclosure relates generally to video processing techniques, and more particularly, to intra block copy (IBC) merge mode with block vector difference (MBVD).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between the current video block and a bitstream of the video, a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding the current video block; and performing the conversion based on the set of motion candidates.

According to the method in accordance with the first aspect of the present disclosure, the number of the set of motion candidates selected during the fast RDO process for subsequent process is limited by the upper limit value. Compared with the conventional solution without such an upper limit, the proposed method can advantageously reduce the complexity of subsequent process and thus improve the coding efficiency.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding a current video block of the video; and generating the bitstream based on the set of motion candidates.

In a fifth aspect, a method for storing a bitstream of a video is proposed. The method comprises: determining a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding a current video block of the video; generating the bitstream based on the set of motion candidates; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing example positions of spatial merge candidate;

FIG. 5 illustrates an example diagram showing candidate pairs considered for redundancy check of spatial merge candidates;

FIG. 6 illustrates an example diagram showing an example motion vector scaling for temporal merge candidate;

FIG. 7 illustrates an example diagram showing candidate positions for temporal merge candidate, C₀ and C₁;

FIG. 8 illustrates an example diagram showing VVC spatial neighboring blocks of the current block;

FIG. 9 illustrates an example virtual block in the ith search round;

FIG. 10 illustrates an example diagram showing spatial neighboring blocks used to derive the spatial merge candidates;

FIG. 11A illustrates spatial neighboring blocks used by SbTMVP;

FIG. 11B illustrates deriving sub-CU motion field by applying a motion shift from spatial neighbor and scaling the motion information from the corresponding collocated sub-CUs;

FIG. 12 illustrates current CTU processing order and available samples in current and left CTU;

FIG. 13 illustrates neighboring samples used for calculating SAD;

FIG. 14 illustrates neighboring samples used for calculating SAD for sub-CU level motion information;

FIG. 15 illustrates an example diagram showing a sorting process;

FIG. 16 illustrates an example diagram illustrating a reorder process in encoder;

FIG. 17 illustrates an example diagram illustrating a reorder process in decoder;

FIG. 18 illustrates an example diagram illustrating template matching performs on a search area around initial MV;

FIG. 19 illustrates an example diagram showing the template matching prediction;

FIG. 20 illustrates an example diagram showing intra template matching search area used;

FIG. 21 illustrates an example diagram showing template and its reference samples used in TIMD;

FIG. 22 illustrates an example diagram showing template and reference samples of the template;

FIG. 23 illustrates an example diagram showing template and reference samples of the template in reference list 0 and reference list 1;

FIG. 24 illustrates an example diagram showing template and reference samples of the template for block with sub-block motion using the motion information of the subblocks of current block;

FIG. 25 illustrates an example diagram showing template and reference samples of the template for block with sub-block motion using the motion information of each sub-template;

FIG. 26 illustrates an example diagram showing template and reference samples of the template for block with OBMC;

FIG. 27 illustrates an example diagram showing motion estimation for rectangular block with hash values for square subblocks;

FIG. 28 illustrates example luma mapping with chroma scaling architecture;

FIG. 29 illustrates MMVD search point;

FIG. 30A illustrates triangle partition based inter prediction where triangleDir is equal to 0;

FIG. 30B illustrates triangle partition based inter prediction where triangleDir is equal to 1;

FIG. 31 illustrates a uni-prediction MV selection for triangle partition mode;

FIG. 32 illustrates weights used in the blending process;

FIG. 33A illustrates three MV storage areas for triangleDir equal to 0 and a 32×16 block;

FIG. 33B illustrates three MV storage areas for triangleDir equal to 0 and a 16×32 block;

FIG. 33C illustrates three MV storage areas for triangleDir equal to 0 and a 32×32 block;

FIG. 34 illustrates examples of the GPM splits grouped by identical angles;

FIG. 35 illustrates a uni-prediction MV selection for geometric partitioning mode;

FIG. 36 illustrates exemplified generation of a bending weight w₀ using geometric partitioning mode;

FIG. 37 illustrates top and left neighboring blocks used in CIIP weight derivation;

FIG. 38A illustrates an example diagram showing candidate positions for spatial candidate;

FIG. 38B illustrates an example diagram showing candidate positions for temporal candidate;

FIG. 39 illustrates an example diagram showing deriving sub-CU by motion field from the corresponding collocated sub-CUs by applying a motion shift from spatial neighbor;

FIG. 40 illustrates an example diagram showing example intra template matching;

FIG. 41A illustrates an example diagram showing the reference template is outside the current picture;

FIG. 41B illustrates an example diagram showing clipping BV to make the reference template locating inside the current picture;

FIG. 42A illustrates an example implementation of adding diagonal angles;

FIG. 42B illustrates another example implementation of adding diagonal angles;

FIG. 42C illustrates a further example implementation of adding diagonal angles;

FIG. 43A illustrates an example implementation of adding diagonal angles with exact similar distance around a circle;

FIG. 43B illustrates another example implementation of adding diagonal angles with exact similar distance around a circle;

FIG. 44 illustrates some example implementations of adding arbitrary combination of steps and angles asymmetrically;

FIG. 45 illustrates some example implementations of removing every other distance offset;

FIG. 46 illustrates a schematic diagram of proposed MV based dependent direction offset;

FIG. 47 illustrates template and reference samples of the template for block with sub-block motion;

FIG. 48 illustrates template and reference samples of the template for full block;

FIG. 49 illustrates the adjacent spatial neighboring blocks used;

FIG. 50 illustrates top and left neighboring blocks used in CIIP_N1 and CIIP_N2 weight derivation;

FIG. 51 illustrates triangle partition based IBC prediction;

FIG. 52A illustrates a diamond search pattern;

FIG. 52B illustrates a cross search pattern;

FIG. 53 illustrates IBC reference region depending on current CU position;

FIG. 54 illustrates candidate BVP clipping at the IBC buffer boundaries;

FIG. 55 illustrates candidate BVPs selected to complete the IBC merge/AMVP list;

FIG. 56 illustrates the adjacent spatial neighboring blocks used;

FIG. 57 illustrates a cross search pattern;

FIG. 58 illustrates a flowchart of a method for video processing in accordance with embodiments of the present disclosure; and

FIG. 59 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

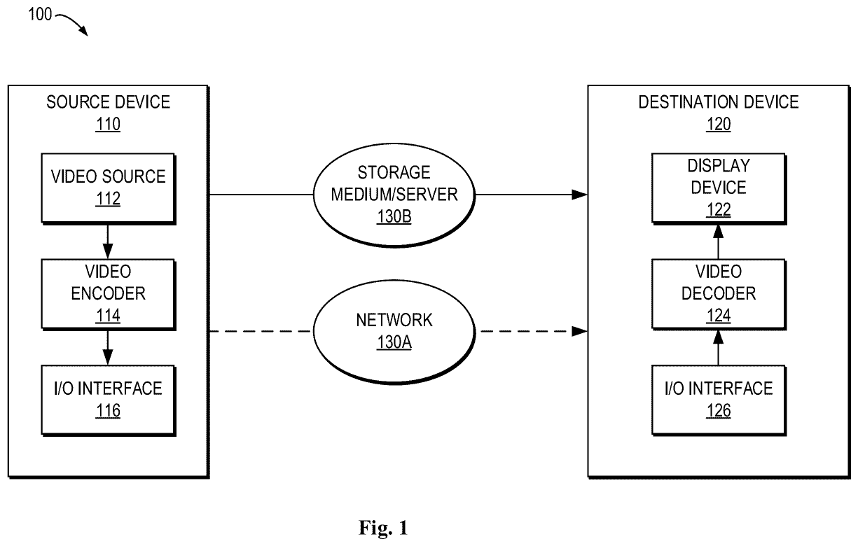

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

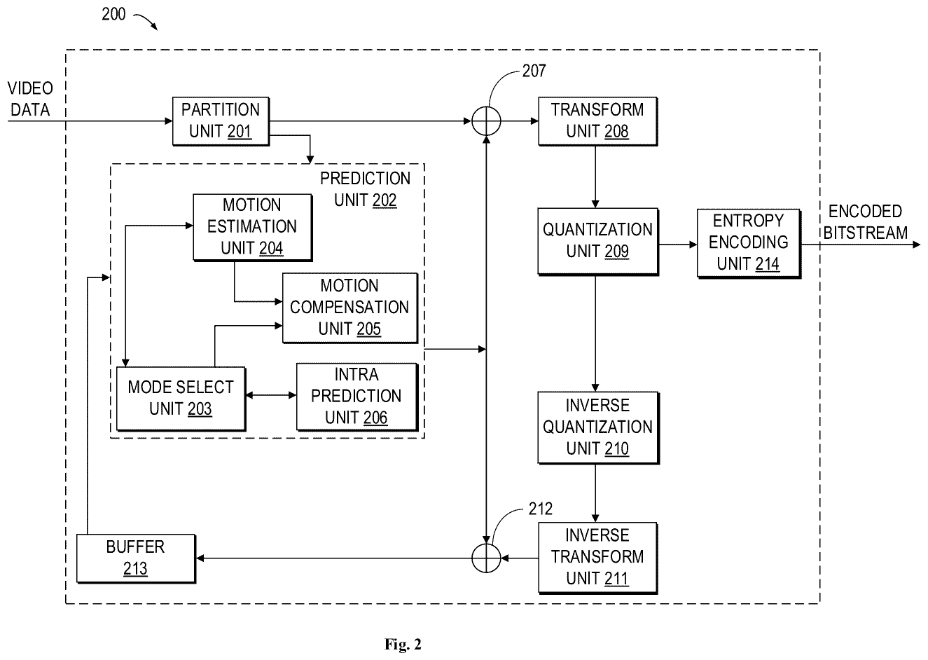

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

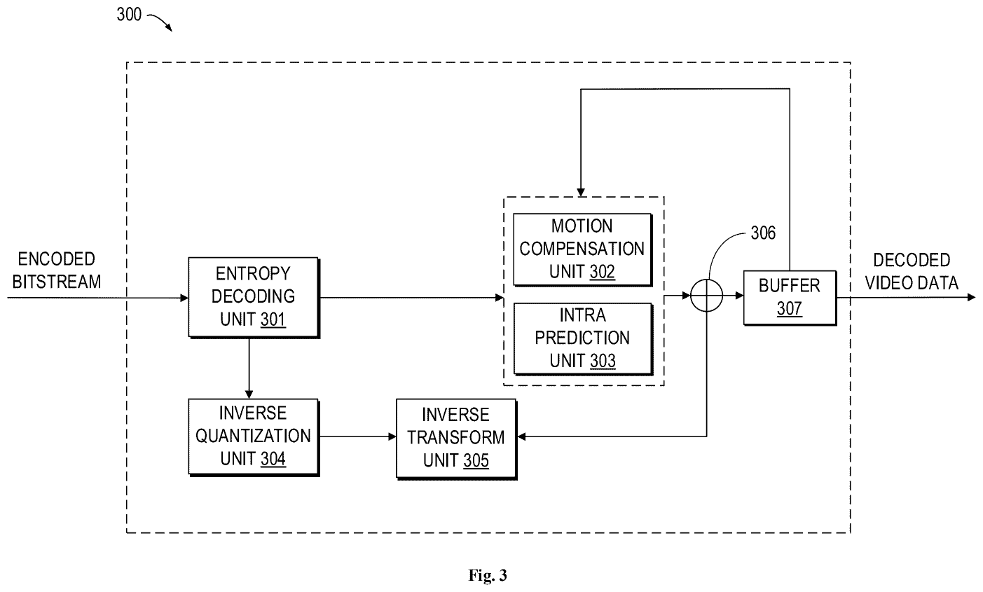

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about IBC prediction and related techniques in video coding. It may be applied to the existing video coding standard like HEVC, VVC, etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Extended Merge Prediction

In VVC, the merge candidate list is constructed by including the following five types of candidates in order:
1) Spatial MVP from spatial neighbour CUs;
2) Temporal MVP from collocated CUs;
3) History-based MVP from an FIFO table;
4) Pairwise average MVP;
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1 Spatial Candidates Derivation

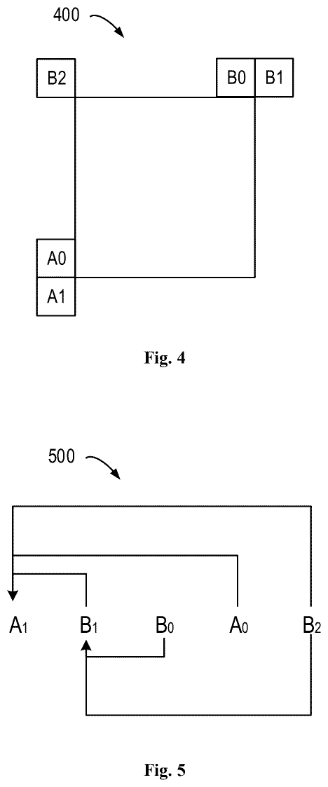

The derivation of spatial merge candidates in VVC is same to that in HEVC except the positions of first two merge candidates are swapped. A maximum of four merge candidates are selected among candidates located in the positions depicted in FIG. 4. The order of derivation is B₁, A₁ B₀, A₀, and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 5 are considered and a candidate is only added to the list if the corresponding candidate used for redundancy check has not the same motion information.

### 2.1.2 Temporal Candidates Derivation

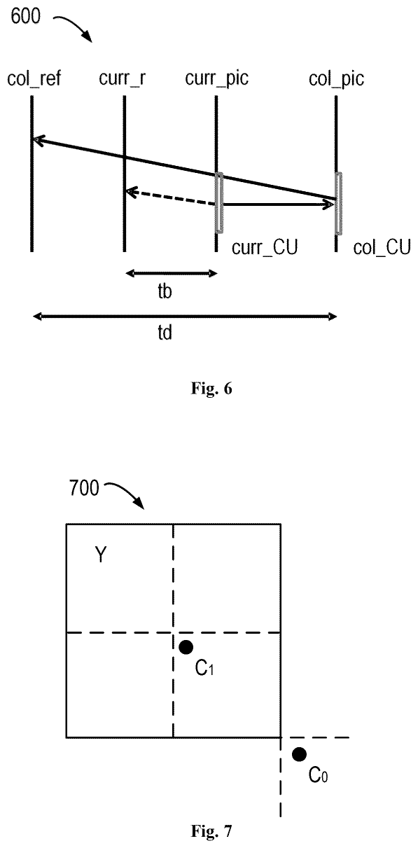

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 7. If CU at position C₀ is not available, is intra coded, or is outside of the current row of CTUs, position C₁ is used. Otherwise, position C₀ is used in the derivation of the temporal merge candidate.

### 2.1.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate. To reduce the number of redundancy check operations, the following simplifications are introduced:
1. Number of HMPV candidates is used for merge list generation is set as (N<=4) ?M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.2. New Merge Candidates

### 2.2.1 Non-Adjacent Merge Candidates Derivation

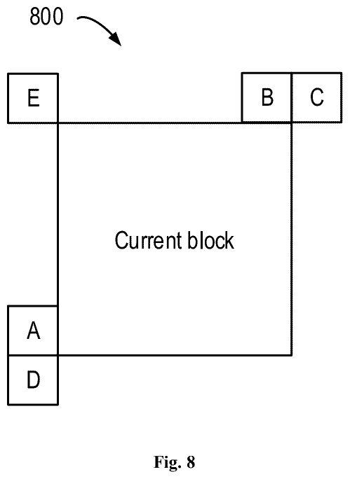

In VVC, five spatially neighboring blocks shown in FIG. 8 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

Offsetx=−i×gridX, Offsety=−i×gridY

where the Offsetx and Offsety denote the offset of the top-left corner of the virtual block relative to the top-left corner of the current block, gridX and gridY are the width and height of the search grid.

Second, the width and height of the virtual block are calculated by:

newWidth=i×2×gridX+currWidth newHeight=i×2×gridY+currHeight.

where the currWidth and currHeight are the width and height of current block. The newWidth and newHeight are the width and height of new virtual block.

gridX and gridY are currently set to currWidth and currHeight, respectively.

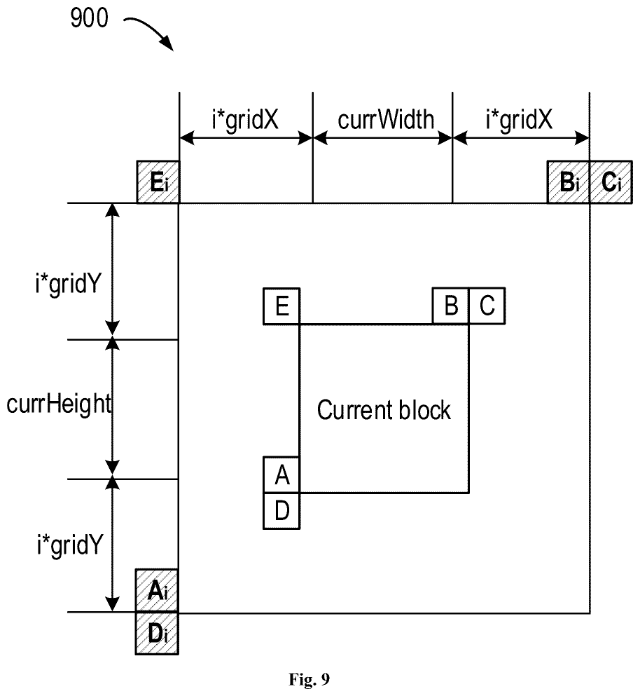

FIG. 9 illustrates the relationship between the virtual block and the current block.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.2.2 Non-Adjacent Spatial Candidate

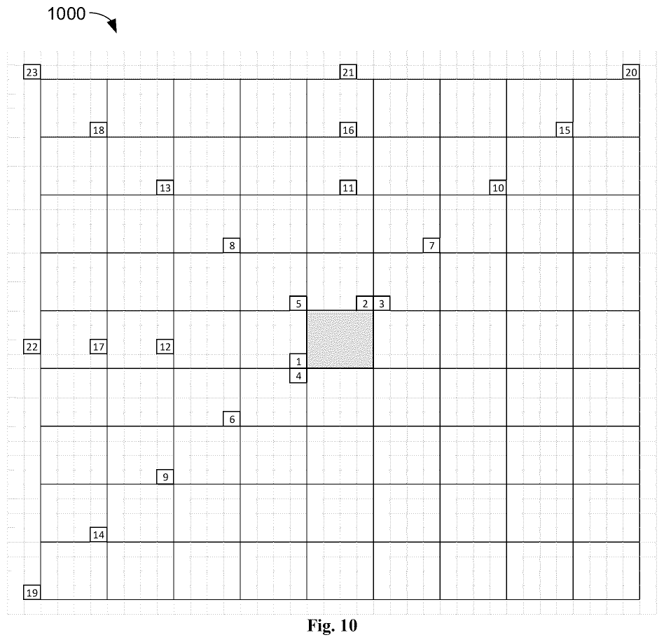

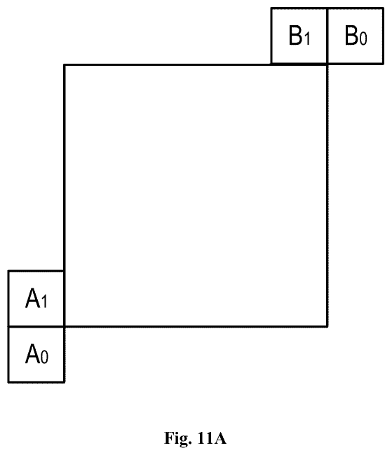

The non-adjacent spatial merge candidates are inserted after the TMVP in the regular merge candidate list. The pattern of spatial merge candidates is shown in FIG. 10. The distances between non-adjacent spatial candidates and current coding block are based on the width and height of current coding block. The line buffer restriction is not applied.

### 2.2.3 STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

mvLX=(mvLX_F+mvLX_S+mvLX_T+mvLX_Col)>>2.
2) If reference indices of three of the four merge candidates are valid and are equal to zero in prediction direction X (X=0 or 1),

mvLX=(mvLX_F×3+mvLX_S×3+mvLX_Col×2)>>3, or

mvLX=(mvLX_F×3+mvLX_T×3+mvLX_Col×2)>>3, or

mvLX=(mvLX_S×3+mvLX_T×3+mvLX_Col×2)>>3.
3) If reference indices of two of the four merge candidates are valid and are equal to zero in prediction direction X (X=0 or 1),

mvLX=(mvLX_F+mvLX_Col)>>1, or

mvLX=(mvLX_S+mvLX_Col)>>1, or

mvLX=(mvLX_T+mvLX_Col)>>1.

Note: If the temporal candidate is unavailable, the STMVP mode is off.

### 2.2.4 Merge List Size

If considering both non-adjacent and STMVP merge candidates, the size of merge list is signalled in sequence parameter set header and the maximum allowed size of merge list is increased (e.g. 8).

### 2.3. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

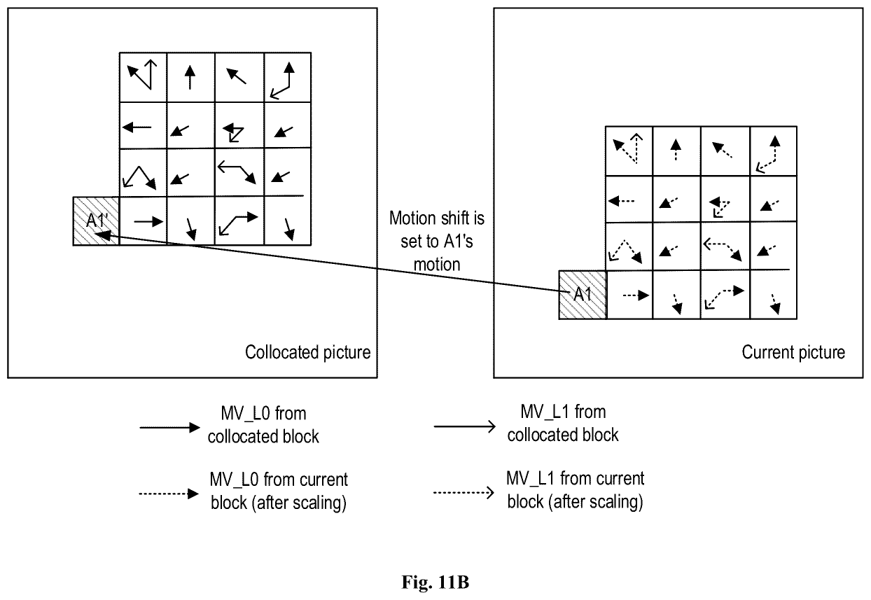

The SbTMVP process is illustrated in FIGS. 11A and 11B. SbTMVP predicts the motion vectors of the sub-CUs within the current CU in two steps. In the first step, the spatial neighbor A1 in FIG. 11A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU-level motion information (motion vectors and reference indices) from the collocated picture as shown in FIG. 11B. The example in FIG. 11B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

FIG. 11A illustrates spatial neighboring blocks used by SbTMVP, and FIG. 11B illustrates deriving sub-CU motion field by applying a motion shift from spatial neighbor and scaling the motion information from the corresponding collocated sub-CUs.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.4.1 Simplification of IBC Vector Prediction

The BV predictors for merge mode and AMVP mode in IBC will share a common predictor list, which consist of the following elements:
2 spatial neighboring positions (A0, B0 as in FIG. 1);
5 HMVP entries;
Zero vectors by default.

For merge mode, up to first 6 entries of this list will be used; for AMVP mode, the first 2 entries of this list will be used. And the list conforms with the shared merge list region requirement (shared the same list within the SMR).

### 2.4.2 IBC Reference Region

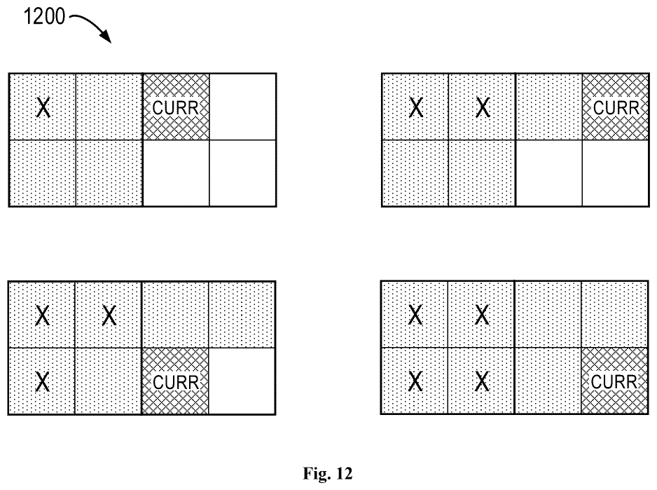

To reduce memory consumption and decoder complexity, the IBC in VVC allows only the reconstructed portion of the predefined area including the region of current CTU and some region of the left CTU. FIG. 12 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.4.3 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set
   ibcBuf[x % wIbcBuf][y % ctbSize]=recSample[x][y].

For a block covering the coordinates (x, y), if the following is true for a block vector bv=(bv[0], bv[1]), then it is valid; otherwise, it is not valid:

$$ibcBuf [ ( x + b v [ 0 ] ) \% wIbcBuf ] [ ( y + b v [ 1 ] ) \% ctbSize ] shall not be equal to - 1.$$

### 2.4.4 IBC Virtual Buffer Test

A luma block vector bvL (the luma block vector in 1/16 fractional-sample accuracy) shall obey the following constraints:
CtbSizeY is greater than or equal to ((yCb+(bvL[1]>>4)) & (CtbSizeY−1))+cbHeight.
IbcVirBuf[0][(x+(bvL[0]>>4)) & (IbcBufWidthY−1)][(y+(bvL[1]>>4)) & (CtbSizeY−1)] shall not be equal to −1 for x=xCb . . . xCb+cbWidth−1 and y=yCb . . . yCb+cbHeight−1.

Otherwise, bvL is considered as an invalid bv.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.5. Template Matching Based Adaptive Merge Candidate Reorder

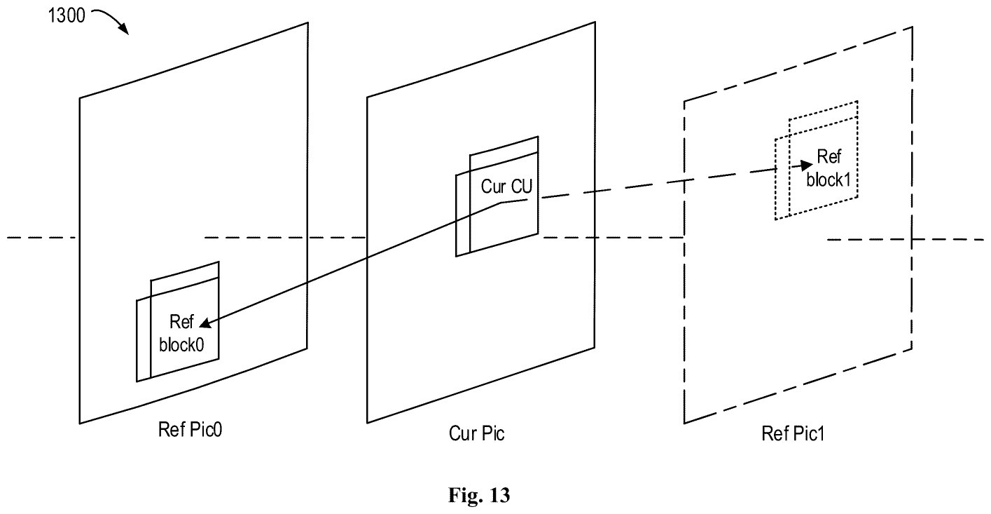

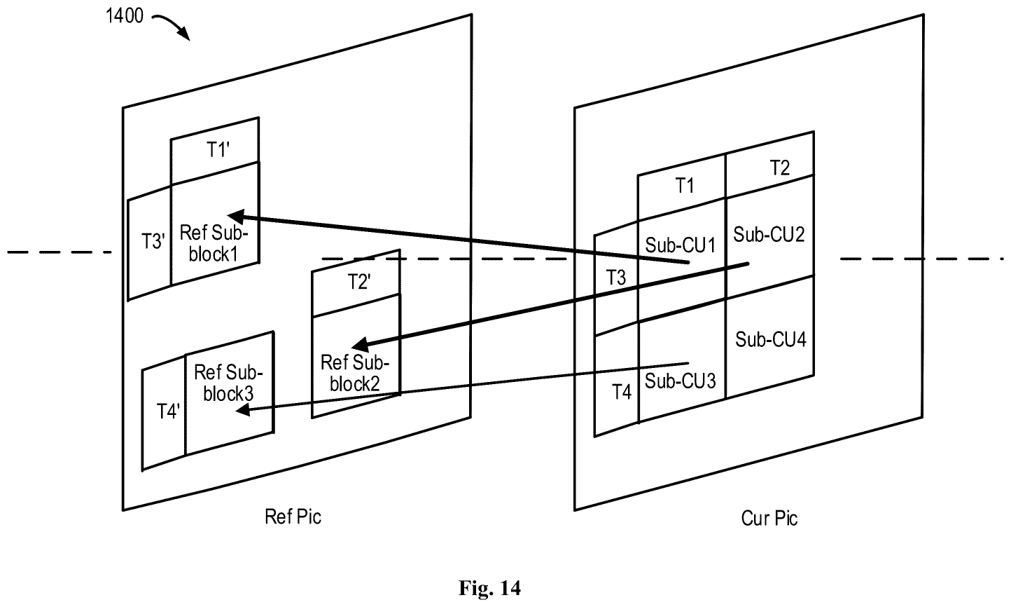

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group. The template matching cost is measured by the SAD (Sum of absolute differences) between the neighbouring samples of the current CU and their corresponding reference samples. If a merge candidate includes bi-predictive motion information, the corresponding reference samples are the average of the corresponding reference samples in reference list0 and the corresponding reference samples in reference list1, as illustrated in FIG. 13. If a merge candidate includes sub-CU level motion information, the corresponding reference samples consist of the neighbouring samples of the corresponding reference sub-blocks, as illustrated in FIG. 14.

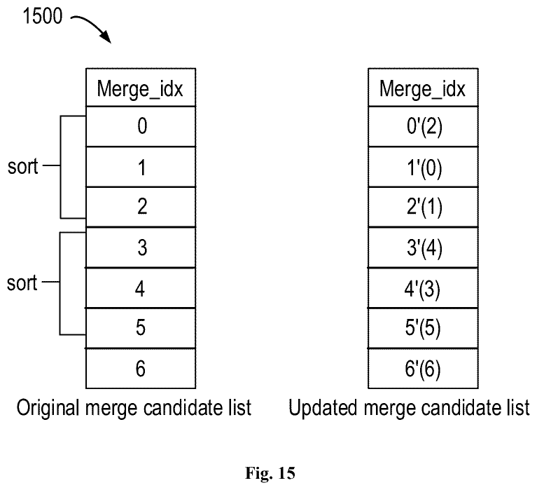

The sorting process is operated in the form of sub-group, as illustrated in FIG. 15. The first three merge candidates are sorted together. The following three merge candidates are sorted together.

The template size (width of the left template or height of the above template) is 1. The sub-group size is 3.

### 2.6. Adaptive Merge Candidate List

It is assumed that the number of the merge candidates is 8. Take the first 5 merge candidates as a first subgroup and take the following 3 merge candidates as a second subgroup (i.e. the last subgroup).

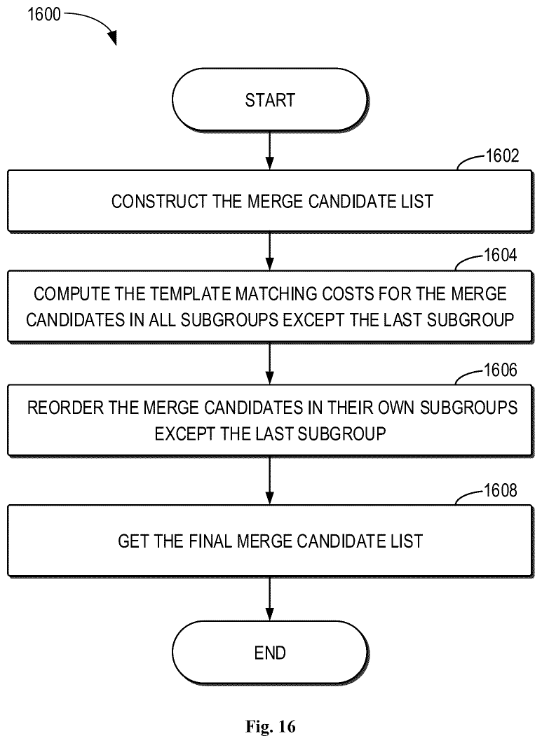

For the encoder, after the merge candidate list is constructed, some merge candidates are adaptively reordered in an ascending order of costs of merge candidates as shown in FIG. 16.

More specifically, the template matching costs for the merge candidates in all subgroups except the last subgroup are computed; then reorder the merge candidates in their own subgroups except the last subgroup; finally, the final merge candidate list will be got.

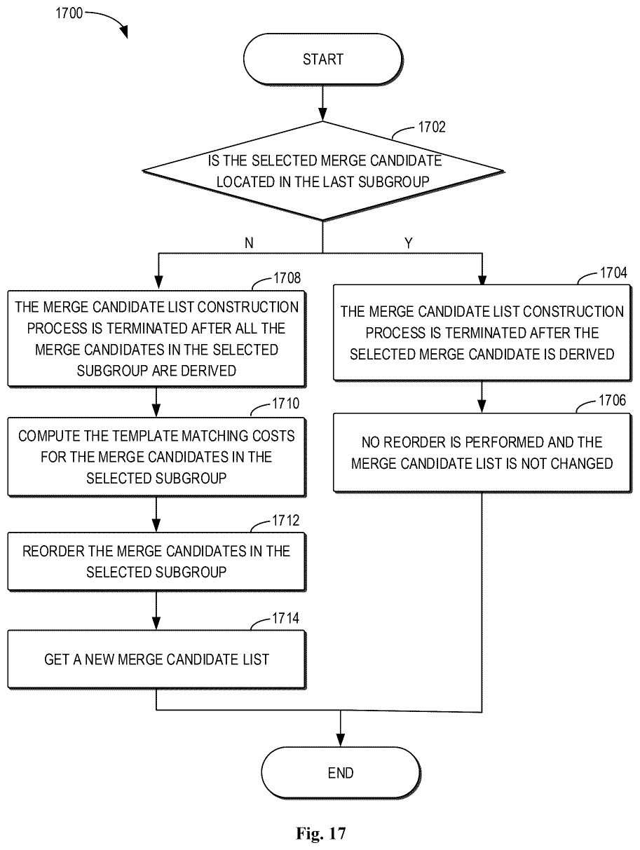

For the decoder, after the merge candidate list is constructed, some/no merge candidates are adaptively reordered in ascending order of costs of merge candidates as shown in FIG. 17. In FIG. 17, the subgroup the selected (signaled) merge candidate located in is called the selected subgroup.

More specifically, if the selected merge candidate is located in the last subgroup, the merge candidate list construction process is terminated after the selected merge candidate is derived, no reorder is performed and the merge candidate list is not changed; otherwise, the execution process is as follows.

The merge candidate list construction process is terminated after all the merge candidates in the selected subgroup are derived; compute the template matching costs for the merge candidates in the selected subgroup; reorder the merge candidates in the selected subgroup; finally, a new merge candidate list will be got.

For both encoder and decoder, a template matching cost is derived as a function of T and RT, wherein T is a set of samples in the template and RT is a set of reference samples for the template.

When deriving the reference samples of the template for a merge candidate, the motion vectors of the merge candidate are rounded to the integer pixel accuracy. It can also be derived using 8 tap or 12 tap luma interpolation filter.

The reference samples of the template (RT) for bi-directional prediction are derived by weighted averaging of the reference samples of the template in reference list0 (RT₀) and the reference samples of the template in reference list1 (RT₁) as follows.

$$R T = ( ( 8 - w ) * R {T}_{0} + w * R {T}_{1} + 4 ) ≫ 3$$

where the weight of the reference template in reference list0 (8−w) and the weight of the reference template in reference list1 (w) are decided by the BCW index of the merge candidate. BCW index equal to {0,1,2,3,4} corresponds to w equal to {−2,3,4,5,10}, respectively.

If the Local Illumination Compensation (LIC) flag of the merge candidate is true, the reference samples of the template are derived with LIC method.

The template matching cost is calculated based on the sum of absolute differences (SAD) of T and RT.

The template size is 1. That means the width of the left template and/or the height of the above template is 1.

If the coding mode is MMVD, the merge candidates to derive the base merge candidates are not reordered.

If the coding mode is GPM, the merge candidates to derive the uni-prediction candidate list are not reordered.

### 2.7. Template Matching (TM)

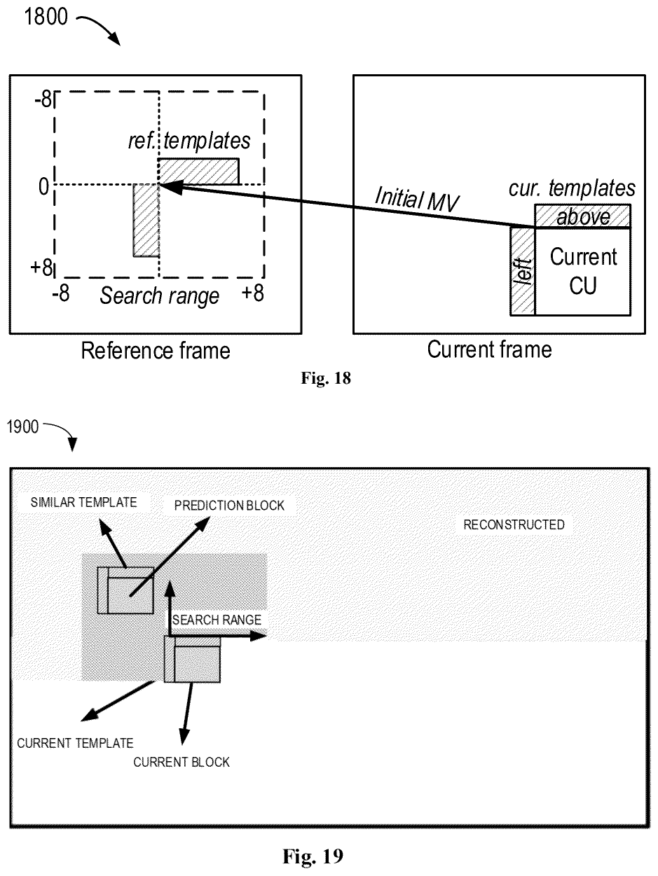

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 18, a better MV is to be searched around the initial motion of the current CU within a [−8, +8]-pel search range. The template matching that was previously proposed is adopted with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 2-1. This search process ensures that the MVP candidate still keeps the same MV precision as indicated by AMVR mode after TM process.

TABLE 2-1
Search patterns of AMVR and merge mode with AMVR.

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In merge mode, similar search method is applied to the merge candidate indicated by the merge index. As Table 2-1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

At encoder side, TM merge mode will do MV refinement for each merge candidate.

### 2.8. Intra Template Matching for IBC (TM_IBC)

Template matching prediction (TMP) is a special intra prediction mode that copies the best prediction block from the reconstructed part of the current frame, whose L-shaped templated matches the current template. This is illustrated in FIG. 19. For a predefined search range, the encoder searches for the most similar template to the current template in the reconstructed part of the current frame, and uses the corresponding block as a prediction block. The encoder then signals the usage of this mode, and the inverse operation is made at the decoder side.

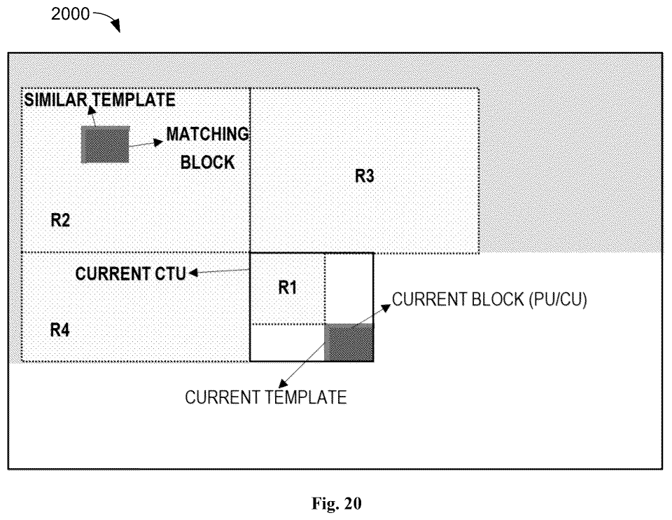

It is a coding tool that is mostly adapted for screen content coding. The prediction signal is generated at the decoder side by matching the L-shaped causal neighbor of the current block with another block in a predefined search area. This is illustrated in FIG. 20. Specifically, the search range is divided into 3 regions:
R1: within the current CTU;
R2: top-left outside the current CTU;
R3: above the current CTU;
R4: left to the current CTU.

Within each region, the decoder searches for the template the has least SAD with respect to the current one and uses its corresponding block as a prediction block.

The dimensions of all regions (SearchRange_w, SearchRange_h) are set proportional to the block dimension (BlkW, BlkH) in order to have a fixed number of SAD comparisons per pixel. That is:

$$SearchRange\_w = a * BlkW ;$$

$$SearchRange\_h = a * BlkH ;$$

where ‘a’ is a constant that controls the gain/complexity trade-off.

### 2.9. Template-Based Intra Mode Derivation Using MPMs

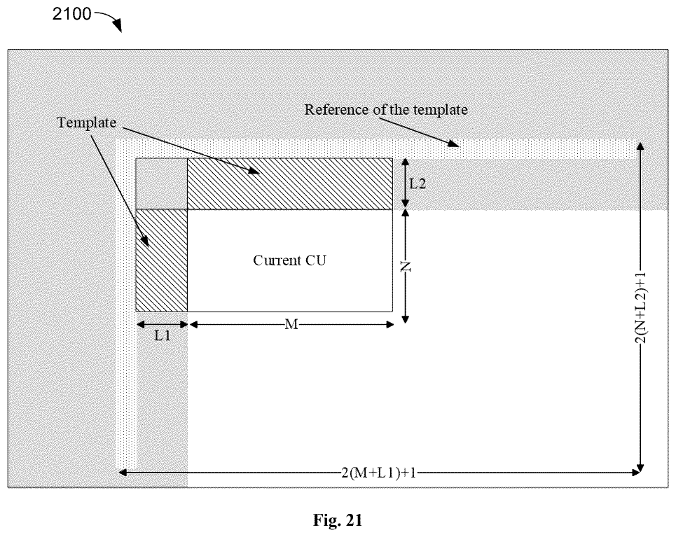

A TIMD mode is derived from MPMs using the neighbouring template. The TIMD mode is used as an additional intra prediction method for a CU. As shown in FIG. 21, the prediction samples of the template are generated using the reference samples of the template for each candidate mode. A cost is calculated as the sum of absolute transformed differences (SATD) between the prediction and the reconstruction samples of the template. The intra prediction mode with the minimum cost is selected as the TIMD mode and used for intra prediction of the CU.

### 2.9.1 TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) and gradient PDPC are supported in the derivation of the TIMD mode.

### 2.9.2 TIMD Signalling

A flag is signalled in sequence parameter set (SPS) to enable/disable TIMD. When the flag is true, a CU level flag is signalled to indicate whether TIMD is used for the CU. The TIMD flag is signalled right after the MIP flag. If the TIMD flag is equal to true, the remaining syntax elements related to luma intra prediction mode, is skipped.

2.9.3 Interaction with New Coding Tools in ECM-1.0

When DIMD flag or MIP flag is equal to true, the TIMD flag is not signalled and set equal to false.

TIMD is allowed to be combined with ISP and MRL. When TIMD is combined with ISP or MRL and the TIMD flag is equal to true, the derived TIMD mode is used as the intra prediction mode for ISP or MRL.

When the secondary MPM is enabled, both the primary MPMs and the secondary MPMs are used to derive the TIMD mode.

6-tap interpolation filter is not used in the derivation of the TIMD mode.

### 2.9.4 Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list.

### 2.10. Adaptive Merge Candidate List

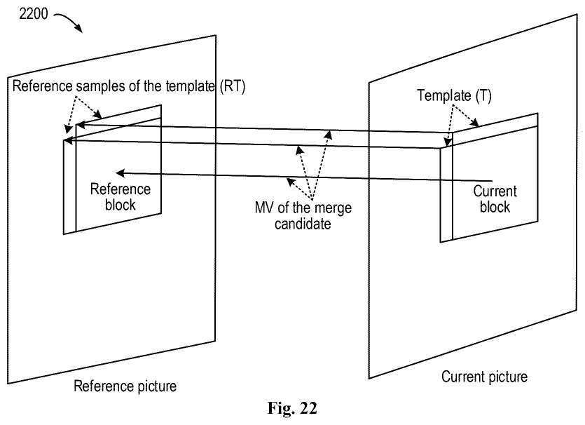

Hereinafter, template is a set of reconstructed samples adjacently or non-adjacently neighboring to the current block. Reference samples of the template are derived according to the same motion information of the current block. For example, reference samples of the template are mapping of the template depend on a motion information. In this case, reference samples of the template are located by a motion vector of the motion information in a reference picture indicated by the reference index of the motion information. FIG. 22 shows an example, wherein RT represents the reference samples of the template T.

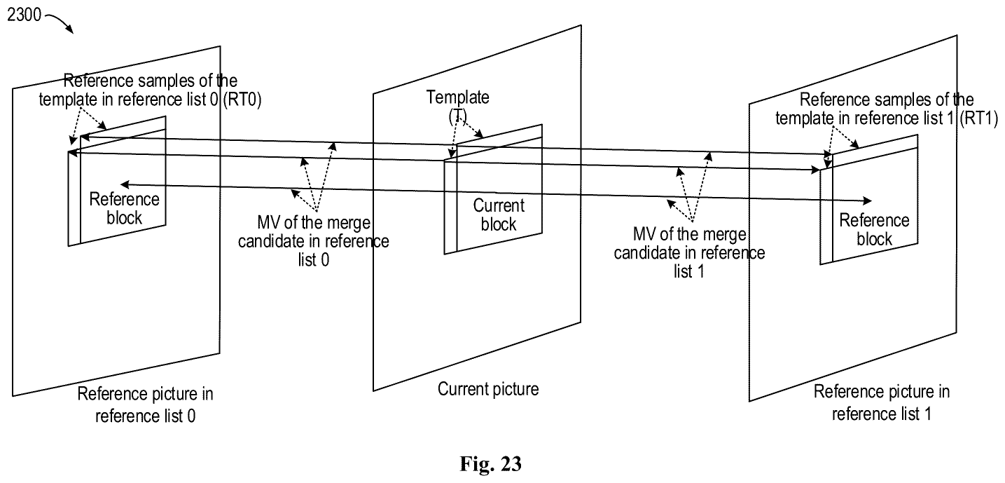

When a merge candidate utilizes bi-directional prediction, the reference samples of the template of the merge candidate are denoted by RT and RT may be generated from RT₀ which are derived from a reference picture in reference picture list 0 and RT₁ derived from a reference picture in reference picture list 1. In one example, RT₀ includes a set of reference samples on the reference picture of the current block indicated by the reference index of the merge candidate referring to a reference picture in reference list 0 with the MV of the merge candidate referring to reference list 0), In one example, RT₁ includes a set of reference samples on the reference picture of the current block indicated by the reference index of the merge candidate referring to a reference picture in reference list 1 with the MV of the merge candidate referring to reference list 1). An example is shown in FIG. 23.

In one example, the reference samples of the template (RT) for bi-directional prediction are derived by equal weighted averaging of the reference samples of the template in reference list0 (RT₀) and the reference samples of the template in reference list1 (RT₁). One example is as follows:

$$R T = ( R {T}_{0} + R {T}_{1} + 1 ) ≫ 1$$

In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$R T = ( ( {2}^{N} - w ) * R {T}_{0} + w * {RT}_{1} + {2}^{N - 1} ) ≫ N , for example , N = 3 .$$

In one example, the weight of the reference template in reference list0 such as (8−w) and the weight of the reference template in reference list1 such as (w) maybe decided by the BCW index of the merge candidate.

The merge candidates can be divided to several groups according to some criterions. Each group is called a subgroup. For example, take adjacent spatial and temporal merge candidates as a first subgroup and take the remaining merge candidates as a second subgroup; In another example, take the first N (N≥2) merge candidates as a first subgroup, take the following M (M≥2) merge candidates as a second subgroup, and take the remaining merge candidates as a third subgroup. Note that the proposed methods may be applied to merge candidate list construction process for inter coded blocks (e.g., translational motion), affine coded blocks; or other motion candidate list construction process (e.g., AMVP list; IBC AMVP list; IBC merge list).

W and H are the width and height of current block (e.g., luma block). Taking merge candidate list construction process as an example in the following descriptions:
1. The merge candidates can be adaptively rearranged in the final merge candidate list according to one or some criterions.
   a. In one example, partial or full process of current merge candidate list construction process is firstly invoked, followed by the reordering of candidates in the list.
      i. Alternatively, candidates in a first subgroup may be reordered and they should be added before those candidates in a second subgroup wherein the first subgroup is added before the second subgroup.
         (i) In one example, multiple merge candidates for a first category may be firstly derived and then reordered within the first category; then merge candidates from a second category may be determined according to the reordered candidates in the first category (e.g., how to apply pruning).
      ii. Alternatively, a first merge candidate in a first category may be compared to a second merge candidate in a second category, to decide the order of the first or second merge candidate in the final merge candidate list.
   b. In one example, the merge candidates may be adaptively rearranged before retrieving the merge candidates.
      i. In one example, the procedure of arranging merge candidates adaptively may be processed before the obtaining the merge candidate to be used in the motion compensation process.
   c. In one example, if the width of current block is larger than the height of current block, the above candidate is added before the left candidate.
   d. In one example, if the width of current block is smaller than the height of current block, the above candidate is added after the left candidate.
   e. Whether merge candidates are rearranged adaptively may depend on the selected merging candidate or the selected merging candidate index.
      i. In one example, if the selected merging candidate is in the last sub-group, the merge candidates are not rearranged adaptively.
   f. In one example, a merge candidate is assigned with a cost, the merge candidates are adaptively reordered in an ascending order of costs of merge candidates.
      i. In one example, the cost of a merge candidate may be a template matching cost.
      ii. In one example, template is a set of reconstructed samples adjacently or non-adjacently neighboring to the current block.
      iii. A template matching cost is derived as a function of T and RT, wherein T is a set of samples in the template and RT is a set of reference samples for the template.
         (i) How to obtain the reference samples of the template for a merge candidate may depend on the motion information of the merge candidate
         a) In one example, when deriving the reference samples of the template, the motion vectors of the merge candidate are rounded to the integer pixel accuracy, where the integer motion vector may be its nearest integer motion vector.
         b) In one example, when deriving the reference samples of the template, N-tap interpolation filtering is used to get the reference samples of the template at sub-pixel positions. For example, N may be 2, 4, 6, or 8.
         c) In one example, when deriving the reference samples of the template, the motion vectors of the merge candidates may be scaled to a given reference picture (e.g., for each reference picture list if available).
         d) For example, the reference samples of the template of a merge candidate are obtained on the reference picture of the current block indicated by the reference index of the merge candidate with the MVs or modified MVs (e.g., according to bullets a)-b)) of the merge candidate as shown in FIG. 22.
         e) For example, when a merge candidate utilizes bi-directional prediction, the reference samples of the template of the merge candidate are denoted by RT and RT may be generated from RT₀ which are derived from a reference picture in reference picture list 0 and RT₁ derived from a reference picture in reference picture list 1.
         [1] In one example, RT₀ includes a set of reference samples on the reference picture of the current block indicated by the reference index of the merge candidate referring to a reference picture in reference list 0 with the MV of the merge candidate referring to reference list 0).
         [2] In one example, RT₁ includes a set of reference samples on the reference picture of the current block indicated by the reference index of the merge candidate referring to a reference picture in reference list 1 with the MV of the merge candidate referring to reference list 1).
         [3] An example is shown in FIG. 23.
         f) In one example, the reference samples of the template (RT) for bi-directional prediction are derived by equal weighted averaging of the reference samples of the template in reference list0 (RT₀) and the reference samples of the template in reference list1 (RT₁). One example is as follows:

$$R T = ( R {T}_{0} + R {T}_{1} + 1 ) ≫ 1.$$

g) In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$R T = ( ( {2}^{N} - w ) * R {T}_{0} + w * {RT}_{1} + {2}^{N - 1} ) ≫ N , for example , N = 3 .$$

h) In one example, the weight of the reference template in reference list0 such as (8−w) and the weight of the reference template in reference list1 such as (w) maybe decided by the BCW index of the merge candidate.
[1] In one example, BCW index is equal to 0, w is set equal to −2.
[2] In one example, BCW index is equal to 1, w is set equal to 3.
[3] In one example, BCW index is equal to 2, w is set equal to 4.
[4] In one example, BCW index is equal to 3, w is set equal to 5.
[5] In one example, BCW index is equal to 4, w is set equal to 10.
i) In one example, if the Local Illumination Compensation (LIC) flag of the merge candidate is true, the reference samples of the template are derived with LIC method.
(ii) The cost may be calculated based on the sum of absolute differences (SAD) of T and RT.
a) Alternatively, the cost may be calculated based on the sum of absolute transformed differences (SATD) of T and RT.
b) Alternatively, the cost may be calculated based on the sum of squared differences (SSD) of T and RT.
c) Alternatively, the cost may be calculated based on weighted SAD/weighted SATD/weighted SSD.
(iii) The cost may consider the continuity (Boundary_SAD) between RT and reconstructed samples adjacently or non-adjacently neighboring to T in addition to the SAD calculated in (ii). For example, reconstructed samples left and/or above adjacently or non-adjacently neighboring to T are considered.
a) In one example, the cost may be calculated based on SAD and Boundary_SAD.
[1] In one example, the cost may be calculated as (SAD+w*Boundary_SAD). w may be pre-defined, or signaled or derived according to decoded information.
2. Whether to and/or how to reorder the merge candidates may depend on the category of the merge candidates.
   a. In one example, only adjacent spatial and temporal merge candidates can be reordered.
   b. In one example, only adjacent spatial, STMVP, and temporal merge candidates can be reordered.
   c. In one example, only adjacent spatial, STMVP, temporal and non-adjacent spatial merge candidates can be reordered.
   d. In one example, only adjacent spatial, STMVP, temporal, non-adjacent spatial and HMVP merge candidates can be reordered.
   e. In one example, only adjacent spatial, STMVP, temporal, non-adjacent spatial, HMVP and pair-wise average merge candidates can be reordered.
   f. In one example, only adjacent spatial, temporal, HMVP and pair-wise average merge candidates can be reordered.
   g. In one example, only adjacent spatial, temporal, and HMVP merge candidates can be reordered.
   h. In one example, only adjacent spatial merge candidates can be reordered.
   i. In one example, only the first subgroup can be reordered.
   j. In one example, the last subgroup can not be reordered.
   k. In one example, only the first N merge candidates can be reordered.
      i. In one example, N is set equal to 5.
   l. In one example, for the candidates not to be reordered, they will be arranged in the merge candidate list according to the initial order.
   m. In one example, candidates not to be reordered may be put behind the candidates to be reordered.
   n. In one example, candidates not to be reordered may be put before the candidates to be reordered.
   o. In one example, a combination of some of the above items (a-k) can be reordered.
   p. Different subgroups may be reordered separately.
   q. Two candidates in different subgroups cannot be compared and/or reordered.
   r. A first candidate in a first subgroup must be put ahead of a second candidate in a second subgroup after reordering if the first subgroup is ahead of a second subgroup.
3. Whether to and/or how to reorder the merge candidates may depend on the coding mode.
   a. In one example, if the coding mode is regular merge mode, the merge candidates can be reordered.
   b. In one example, if the coding mode is MMVD, the merge candidates to derive the base merge candidates are not reordered.
      i. Alternatively, the reordering method may be different for the MMVD mode and other merge modes.
   c. In one example, if the coding mode is CIIP, the merge candidates used forcombination with intra prediction are based on the reordered merge candidates.
      i. Alternatively, the reordering method may be different for the CIIP mode and other merge modes.
   d. In one example, if the coding mode is GPM, the merge candidates to derive the uni-prediction candidate list are not reordered.
      i. Alternatively, the reordering method may be different for the GPM mode and other merge modes.
   e. In one example, if the coding mode is a triangle partition mode, the merge candidates to derive the uni-prediction candidate list are not reordered.
      i. Alternatively, the reordering method may be different for the triangular mode and other merge modes.
   f. In one example, if the coding mode is a subblock based merge mode, partial or full subblock based merge candidates are reordered.
      i. Alternatively, the reordering method may be different for the subblock based merge mode and other merge modes.
      ii. In one example, the uni-prediction subblock based merge candidates are not reordered.
      iii. In one example, the SbTMVP candidate is not reordered.
      iv. In one example, the constructed affine candidates are not reordered.
      v. In one example, the zero padding affine candidates are not reordered.
4. Whether to and/or how to reorder the merge candidates may depend on the available number of adjacent spatial and/or STMVP and/or temporal merge candidates.
5. Whether the merge candidates need to be reordered or not may depend on decoded information (e.g., the width and/or height of the CU).
   a. In one example, if the height is larger than or equal to M, the width is larger than or equal to N, and width*height is larger than or equal to R, the merge candidates can be reordered.
      i. In one example, M, N, and R are set equal to 8, 8, and 128.
      ii. In one example, M, N, and R are set equal to 16, 16, and 512.
   b. In one example, if the height is larger than or equal to M and the width is larger than or equal to N, the merge candidates can be reordered.
      i. In one example, M and N are set equal to 8 and 8.
      ii. In one example, M and N are set equal to 16 and 16.
6. The subgroup size can be adaptive.
   a. In one example, the subgroup size is decided according to the available number of adjacent spatial and/or STMVP and/or temporal merge candidates denoted as N.
      i. In one example, if N is smaller than M and larger than Q, the subgroup size is set to N;
      ii. In one example, if N is smaller than or equal to Q, no reordering is performed;
      iii. In one example, if N is larger than or equal to M, the subgroup size is set to M.
      iv. In one example, M and Q are set equal to 5 and 1, respectively.
         (i) Alternatively, M and/or Q may be pre-defined, or signaled or derived according to decoded information.
   b. In one example, the subgroup size is decided according to the available number of adjacent spatial and temporal merge candidates denoted as N.
      i. In one example, if N is smaller than M and larger than Q, the subgroup size is set to N;
      ii. In one example, if N is smaller than or equal to Q, no reorder is performed;
      iii. In one example, if N is larger than or equal to M, the subgroup size is set to M.
      iv. In one example, M and Q are set equal to 5 and 1, respectively.
7. The template shape can be adaptive.
   a. In one example, the template may only comprise neighboring samples left to the current block.
   b. In one example, the template may only comprise neighboring samples above to the current block.
   c. In one example, the template shape is selected according to the CU shape.
   d. In one example, the width of the left template is selected according to the CU height.
      i. For example, if H<=M, then the left template size is w1×H; otherwise, the left template size is w2×H.
   e. In one example, M, w1, and w2 are set equal to 8, 1, and 2, respectively.
   f. In one example, the height of the above template is selected according to the CU width.
      i. For example, if W<=N, then the above template size is W×h1; otherwise, the above template size is W×h2.
         (i) In one example, N, h1, and h2 are set equal to 8, 1, and 2, respectively.
   g. In one example, the width of the left template is selected according to the CU width.
      i. For example, if W<=N, then the left template size is w1×H; otherwise, the left template size is w2×H.
         (i) In one example, N, w1, and w2 are set equal to 8, 1, and 2, respectively.
   h. In one example, the height of the above template is selected according to the CU height.
      i. For example, if H<=M, then the above template size is W×h1; otherwise, the above template size is W×h2.
         (i) In one example, M, h1, and h2 are set equal to 8, 1, and 2, respectively.
   i. In one example, samples of the template and the reference samples of the template samples may be subsampled or downsampled before being used to calculate the cost.
      i. Whether to and/or how to do subsampling may depend on the CU dimensions.
      ii. In one example, no subsampling is performed for the short side of the CU.
8. In above examples, the merge candidate is one candidate which is included in the final merge candidate list (e.g., after pruning).
   a. Alternatively, the merge candidate is one candidate derived from a given spatial or temporal block or HMVP table or with other ways even it may not be included in the final merge candidate list.
9. The template may comprise samples of specific color component(s).
   a. In one example, the template only comprises samples of the luma component.
10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.11. Adaptive Motion Candidate List

1. The motion candidates in a motion candidate list of a block can be adaptively rearranged to derive the reordered motion candidate list according to one or some criterions, and the block is encoded/decoded according to the reordered motion candidate list.
   a. The motion candidates in a motion candidate list of a block which is not a regular merge candidate list can be adaptively rearranged to derive the reordered motion candidate list according to one or some criterions.
   b. In one example, whether to and/or how to reorder the motion candidates may depend on the coding mode (e.g. affine merge, affine AMVP, regular merge, regular AMVP, GPM, TPM, MMVD, TM merge, CIIP, GMVD, affine MMVD).
   c. In one example, whether to and/or how to reorder the motion candidates may depend on the category (e.g., spatial, temporal, STMVP, HMVP, pair-wise, SbTMVP, constructed affine, inherited affine) of the motion candidates.
   d. In one example, the motion candidate list may be the AMVP candidate list.
   e. In one example, the motion candidate list may be the merge candidate list.
   f. In one example, the motion candidate list may be the affine merge candidate list.
   g. In one example, the motion candidate list may be the sub-block-based merge candidate list.
   h. In one example, the motion candidate list may be the GPM merge candidate list.
   i. In one example, the motion candidate list may be the TPM merge candidate list.
   j. In one example, the motion candidate list may be the TM merge candidate list.
   k. In one example, the motion candidate list may be the candidate list for MMVD coded blocks.
   l. In one example, the motion candidate list may be the candidate list for DMVR coded blocks.
2. How to adaptively rearrange motion candidates in a motion candidate list may depend on the decoded information, e.g., the category of a motion candidate, a category of a motion candidate list, a coding tool.
   a. In one example, for different motion candidate lists, different criteria may be used to rearrange the motion candidate list.
      i. In one example, the criteria may include how to select the template.
      ii. In one example, the criteria may include how to calculate the template cost.
      iii. In one example, the criteria may include how many candidates and/or how many sub-groups in a candidate list need to be reordered.
   b. In one example, the motion candidates in a motion candidate list are firstly adaptively rearranged to construct a fully rearranged candidate list or partially rearranged candidate list, and at least one motion candidate indicated by at least one index is then retrieved from the rearranged candidate list to derive the final motion information to be used by the current block.
   c. In one example, the motion candidates before refinement (e.g., using TM for TM coded blocks; adding MVD for MMVD coded blocks) are firstly adaptively rearranged to construct a fully rearranged candidate list or partially rearranged candidate list. Then at least one motion candidate indicated by at least one index is retrieved from the rearranged candidate list, and refinement (e.g., using TM for TM coded blocks; adding MVD for MMVD coded blocks) is applied to the retrieved one to derive the final motion information for the current block.
   d. In one example, refinement (e.g., using TM for TM coded blocks; adding MVD for MMVD coded blocks) is applied to at least one of the motion candidates in a motion candidate list, then they are adaptively rearranged to construct a fully rearranged candidate list or partially rearranged candidate list, and at least one motion candidate indicated by at least one index is then retrieved from the rearranged candidate list to derive final the motion information without any further refinement for the current block.
3. In one example, new MERGE/AMVP motion candidates may be generated based on the candidates reordering.
   i. For example, L0 motion and L1 motion of the candidates may be reordered separately.
   ii. For example, new bi-prediction merge candidates may be constructed by combining one from the reordered L0 motion and the other from the reordered L1 motion.
   iii. For example, new uni-prediction merge candidates may be generated by the reordered L0 or L1 motion.

### 2.12. Adaptive Motion Candidate List

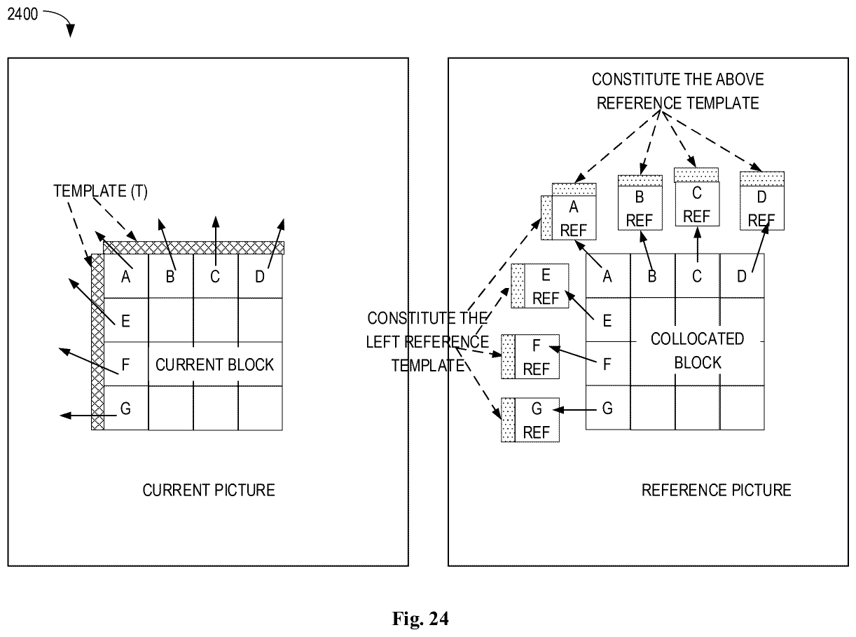

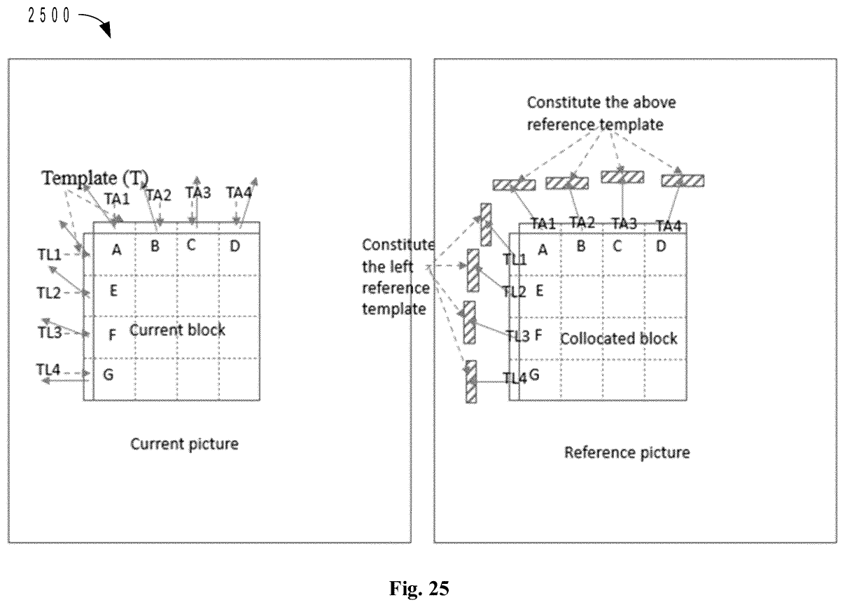

For subblock motion prediction, if the subblock size is Wsub*Hsub, the height of the above template is Ht, the width of the left template is Wt, the above template can be treated as a constitution of several sub-templates with the size of Wsub*Ht, the left template can be treated as a constitution of several sub-templates with the size of Wt*Hsub. After deriving the reference samples of each sub-template in the above similar way, the reference samples of the template are derived. Two examples are shown in FIG. 24 and FIG. 25.

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).
1. In one example, if the coding mode is TM merge, partial or full TM merge candidates may be reordered.
   a. In one example, if the coding mode is TM merge, the partial or full original TM merge candidates may be reordered, before the TM refinement process.
   b. Alternatively, if the coding mode is TM merge, the partial or full refined TM merge candidates may be reordered, after the TM refinement process.
   c. Alternatively, if the coding mode is TM merge, the TM merge candidates may not be reordered.
   d. Alternatively, the reordering method may be different for the TM merge mode and other merge modes.
2. In one example, if the coding mode is a subblock based merge mode, partial or full subblock based merge candidates may be reordered.
   a. Alternatively, the reordering method may be different for the subblock based merge mode and other merge modes.
   b. In one example, a template may be divided into sub-templates. Each sub-template may possess an individual piece of motion information.
      i. In one example, the cost used to reorder the candidates may be derived based on the cost of each sub-template. For example, the cost used to reorder the candidates may be calculated as the sum of the costs of all sub-templates. For example, the cost for a sub-template may be calculated as SAD, SATD, SSD or any other distortion measurement between the sub-template and its corresponding reference sub-template.
   c. In one example, to derive the reference samples of a sub-template, the motion information of the subblocks in the first row and the first column of current block may be used.
      i. In one example, the motion information of a sub-template may be derived (e.g. copied) from its adjacent sub-block in the current block. An example is shown in FIG. 24.
   d. In one example, to derive the reference samples of a sub-template, the motion information of the sub-template may be derived without referring to motion information of a sub-block in the current block. An example is shown in FIG. 25.
      i. In one example, the motion information of each sub-template is calculated according to the affine model of current block.
         (i) In one example, the motion vector of the center sample of each subblock containing a sub-template calculated according to the affine model of current block is treated as the motion vector of the sub-template.
         (ii) In one example, the motion vector of the center sample of each sub-template calculated according to the affine model of current block is treated as the motion vector of the sub-template.
         (iii) For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix}$$

(iv) For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix}$$

(v) For (iii) and (iv), the coordinates of above-left, above-right, and bottom-left corner of current block are (0,0), (W,0) and (0,H), the motion vectors of above-left, above-right, and bottom-left corner of current block are (mv₀ₓ, mv_{0y}), (mv₁ₓ, mv_{1y}) and (mv₂ₓ, mv_{2y}).
(vi) In one example, the coordinate (x, y) in the above equations may be set equal to a position in the template, or a position of a sub-template. E.g., the coordinate (x, y) may be set equal to a center position of a sub-template.
e. In one example, this scheme may be applied to affine merge candidates.
f. In one example, this scheme may be applied to affine AMVP candidates.
g. In one example, this scheme may be applied to SbTMVP merge candidate.
h. In one example, this scheme may be applied to GPM merge candidates.
i. In one example, this scheme may be applied to TPM merge candidates.
j. In one example, this scheme may be applied to TM-refinement merge candidates.
k. In one example, this scheme may be applied to DMVR-refinement merge candidates.
l. In one example, this scheme may be applied to MULTI_PASS_DMVR-refinement merge candidates.
3. In one example, if the coding mode is MMVD, the merge candidates to derive the base merge candidates may be reordered.
   a. In one example, the reordering process may be applied on the merge candidates before the merge candidates is refined by the signaled or derived MVD(s).
   b. For example, the reordering method may be different for the MMVD mode and other merge modes.
4. In one example, if the coding mode is MMVD, the merge candidates after the MMVD refinement may be reordered.
   a. In one example, the reordering process may be applied on the merge candidates after the merge candidates is refined by the signaled or derived MVD(s).
   b. For example, the reordering method may be different for the MMVD mode and other merge modes.
5. In one example, if the coding mode is affine MMVD, the merge candidates to derive the base merge candidates may be reordered.
   a. In one example, the reordering process may be applied on the merge candidates before the affine merge candidates is refined by the signaled or derived MVD(s).
   b. For example, the reordering method may be different for the affine MMVD mode and other merge modes.
6. In one example, if the coding mode is affine MMVD, the merge candidates after the affine MMVD refinement may be reordered.
   a. In one example, the reordering process may be applied on the affine merge candidates after the merge candidates is refined by the signaled or derived MVD(s).
   b. For example, the reordering method may be different for the affine MMVD mode and other merge modes.
7. In one example, if the coding mode is GMVD, the merge candidates to derive the base merge candidates may be reordered.
   a. In one example, the reordering process may be applied on the merge candidates before the merge candidates is refined by the signaled or derived MVD(s).
   b. For example, the reordering method may be different for the GMVD mode and other merge modes.
8. In one example, if the coding mode is GMVD, the merge candidates after the GMVD refinement may be reordered.
   a. In one example, the reordering process may be applied on the merge candidates after the merge candidates is refined by the signaled or derived MVD(s).
   b. For example, the reordering method may be different for the GMVD mode and other merge modes.
9. In one example, if the coding mode is GPM, the merge candidates may be reordered.
   a. In one example, the reordering process may be applied on the original merge candidates before the merge candidates are used to derive the GPM candidate list for each partition (a.k.a. the uni-prediction candidate list for GPM).
   b. In one example, if the coding mode is GPM, the merge candidates in the uni-prediction candidate list may be reordered.
   c. In one example, the GPM uni-prediction candidate list may be constructed based on the reordering.
      i. In one example, a candidate with bi-prediction (a.k.a. bi-prediction candidate) may be separated into two uni-prediction candidates.
         (i) If the number of original merge candidates is M, at most 2M uni-prediction candidates may be separated from them.
      ii. In one example, uni-prediction candidates separated from a bi-prediction candidate may be put into an initial uni-prediction candidate list.
      iii. In one example, candidates in the initial uni-prediction candidate list may be reordered with the template matching costs.
      iv. In one example, the first N uni-prediction candidates with smaller template matching costs may be used as the final GPM uni-prediction candidates. As an example, N is equal to M.
   d. In one example, after deriving a GPM uni-prediction candidate list, a combined bi-prediction list for partition 0 and partition 1 is constructed, then the bi-prediction list is reordered.
      i. In one example, if the number of GPM uni-prediction candidates is M, the number of combined bi-prediction candidates is M*(M−1).
   e. Alternatively, the reordering method may be different for the GPM mode and other merge modes.

### 2.13. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).
1. The reference samples of a template or sub-template (RT) for bi-directional prediction are derived by equal weighted averaging of the reference samples of the template or sub-template in reference list0 (RT₀) and the reference samples of the template or sub-template in reference list1 (RT₁). One example is as follows:

$$R T ( x , y ) = ( R {T}_{0} ( x , y ) + R {T}_{1} ( x , y ) + 1 ) ≫ 1$$

2. The reference samples of a template or sub-template (RT) for bi-directional prediction are derived by weighted averaging of the reference samples of the template or sub-template in reference list0 (RT₀) and the reference samples of the template or sub-template in reference list1 (RT₁).
   a. One example is as follows:

$$R T ( x , y ) = ( ( {2}^{N} - w ) * R {T}_{0} ( x , y ) + w * R {T}_{1} ( x , y ) + {2}^{N - 1} ) ≫ N , for example , N = 3 .$$

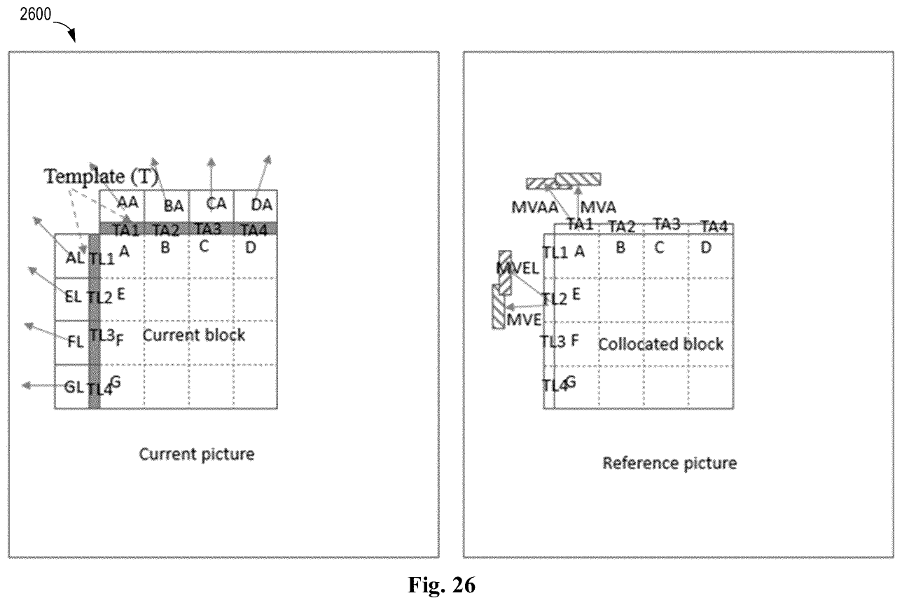

b. The weights may be determined by the BCW index or derived on-the-fly or pre-defined or by the weights used in weighted prediction.
c. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.
3. It is proposed that the reference samples of the template may be derived with LIC method.
   a. In one example, the LIC parameters for both left and above templates are the same as the LIC parameters of current block.
   b. In one example, the LIC parameters for left template are derived as the LIC parameters of current block which uses its original motion vector plus a motion vector offset of (−Wt,0) as the motion vector of current block.
   c. In one example, the LIC parameters for above template are derived as the LIC parameters of current block which uses its original motion vector plus a motion vector offset of (0, −Ht) as the motion vector of current block.
   d. Alternatively, furthermore, the above bullets may be applied if the Local Illumination Compensation (LIC) flag of a merge candidate is true.
4. It is proposed that the reference samples of the template or sub-template may be derived with OBMC method. In the following discussion, a “template” may refer to a template or a sub-template.
   a. In one example, to derive the reference samples of the above template, the motion information of the subblocks in the first row of current block and their above adjacent neighboring subblocks are used. And the reference samples of all the sub-templates constitute the reference samples of the above template. An example is shown in FIG. 26.
   b. In one example, to derive the reference samples of the left template, the motion information of the subblocks in the first column of current block and their left adjacent neighboring subblocks are used. And the reference samples of all the sub-templates constitute the reference samples of the left template. An example is shown in FIG. 26.
   c. In one example, the subblock size is 4×4.
   d. The reference samples of a sub-template based on motion vectors of a neighbouring subblock is denoted as PN, with N indicating an index for the neighbouring above and left subblocks and the reference samples of a sub-template based on motion vectors of a subblock of current block is denoted as Pc. For PN generated based on motion vectors of vertically (horizontally) neighbouring sub-block, samples in the same row (column) of PN are added to Pc with a same weighting factor.
      i. The reference samples of a sub-template (P) may be derived as P=WN*PN+Wc*Pc.
      ii. In one example, the weighting factors {¼, ⅛, 1/16, 1/32} are used for the {first, second, third, fourth} row (column) of PN and the weighting factors {¾, ⅞, 15/16, 31/32} are used for the {first, second, third, fourth}row (column) of Pc if the height of the above template or the width of the left template is larger than or equal to 4.
      iii. In one example, the weighting factors {¼, ⅛} are used for the {first, second}row (column) of PN and the weighting factors {¾, ⅞} are used for the {first, second} row (column) of Pc if the height of the above template or the width of the left template is larger than or equal to 2.
      iv. In one example, the weighting factor {¼} is used for the first row (column) of P_{N} and the weighting factor {¾} is used for the first row (column) of P_{C} if the height of the above template or the width of the left template is larger than or equal to 1.
   e. The above bullets may be applied if a merge candidate is assigned with OBMC enabled.
5. In one example, if a merge candidate uses multi-hypothesis prediction, the reference samples of the template may be derived with multi-hypothesis prediction method.
6. The template may comprise samples of specific color component(s).
   a. In one example, the template only comprises samples of the luma component.
   b. Alternatively, the template only comprises samples of any component such as Cb/Cr/R/G/B.
7. Whether to and/or how to reorder the motion candidates may depend on the category of the motion candidates.
   a. In one example, only adjacent spatial and temporal motion candidates can be reordered.
   b. In one example, only adjacent spatial, STMVP, and temporal motion candidates can be reordered.
   c. In one example, only adjacent spatial, STMVP, temporal and non-adjacent spatial motion candidates can be reordered.
   d. In one example, only adjacent spatial, STMVP, temporal, non-adjacent spatial and HMVP motion candidates can be reordered.
   e. In one example, only adjacent spatial, STMVP, temporal, non-adjacent spatial, HMVP and pair-wise average motion candidates can be reordered.
   f. In one example, only adjacent spatial, temporal, HMVP and pair-wise average motion candidates can be reordered.
   g. In one example, only adjacent spatial, temporal, and HMVP motion candidates can be reordered.
   h. In one example, only adjacent spatial motion candidates can be reordered.
   i. In one example, the uni-prediction subblock based motion candidates are not reordered.
   j. In one example, the SbTMVP candidate is not reordered.
   k. In one example, the inherited affine motion candidates are not reordered.
   l. In one example, the constructed affine motion candidates are not reordered.
   m. In one example, the zero padding affine motion candidates are not reordered.
   n. In one example, only the first N motion candidates can be reordered.
      i. In one example, N is set equal to 5.
8. In one example, the motion candidates may be divided into subgroups. Whether to and/or how to reorder the motion candidates may depend on the subgroup of the motion candidates.
   a. In one example, only the first subgroup can be reordered.
   b. In one example, the last subgroup can not be reordered.
   c. In one example, the last subgroup can not be reordered. But if the last subgroup also is the first subgroup, it can be reordered.
   d. Different subgroups may be reordered separately.
   e. Two candidates in different subgroups cannot be compared and/or reordered.
   f. A first candidate in a first subgroup must be put ahead of a second candidate in a second subgroup after reordering if the first subgroup is ahead of a second subgroup.
9. In one example, the motion candidates which are not included in the reordering process may be treated in specified way.
   a. In one example, for the candidates not to be reordered, they will be arranged in the merge candidate list according to the initial order.
   b. In one example, candidates not to be reordered may be put behind the candidates to be reordered.
   c. In one example, candidates not to be reordered may be put before the candidates to be reordered.
10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.14. Cost Function Utilized in Coding Data Refinement in Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).

In the following discussion, Shift(x, s) is defined as:

Shift(x, s)=(x+offset)>>s, wherein offset is an integer such as offset=0 or offset=1<<(s−1) or offset=(1<<(s−1))−1.

In another example, offset depends on x. For example, offset=(x<0 ?(1<<(s−1)):((1<<(s−1)−1).
1. In addition to the error measurement, it is proposed to add a regulation item in the cost calculation process.
   a) In one example, the cost is defined as: E+W*RI wherein the E represents the output of an error function, W is the weight applied to the regulation item denoted by RI.
      i. In one example, for processing the template-based-coded block/bilateral-based-coded block, the cost function is set to: E+W*RI wherein E may be SAD/MRSAD/SATD or others, RI is the estimated bits for motion vectors/motion vector differences, W is a weight, e.g., which may rely on QP/temporal layer etc. al.
      ii. Alternatively, the cost is defined as: w0*E+W1*RI wherein the E represents the output of an error function, W1 is the weight applied to the regulation item denoted by RI, w0 is the weight applied to the output of the error function.
         (i) Alternatively, furthermore, W1 may be set to 0.
   b) In one example, the regulation item is multiplied by a weighted rate.
      i. In one example, the weight is derived on-the-fly.
      ii. In one example, the weight is set to lambda used in the full RDO process
      iii. In one example, the weight is set to a square root of the lambda used in the full RDO process.
   c) In one example, the cost is calculated as E+Shift(W*RI, s), wherein s and W are integers.
      i. Alternatively, the cost is calculated as Shift((E<<s)+W*RI, s), wherein s and W are integers.
2. It is proposed to use an error function different from SAD/MR-SAD (mean removal sum of absolute difference) for processing a template-based-coded block/bilateral-based-coded block.
   a) In one example, the error function may be:
      i. SATD;
      ii. MR-SATD;
      iii. Gradient information;
      iv. SSE/SSD;
      v. MR-SSE/MR-SSD;
      vi. Weighted SAD/weighted MR-SAD;
      vii. Weighted SATD/weighted MR-SATD;
      viii. Weighted SSD/weighted MR-SSD;
      ix. Weighted SSE/weighted MR-SSE.
   b) Alternatively, furthermore, it is proposed to adaptively select the error function among different cost functions such as the above mentioned error functions and SAD/MR-SAD.
      i. The selection may be determined on-the-fly.
3. When using the MR-X (e.g., X being SATD, SAD, SSE) based error function (e.g., MR-SAD/MR-SATD etc. al), the following may further apply:
   a) In one example, the mean may be calculated with all samples in a block to be compared taken into consideration.
   b) In one example, the mean may be calculated with partial samples in a block to be compared taken into consideration.
   c) In one example, the mean and the X function may depend on same samples in a block.
      i. In one example, the mean and X function may be calculated with all samples in the block.
      ii. In one example, the mean and X function may be calculated with partial samples in the block.
   d) In one example, the mean and the X function may depend on at least one different samples in a block.
      i. In one example, the mean may be calculated with all samples while the X function may depend on partial samples in the block.
      ii. In one example, the mean may be calculated with partial samples while the X function may depend on all samples in the block.
4. The template/bilateral matching cost may be calculated by applying a cost factor to the error cost function.
   a) In one example, it is proposed to favor the motion candidates ahead during the template/bilateral matching based reordering process.
      i. In one example, the motion candidate in the ith position is assigned with a smaller cost factor than the cost factor of the motion candidate in the (i+1)th position.
      ii. In one example, the motion candidates in the ith group (e.g. involve M motion candidates) are assigned with a smaller cost factor than the cost factor of the motion candidates in the (i+1)th group (e.g. involve N motion candidates).
         (i) In one example, M may be equal to N. For example, M=N=2.
         (ii) In one example, M may be not equal to N. For example, M=2, N=3.
   b) In one example, it is proposed to favor the searching MVs closer to original MV during the template/bilateral matching based refinement process
      i. In one example, each search region is assigned with a cost factor, which may be determined by the distance (e.g. delta MV in integer pixel precision) between each searching MV in the search region and the starting MV.
      ii. In one example, each search region is assigned with a cost factor, which may be determined by the distance (e.g. delta MV in integer pixel precision) between the center searching MV in the search region and the starting MV.
      iii. In one example, each searching MV is assigned with a cost factor, which may be determined by the distance (e.g. delta MV in integer pixel precision) between each searching MV and the starting MV.
5. The above methods may be applied to any coding data refinement process, e.g., for a template-based-coded block, for a bilateral-based-coded block (e.g., DMVR in VVC).
6. The template matching cost measurement may be different for different template matching refinement methods.
   a. In one example, the template matching refinement method may be template matching based motion candidate reordering.
   b. In one example, the template matching refinement method may be template matching based motion derivation.
      i. In one example, the refinement method may be TM AMVP, TM merge, and/or FRUC.
   c. In one example, the template matching refinement method may be template matching based motion refinement.
      ii. In one example, the refinement method may be TM GPM, TM CIIP, and/or TM affine.
   d. In one example, the template matching refinement method may be template matching based block vector derivation.
   e. In one example, the template matching refinement method may be template matching based intra mode derivation.
      iii. In one example, the refinement method may be DIMD and/or TIMD.
   f. In one example, the template matching cost measure may be calculated based on the sum of absolute differences (SAD) between the current and reference templates.
   g. In one example, the template matching cost measure may be calculated based on the mean-removal SAD between the current and reference templates.
   h. In one example, SAD and mean-removal SAD (MR-SAD) might be selectively utilized according to the size of the current block.
      i. In one example, mean-removal SAD is used for the block with size larger than M and SAD is used for the block with size smaller than or equal to M.
         (i) In one example, M is 64.
   i. In one example, SAD and mean-removal SAD (MR-SAD) might be selectively utilized according to the LIC flag of the current block.
      i. In one example, the template matching cost measure may be SAD if the LIC flag of the current block is false.
      ii. In one example, the template matching cost measure may be MR-SAD if the LIC flag of the current block is true.
   j. In one example, the template matching cost measure may be calculated based on the sum of absolute transformed differences (SATD) between the current and reference templates.
   k. In one example, the template matching cost measure may be calculated based on the mean-removal SATD between the current and reference templates.
   l. In one example, SATD and mean-removal SATD (MR-SATD) might be selectively utilized according to the size of the current block.
      i. In one example, mean-removal SATD is used for the block with size larger than M and SATD is used for the block with size smaller than or equal to M.
         (i) In one example, M is 64.
   m. In one example, SATD and mean-removal SATD (MR-SATD) might be selectively utilized according to the LIC flag of the current block.
      i. In one example, the template matching cost measure may be SATD if the LIC flag of the current block is false.
      ii. In one example, the template matching cost measure may be MR-SATD if the LIC flag of the current block is true.
   n. In one example, the template matching cost measure may be calculated based on the sum of squared differences (SSD) between the current and reference templates.
   o. In one example, the template matching cost measure may be calculated based on the mean-removal SSD between the current and reference templates.
   p. In one example, SSD and mean-removal SSD (MR-SSD) might be selectively utilized according to the size of the current block.
      i. In one example, mean-removal SSD is used for the block with size larger than M and SSD is used for the block with size smaller than or equal to M.
         (i) In one example, M is 64.
   q. In one example, the template matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the current and reference templates.
      i. In one example, the weighted means applying different weights to each sample based on its row and column indices in template block when calculating the distortion between the current and reference templates.
      ii. In one example, the weighted means applying different weights to each sample based on its positions in template block when calculating the distortion between the current and reference templates.
      iii. In one example, the weighted means applying different weights to each sample based on its distances to current block when calculating the distortion between the current and reference templates.
   r. In one example, the template matching cost may be calculated as a form of tplCost=w1*mvDistanceCost+w2*distortionCost.
      i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the current and reference templates.
      ii. In one example, mvDistanceCost may be the sum of absolute my differences of searching point and starting point in horizontal and vertical directions.
      iii. In one example, w1 and w2 may be pre-defined, or signaled or derived according to decoded information.
         (i) In one example, w1 is a weighting factor set to 4, w2 is a weighting factor set to 1.
   s. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
      i. In one example, the cost may be calculated based on SAD and Boundary_SAD.
         (i) In one example, the cost may be calculated as (SAD+w*Boundary_SAD). w may be pre-defined, or signaled or derived according to decoded information.
7. The bilateral matching cost measurement may be different for different bilateral matching refinement methods.
   a) In one example, the bilateral matching refinement method may be bilateral matching based motion candidate reordering.
   b) In one example, the bilateral matching refinement method may be bilateral matching based motion derivation.
      i. In one example, the refinement method may be BM merge and/or FRUC.
   c) In one example, the bilateral matching refinement method may be bilateral matching based motion refinement.
      i. In one example, the refinement method may be BM GPM, BM CIIP, and/or BM affine.
   d) In one example, the bilateral matching refinement method may be bilateral matching based block vector derivation.
   e) In one example, the bilateral matching refinement method may be bilateral matching based intra mode derivation.
   f) In one example, the bilateral matching cost measure may be calculated based on the sum of absolute differences (SAD) between the two reference blocks/subblocks.
   g) In one example, the bilateral matching cost measure may be calculated based on the mean-removal SAD between the two reference blocks/subblocks.
   h) In one example, SAD and mean-removal SAD (MR-SAD) might be selectively utilized according to the size of the current block/subblock.
      i. In one example, mean-removal SAD is used for the block/subblock with size larger than M and SAD is used for the block/subblock with size smaller than or equal to M.
         (i) In one example, M is 64.
   i) In one example, SAD and mean-removal SAD (MR-SAD) might be selectively utilized according to the LIC flag of the current block.
      i. In one example, the bilateral matching cost measure may be SAD if the LIC flag of the current block is false.
      ii. In one example, the bilateral matching cost measure may be MR-SAD if the LIC flag of the current block is true.
   j) In one example, the bilateral matching cost measure may be calculated based on the sum of absolute transformed differences (SATD) between the two reference blocks/subblocks.
   k) In one example, the bilateral matching cost measure may be calculated based on the mean-removal SATD between the two reference blocks/subblocks.
   l) In one example, SATD and mean-removal SATD (MR-SATD) might be selectively utilized according to the size of the current block/subblock.
      i. In one example, mean-removal SATD is used for the block/subblock with size larger than M and SATD is used for the block/subblock with size smaller than or equal to M.
         (i) In one example, M is 64.
   m) In one example, SATD and mean-removal SATD (MR-SATD) might be selectively utilized according to the LIC flag of the current block.
      i. In one example, the bilateral matching cost measure may be SATD if the LIC flag of the current block is false.
      ii. In one example, the bilateral matching cost measure may be MR-SATD if the LIC flag of the current block is true.
   n) In one example, the bilateral matching cost measure may be calculated based on the sum of squared differences (SSD) between the two reference blocks/subblocks.
   o) In one example, the bilateral matching cost measure may be calculated based on the mean-removal SSD between the two reference blocks/subblocks.
   p) In one example, SSD and mean-removal SSD (MR-SSD) might be selectively utilized according to the size of the current block/subblock.
      i. In one example, mean-removal SSD is used for the block/subblock with size larger than M and SSD is used for the block/subblock with size smaller than or equal to M.
         (i) In one example, M is 64.
   q) In one example, SSD and mean-removal SSD (MR-SSD) might be selectively utilized according to the LIC flag of the current block.
      i. In one example, the bilateral matching cost measure may be SSD if the LIC flag of the current block is false.
      ii. In one example, the bilateral matching cost measure may be MR-SSD if the LIC flag of the current block is true.
   r) In one example, the bilateral matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the two reference blocks/subblocks.
      i. In one example, the weighted means applying different weights to each sample based on its row and column indices in reference block/subblock when calculating the distortion between the two reference blocks/subblocks.
      ii. In one example, the weighted means applying different weights to each sample based on its positions in reference block/subblock when calculating the distortion between the two reference blocks/subblocks.
      iii. In one example, the weighted means applying different weights to each sample based on its distances to center position of reference block/subblock when calculating the distortion between the two reference blocks/subblocks.
   s) In one example, if MR-SAD/MR-SATD/MR-SSD is used for the bilateral matching cost measure, LIC may be not used when deriving the reference blocks/subblocks.
   t) In one example, the bilateral matching cost may be calculated as a form of bilCost=w1*mvDistanceCost+w2*distortionCost.
      i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the two reference blocks/subblocks.
      ii. In one example, mvDistanceCost may be the sum of absolute my differences of searching point and starting point in horizontal and vertical directions.
      iii. In one example, w1 and w2 may be pre-defined, or signaled or derived according to decoded information.
         (i) In one example, w1 is a weighting factor set to 4, w2 is a weighting factor set to 1.
8. The bilateral or template matching cost may be calculated based on prediction/reference samples which are modified by a function.
   a) In one example, the prediction/reference samples may be filtered before being used to calculate the bilateral or template matching cost.
   b) In one example, a prediction/reference sample S may be modified to be a*S+b before being used to calculate the bilateral or template matching cost.
   c) In one example, the modification may depend on the coding mode of the block, such as whether the block is LIC-coded or BCW-coded.

### 2.15. Usage of Multiple Cost Functions in Coding Data Refinement in Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).
1. The cost definition may rely on outputs of multiple errors functions (e.g., distortion measurement methods) regarding the error/difference of two samples/blocks to be evaluated in one coding data refinement process of a current block.
   a) In one example, the error function may be:
      i. SAD;
      ii. SATD;
      iii. MR-SAD;
      iv. MR-SATD;
      v. Gradient information;
      vi. SSE/SSD;
      vii. MR-SSE/MR-SSD;
      viii. Weighted SAD/weighted MR-SAD;
      ix. Weighted SATD/weighted MR-SATD;
      x. Weighted SSD/weighted MR-SSD;
      xi. Weighted SSE/weighted MR-SSE.
   b) In one example, the error function may be performed in block level or sub-block level.
      i. Alternatively, furthermore, for two sub-blocks, the error function may be different.
      ii. Alternatively, furthermore, the final output of the evaluated error of a block may be based on the outputs of sub-blocks, e.g., sum of outputs of error functions applied to each sub-block.
2. When the cost definition relies on outputs of multiple functions, the following may further apply:
   a) In one example, the cost function may rely on a linear weighted sum of multiple error functions.
   b) In one example, the cost function may rely on a non-linear weighted sum of multiple error functions.
   c) In one example, the cost function may further rely on estimated bits for side information.
   d) In one example, the cost function may be defined as:

$$C = R + {\sum }_{i = 0}^{N - 1} {W}_{i} * {E}_{i}$$

wherein R denotes the estimated bits for side information, Wᵢ and Eᵢ represent the weight applied to the i-th error function and output of the i-th error function, respectively.
3. Multiple refinement processes may be applied to one block with at least more than two different cost functions applied to at least two refinement processes.
   a) In one example, a first refinement process may be invoked with a first cost function. Based on the output of the first refinement process, a second cost function is further applied to the second refinement process.
   b) The above methods may be applied to the template-based-coded blocks.
4. Whether to use multiple refinement process, and/or how to select one or multiple error function and/or how to define the cost function and/or which samples to be involved in the error function may depend on the decoded information of a current block and/or its neighboring (adjacent or non-adjacent) blocks.
   a) In one example, how to select one or multiple error function and/or how to define the cost function may depend on the coding tool applied to current block and/or its neighboring blocks.
      i. In one example, the coding tool is the LIC.
         (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
         (ii) In one example, if MR-SAD/MR-SATD/MR-SSD is used for the template matching cost measure, the linear function used in LIC process may be not used when deriving the reference template.
         (iii) In one example, if MR-SAD/MR-SATD/MR-SSD is used for the bilateral matching cost measure, the linear function used in LIC process may be not used when deriving the reference block.
   b) In one example, it may depend on block dimension, temporal layer, low delay check flag, etc. al.
   c) In one example, it may depend on whether the motion information of current and neighboring block is similar/identical.
   d) In one example, it may depend on reference picture list and/or reference picture information.
      i. In one example, for list X, a first error function (e.g., SAD/SSE) may be used, and for list Y (Y=1−X), a second error function (e.g., MR-SAD/MR-SSE) may be used.
      ii. Alternatively, furthermore, the final cost may be based on the costs of each reference picture list.
5. The above methods may be applied to any coding data refinement process, e.g., for a template-based-coded block, for a bilateral-based-coded block (e.g., DMVR in VVC).

### 2.16. Samples Utilized in Coding Data Refinement for Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block).
1. The error/cost evaluation in the coding data refinement process may depend on both reference samples corresponding to current block (e.g., the reference blocks used in bilateral matching) and reference samples corresponding to a template of current block.
   a) Alternatively, it may depend on both reference samples corresponding to current block and samples in a template of current block.
   b) In one example, the template may be neighboring samples (adjacent or non-adjacent) of current block.
2. Multiple refinement processes may be applied to one block with different templates applied to at least two refinement processes.
   a) In one example, a first refinement process may be invoked with a first template. Based on the output of the first refinement process, a second template is further utilized in the second refinement process.
   b) In one example, the first template may contain more samples compared to the second template.
   c) In one example, the first and second template may contain at least one different sample.
   d) In one example, the first and second refinement process may use different cost/error functions.
3. Whether to use multiple refinement process, and/or how to select one or multiple error function and/or how to define the cost function and/or which samples to be involved in the error function may depend on the decoded information of a current block and/or neighboring (adjacent or non-adjacent) blocks.
   a) In one example, how to select one or multiple error function and/or how to define the cost function may depend on the coding tool applied to current block and/or neighboring blocks.
      i. In one example, the coding tool is the LIC.
         (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
         (ii) In one example, if MR-SAD/MR-SATD/MR-SSD is used for the template matching cost measure, the linear function used in LIC process may be not used when deriving the reference template.
         (iii) In one example, if MR-SAD/MR-SATD/MR-SSD is used for the bilateral matching cost measure, the linear function used in LIC process may be not used when deriving the reference block.
   b) In one example, it may depend on block dimension (e.g., W, H), temporal layer, low delay check flag, etc. al.
   c) In one example, it may depend on whether the motion information of current and neighboring block is similar/identical.
   d) In one example, it may depend on reference picture list and/or reference picture information.
      i. In one example, for list X, a first error function (e.g., SAD/SSE) may be used, and for list Y (Y=1−X), a second error function (e.g., MR-SAD/MR-SSE) may be used.
      ii. Alternatively, furthermore, the final cost may be based on the costs of each reference picture list.
4. In one example, LIC may be enabled for reference list X and disabled for reference list Y.
   a) In one example, the final prediction of current block may be weighted average of LIC prediction from reference List X and regular prediction from reference List Y.
5. The above methods may be applied to any coding data refinement process, e.g., for a template-based-coded block, for a bilateral-based-coded block (e.g., DMVR in VVC).

### 2.17. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, TM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

W and H are the width and height of current block (e.g., luma block).
1. The template/bilateral matching cost C may be calculated to be f(C) before it is used to be compared with another template matching cost.
   a. In one example, f(C)=w*C, wherein w is denoted as a cost factor.
   b. In one example, f(C)=w*C+u.
   c. In one example, f(C)=Shift((w*C), s).
   d. In one example, w and/or u and/or s are integers.
   e. In one example, a first template matching cost for a first motion candidate may be multiplied by a cost factor before it is compared with a second template matching cost for a second motion candidate.
   f. In one example, it is proposed the cost factor for a motion candidate may depend on the position of the candidate before reordering.
      i. In one example, the motion candidate at the i-th position may be assigned with a smaller cost factor than the cost factor of the motion candidate at the j-th position, wherein j>i, e.g. j=i+1.
         (i) In one example, the cost factor of the motion candidate at the i-th position is 4 and the cost factor of the motion candidate at the j-th position is 5.
         (ii) In one example, the cost factor of the motion candidate at the i-th position is 1 and the cost factor of the motion candidate at the j-th position is 5.
      ii. In one example, the motion candidate at the i-th position may be assigned with a larger cost factor than the cost factor of the motion candidate at the j-th position, wherein j>i, e.g. j=i+1.
      iii. In one example, the motion candidates in the p-th group (e.g. including M motion candidates) may be assigned with a smaller cost factor than the cost factor of the motion candidates in the q-th group (e.g. including N motion candidates), wherein q>p, e.g. q=p+1.
         (i) Alternatively, the motion candidates in the p-th group (e.g. including M motion candidates) may be assigned with a larger cost factor than the cost factor of the motion candidates in the q-th group (e.g. including N motion candidates), wherein q>p, e.g. q=p+l.
         (ii) In one example, M may be equal to N. For example, M=N=2.
         (iii) In one example, M may be not equal to N. For example, M=2, N=3.
         (iv) In one example, the cost factor of the motion candidates at the p-th group is 4 and the cost factor of the motion candidates at the q-th group is 5.
         (v) In one example, the cost factor of the motion candidates at the p-th group is 1 and the cost factor of the motion candidates at the q-th group is 5.
      iv. In one example, the cost factor may be not applied to subblock motion candidates.
      v. In one example, the cost factor may be not applied to affine motion candidates.
      vi. In one example, the cost factor may be not applied to SbTMVP motion candidates.
   g. In one example, the cost factor of the motion candidates in one group/position may be adaptive.
      i. In one example, the cost factor of the motion candidates in one group/position may be dependent on the coding mode of neighbor coded blocks.
         (i) In one example, the cost factor of SbTMVP merge candidate may be dependent on the number of neighbor affine coded blocks.
         (ii) In one example, the neighbor coded blocks may include at least one of the five spatial neighbor blocks (shown in FIG. 1) and/or the temporal neighbor block(s) (shown in FIG. 7).
         (iii) In one example, the cost factor of SbTMVP merge candidate may be 0.2 when the number of spatial neighbor affine coded blocks (shown in FIG. 1) is 0; the cost factor of SbTMVP merge candidate may be 0.5 when the number of spatial neighbor affine coded blocks (shown in FIG. 1) is 1; the cost factor of SbTMVP merge candidate may be 0.8 when the number of spatial neighbor affine coded blocks (shown in FIG. 1) is 2; otherwise, the cost factor of SbTMVP merge candidate may be 1 (which means keeping unchanged).
         (iv) In one example, the cost factor of SbTMVP merge candidate may be 0.2 when the number of spatial neighbor affine coded blocks (shown in FIG. 1) is 0; the cost factor of SbTMVP merge candidate may be 0.5 when the number of spatial neighbor affine coded blocks (shown in FIG. 1) is 1; the cost factor of SbTMVP merge candidate may be 0.8 when the number of spatial neighbor affine coded blocks (shown in FIG. 1) is larger than or equal to 2.
         (v) In one example, the cost factor of SbTMVP merge candidate may be 2 when the number of spatial neighbor affine coded blocks (shown in FIG. 1) is 0; the cost factor of SbTMVP merge candidate may be 5 when the number of spatial neighbor affine coded blocks (shown in FIG. 1) is 1; the cost factor of SbTMVP merge candidate may be 8 when the number of spatial neighbor affine coded blocks (shown in FIG. 1) is 2; otherwise, the cost factor of SbTMVP merge candidate may be 10 (wherein the cost factor of affine merge candidates is 10).
         (vi) In one example, the cost factor of SbTMVP merge candidate may be 2 when the number of spatial neighbor affine coded blocks (shown in FIG. 1) is 0; the cost factor of SbTMVP merge candidate may be 5 when the number of spatial neighbor affine coded blocks (shown in FIG. 1) is 1; the cost factor of SbTMVP merge candidate may be 8 when the number of spatial neighbor affine coded blocks (shown in FIG. 1) is larger than or equal to 2 (wherein the cost factor of affine merge candidates is 10).
2. The subgroup size may be different for different coding modes.
   a. The coding modes may include regular/subblock/TM merge modes.
      i. The subgroup size may be K1 (e.g., K1=5) for regular merge mode.
      ii. The subgroup size may be K2 (e.g., K2=3) for subblock merge mode.
      iii. The subgroup size may be K3 (e.g., K3=3) for TM merge mode.
   b. The subgroup size may be larger than or equal to the maximum number of subblock merge candidates defined in sps/picture/slice header (which means reordering whole list together) for subblock merge mode.
   c. The subgroup size may be larger than or equal to the maximum number of TM merge candidates defined in sps/picture/slice header (which means reordering whole list together) for TM merge mode.
   d. The subgroup size for a coding mode may be dependent on the maximum number of motion candidates in the coding mode.
   e. The subgroup size for subblock merge mode may be adaptive dependent on the number of neighbor affine coded blocks.
      i. In one example, the neighbor coded blocks may include at least one of the five spatial neighbor blocks (shown in FIG. 1) and/or the temporal neighbor block(s) (shown in FIG. 7).
      ii. In one example, the subgroup size for subblock merge mode may be 3 when the number of spatial neighbor affine coded blocks (shown in FIG. 1) is 0 or 1; the subgroup size for subblock merge mode may be 5 when the number of spatial neighbor affine coded blocks (shown in FIG. 1) is larger than 1;
3. The template size may be different for different coding modes.
   a. The coding modes may include regular/subblock/TM merge modes.
      i. The template size may be K1 (e.g., K1=1) for regular merge mode.
      ii. The template size may be K2 (e.g., K2=1, 2, or 4) for subblock merge mode.
      iii. The template size may be K3 (e.g., K3=1) for TM merge mode.
4. Whether to and/or how to reorder the motion candidates may depend on the coding modes of neighbor coded blocks.
   a. In one example, the neighbor coded blocks may include at least one of the five spatial neighbor blocks (shown in FIG. 1) and/or the temporal neighbor block(s) (shown in FIG. 7).
   b. The regular merge candidates may be reordered when the number of spatial neighbor coded blocks with regular merge mode (shown in FIG. 1) is larger than or equal to K (e.g., K=1).
   c. The subblock merge candidates may be reordered when the number of spatial neighbor coded blocks with subblock merge mode (shown in FIG. 1) is larger than or equal to K (e.g., K=1).
   d. The affine merge candidates may be reordered when the number of spatial neighbor coded blocks with affine merge mode (shown in FIG. 1) is larger than or equal to K (e.g., K=1).
   e. The SbTMVP merge candidates may be reordered when the number of spatial neighbor coded blocks with affine merge mode (shown in FIG. 1) is larger than or equal to K (e.g., K=1, 2, or 3).
   f. The TM merge candidates may be reordered when the number of spatial neighbor coded blocks with TM merge mode (shown in FIG. 1) is larger than or equal to K (e.g., K=1).
5. The HMVP motion candidates in the HMVP table may be reordered based on template/bilateral matching etc. al.
   a. In one example, a HMVP motion candidate is assigned with a cost, the HMVP candidates are adaptively reordered in a descending order of costs of HMVP candidates.
      i. In one example, the cost of a HMVP candidate may be a template matching cost.
   b. In one example, HMVP motion candidates may be reordered before coding a block.
      i. In one example, HMVP motion candidates may be reordered before coding an inter-coded block.
   c. In one example, HMVP motion candidates may be reordered in different ways depending on coding information of the current block and/or neighbouring blocks.

### General Aspects

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
7. Whether to and/or how to apply the disclosed methods above may be signalled at PB/TB/CB/PU/TU/CU/VPDU/CTU/CTU row/slice/tile/sub-picture/other kinds of region contains more than one sample or pixel.
8. Whether to and/or how to apply the disclosed methods above may be dependent on coded information, such as coding mode, block size, colour format, single/dual tree partitioning, colour component, slice/picture type.

### 2.18. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList.

W and H are the width and height of current block (e.g., luma block).
1. It is proposed that for a GPM coded block, the coded candidate index may be corresponding to a candidate with a different candidate index in the candidate list for GPM coded blocks.
   a. Alternatively, furthermore, the candidate list constructed for the GPM coded block may be reordered before being used and the coded index is corresponding to the reordered candidate list.
   b. Alternatively, furthermore, for a first type of GPM coded block, the candidate list may be reordered, and for a second type of GPM coded block, the candidate list may not be reordered.
      i. In one example, the first type is template-based GPM coded block.
      ii. In one example, the second type is the MMVD-based GPM coded block (e.g., GMVD).
   c. Alternatively, furthermore, for a first type of GPM coded block, the candidate list may be reordered with a first rule, and for a second type of GPM coded block, the candidate list may be reordered with a second rule.
   d. The reordering method for a GPM coded block may be the same as that for a non-GPM coded block.
      i. The reordering method for a GPM coded block may be different from that for a non-GPM coded block.
2. It is proposed that for a GPM coded block, the coded candidate index may be corresponding to a candidate from a refined candidate list for GPM coded blocks.
   a. Alternatively, furthermore, the candidate list constructed for the GPM coded block may be refined firstly before being used and the coded index is corresponding to the refined candidate list.
   b. Alternatively, furthermore, for a first type of GPM coded block, the candidate list may be refined, and for a second type of GPM coded block, the candidate list may not be refined.
      i. In one example, the first type is template-based GPM coded block.
      ii. In one example, the second type is the MMVD-based GPM coded block (e.g., GMVD).
   c. Alternatively, furthermore, for a first type of GPM coded block, the candidate list may be refined with a first rule, and for a second type of GPM coded block, the candidate list may be refined with a second rule.
   d. The refined method for a GPM coded block may be the same as that for a non-GPM coded block.
      i. The refined method for a GPM coded block may be different from that for a non-GPM coded block.
3. In one example, the GPM candidates may be divided into subgroups. Whether to and/or how to reorder the GPM candidates may depend on the subgroup of the GPM candidates.
   a. In one example, only the first subgroup can be reordered.
   b. In one example, the last subgroup can not be reordered.
   c. In one example, the last subgroup can not be reordered. But if the last subgroup also is the first subgroup, it can be reordered.
   d. Different subgroups may be reordered separately.
   e. Two candidates in different subgroups cannot be compared and/or reordered.
   f. A first candidate in a first subgroup must be put ahead of a second candidate in a second subgroup after reordering if the first subgroup is ahead of a second subgroup.
4. In one example, the GPM candidates which are not included in the reordering process may be treated in specified way.
   a. In one example, for the candidates not to be reordered, they will be arranged in the merge candidate list according to the initial order.
   b. In one example, candidates not to be reordered may be put behind the candidates to be reordered.
   c. In one example, candidates not to be reordered may be put before the candidates to be reordered.
5. A GPM candidate list to be reordered may refer to
   Case 1: a first candidate list which is prepared for the two GPM partitions and is used to derive the individual GPM candidate lists for each GPM partitions.
   Case 2: a second GPM candidate list which is used for each GPM partition. Usually, the second GPM candidate is derived from the first candidate list.
   a. In one example, in case 1, the reordering method may be the same to that used for a regular merge candidate list.
   b. In one example, in case 1, the template matching approach in the reordering method may be conducted in a bi-prediction way if the corresponding candidate is bi-predicted.
   c. In one example, in case 2, the template matching approach in the reordering method cannot be conducted in a bi-prediction way.
   d. In one example, in case 2, the reordering method may be the same for all GPM partitions.
   e. In one example, in case 2, the reordering method may be different for different GPM partitions.
6. In above examples, the GPM coded block may be a GPM coded block with merge mode, a GPM coded block with AMVP mode.
   a. Alternatively, furthermore, the merge candidate mentioned above may be replaced by an AMVP candidate.

### General Aspects

7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
8. Whether to and/or how to apply the disclosed methods above may be signalled at PB/TB/CB/PU/TU/CU/VPDU/CTU/CTU row/slice/tile/sub-picture/other kinds of region contains more than one sample or pixel.
9. Whether to and/or how to apply the disclosed methods above may be dependent on coded information, such as coding mode, block size, colour format, single/dual tree partitioning, colour component, slice/picture type.

### 2.19. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList;

Regarding the type of GPM candidates in the original GPM candidate list, the GPM candidates derived in the first step of GPM candidate list construction process in section 2.29 are called GPM-parity-based candidates; The GPM candidates derived in the second step of GPM candidate list construction process in section 2.29 are called GPM-anti-parity-based candidates; The GPM candidates derived in the third step of GPM candidate list construction process in section 2.29 are called GPM-filled candidates.

W and H are the width and height of current block (e.g., luma block).
1. In one example, if the coding mode is GPM, the merge candidates may be reordered.
   a. In one example, the merge candidates in the OGPMList may be reordered.
      i. In one example, at least two merge candidates in OGPMList may be reordered.
      ii. In one example, at least one type of template may be used for OGPMList reordering.
      iii. Alternatively, the merge candidates in the OGPMList may NOT be reordered.
      iv. In one example, a first type of template may only comprise neighboring samples left to the current block.
      v. In one example, a second type of template may only comprise neighboring samples above to the current block.
      vi. In one example, a third type of template may comprise neighboring samples left and above to the current block.
      vii. The reordering process may be invoked after the parsing process but before the MV reconstruction process.
   b. In one example, the merge candidates in the AGPMList may be reordered.
      i. In one example, at least two merge candidates in AGPMList may be reordered.
      ii. In one example, at least one type of template may be used for AGPMList reordering.
      iii. In one example, a first type of template may only comprise neighboring samples above to the current block.
      iv. In one example, a second type of template may comprise neighboring samples left and above to the current block.
   c. In one example, the merge candidates in the LGPMList may be reordered.
      i. In one example, at least two merge candidates in LGPMList may be reordered.
      ii. In one example, at least one type of template may be used for LGPMList reordering.
      iii. In one example, a first type of template may only comprise neighboring samples left to the current block.
      iv. In one example, a second type of template may comprise neighboring samples left and above to the current block.
   d. In one example, the merge candidates in the LAGPMList may be reordered.
      i. In one example, at least two merge candidates in LAGPMList may be reordered.
      ii. In one example, at least one type of template may be used for LAGPMList reordering.
      iii. In one example, a first type of the template may only comprise neighboring samples left to the current block.
      iv. In one example, a second type of the template may only comprise neighboring samples above to the current block.
      v. In one example, a third type of the template may comprise neighboring samples left and above to the current block.
   e. In one example, whether to and/or how to reorder merge candidates in a GPM list may be dependent on the coding information.
      i. In one example, whether to reorder merge candidates in a GPM list may be dependent on whether a template matching based motion refinement is applied to a GPM partition or two GPM partitions (i.e. a GPM coded CU).
         (i) For example, if the motion of a GPM partition or two GPM partitions (i.e. a GPM coded CU) is NOT refined based on template matching (e.g., the template matching flag is equal to false), the corresponding GPM list may NOT be reordered.
         a) For example, if a GPM partition is coded using a merge candidate in OGPMList (e.g., no motion refinement is applied), then merge candidates in OGPMList may NOT be reordered.
         (ii) For example, if the motion of a GPM partition or two GPM partitions (i.e. a GPM coded CU) is refined based on template matching (e.g., the template matching flag is equal to true), the corresponding GPM list may be reordered.
         a) For example, if a GPM partition is coded using a merge candidate in AGPMList (e.g., template matching motion refinement method using above template is applied), then merge candidates in AGPMList may be reordered.
         b) For example, if a GPM partition is coded using a merge candidate in LGPMList (e.g., template matching motion refinement method using left template is applied), then merge candidates in LGPMList may be reordered.
         c) For example, if a GPM partition is coded using a merge candidate in LAGPMList (e.g., template matching motion refinement method using left and above template is applied), then merge candidates in LAGPMList may be reordered.
      ii. In one example, how to reorder merge candidates in a GPM list may be dependent on the GPM partition information (e.g., partition mode, partition angle, partition distance, etc.).
         (i) For example, above template may be used for the merge candidates reordering in case that the current GPM partition is split by a first partition angle (or partition mode, or partition distance, etc.).
         (ii) For example, left template may be used for the merge candidates reordering in case that the current GPM partition is split by a second partition angle (or partition mode, or partition distance, etc.).
         (iii) For example, left and above template may be used for the merge candidates reordering in case that the current GPM partition is split by a third partition angle (or partition mode, or partition distance, etc.).
         (iv) For example, a type of template may be specified corresponding to the first/second/third partition angle (or partition mode, or partition distance, etc.).
         (v) For example, at least one look-up table (i.e., mapping table) is used to map what specified partition angles (or partition modes, or partition distances, etc.) corresponding to what type of template (e.g., above template, left template, or above and left template.).
   f. In one example, the merge candidates in the OGPMList may be not reordered and the merge candidates in the AGPMList and/or LGPMList and/or LAGPMList may be reordered.
2. The merge candidates can be adaptively rearranged in the final GPM candidate list according to one or some criterions.
   a. In one example, the GPM candidate list may be:
      i. OGPMList;
      ii. AGPMList;
      iii. LGPMLIst;
      iv. LAGPMList.
   b. The GPM candidates may be divided into several subgroups.
      i. For example, the number of GPM candidates (such as X=3 or 5 or any other integer values) in a subgroup may be pre-defined.
   c. In one example, partial or full process of current GPM candidate list construction process is firstly invoked, followed by the reordering of candidates in the GPM list.
      i. Alternatively, candidates in a first subgroup may be reordered and they should be added before those candidates in a second subgroup wherein the first subgroup is added before the second subgroup.
      ii. The construction process may include a pruning method.
   d. In one example, the merge candidates may be adaptively rearranged before retrieving the merge candidates.
      i. In one example, the procedure of arranging merge candidates adaptively may be processed before obtaining the merge candidate to be used in the motion compensation process.
   e. The criterion may be based on template matching cost.
      i. In one example, the cost function between current template and reference template may be:
         (i) SAD/MR-SAD;
         (ii) SATD/MR-SATD;
         (iii) SSD/MR-SSD;
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
3. When deriving the two motions for two geometric partitions, the process may be:
   a. In one example, if TM is not applied to one partition, the motion can be derived according to the signalled merge index from the OGPMList/reordered OGPMList.
   b. In one example, if TM is applied to one partition, the motion can be derived according to the signalled merge index from the AGPMList/reordered AGPMList or LGPMList/reordered LGPMLIst or LAGPMList/reordered LAGPMLIst dependent on partition angle and partition index.
      i. In one example, if partition angle is X (e.g., 0), for the first partition, AGPMList/reordered AGPMList will be used; for the second partition, LAGPMList/reordered LAGPMLIst will be used.
   c. In one example, if TM is applied to one partition, the motion can be derived according to the signalled merge index from the AGPMList/reordered AGPMList.
   d. In one example, if TM is applied to one partition, the motion can be derived according to the signalled merge index from the LGPMList/reordered LGPMLIst.
   e. In one example, if TM is applied to one partition, the motion can be derived according to the signalled merge index from the LAGPMList/reordered LAGPMLIst.
4. Whether to and/or how to reorder the GPM candidates may depend on the category of the GPM candidates.
   a. In one example, only GPM-parity-based candidates can be reordered.
   b. In one example, only GPM-parity-based and GPM-anti-parity-based candidates can be reordered.
   c. In one example, the GPM-filled candidates may not be reordered.
   d. In one example, two candidates in different GPM lists cannot be compared and/or reordered.
   e. In one example, only the first N GPM candidates can be reordered.
      i. In one example, N is set equal to 5.
5. In above examples, the GPM coded block may be a GPM coded block with merge mode, a GPM coded block with AMVP mode.
   a. Alternatively, furthermore, the merge candidate mentioned above may be replaced by an AMVP candidate.

### General Aspects

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
7. Whether to and/or how to apply the disclosed methods above may be signalled at PB/TB/CB/PU/TU/CU/VPDU/CTU/CTU row/slice/tile/sub-picture/other kinds of region containing more than one samples or pixels.
8. Whether to and/or how to apply the disclosed methods above may be dependent on coded information, such as coding mode, block size, GPM partition information, colour format, single/dual tree partitioning, colour component, slice/picture type.

### 2.20. Hash Based Motion Estimation for Screen Content Coding

The VTM reference software uses hash-based motion estimation to handle the sometimes large and irregular motion in screen content. For each reference picture, hash tables corresponding to 4×4 to 64×64 block sizes are generated using a bottom-up approach as follows:
For each 2×2 block, the block hash value is calculated directly from the original sample values (luma samples are used if 4:2:0 chroma format and both luma and chroma sample values are used if 4:4:4 chroma format). The cyclic redundancy check (CRC) value is used as the hash value.
For 4×4, 8×8, 16×16, 32×32 and 64×64 blocks, the hash value of the current block is the CRC value calculated from the CRC values of its four subblocks.

To enable efficient search for matched blocks, the structure of inverted index is used, where hash values are used as to index into a table, and the table entries contain all the blocks with the same hash value as the corresponding table index. The blocks corresponding a given table index are stored as a linked list. Two CRC values, one 16-bit hash and the other 24-bit hash, are calculated for each block. The two hash values are calculated in a similar way but using different CRC truncated polynomials. The first 16-bit CRC value is used as the inverted index. The second 24-bit hash value is stored together with the blocks to resolve hash conflicts in the case more than one matching blocks are found. To reduce the length of the hash table, the hash values of all “simple” blocks (defined as a block with only one sample value in each row or column) are excluded from the hash table.

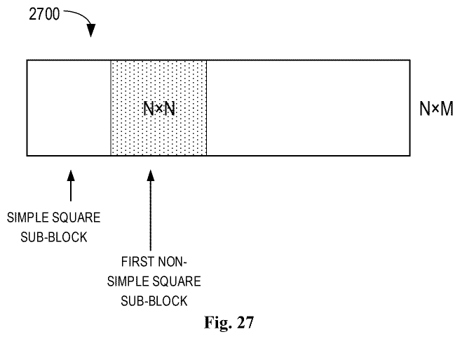

In motion estimation, if the current block is a square block (except for 128×128 blocks), its hash values are calculated. Then, the encoder queries the corresponding hash table. If hash match is found, the matched block is used as the reference. If the current block is a rectangle block of size N×M (and without loss of generality assume M>N), it will be divided into several non-overlapping square subblocks of size N×N. An example is shown in FIG. 27. The encoder will find the first non-simple square subblock and calculate its hash values. Encoder queries the hash values of this N×N square subblock on the hash table corresponding to N×N block size. The one or more matched reference blocks are considered reference block candidates. For each matched reference block candidate, encoder will continue to check whether the hash values of the remaining square subblocks (namely the white region that follows the first non-simple square subblock depicted in FIG. 27) are equal to those of the square subblocks adjacent to that reference block candidate. If the hash values of all square subblocks are matched, the reference block candidate will be regarded as a valid reference block.

For inter coding, the hash-based motion search is performed before testing all coding modes. In addition, encoder will reuse the MVs of the hash mode as the starting point candidates in the normal motion estimation process. If the hash-based motion vector exists, which indicates that the block most likely contains screen content, fractional motion estimation is skipped.

To accelerate the encoder, coding modes other than the skip and merge part of ETM_MERGE_SKIP, ETM_AFFINE, and ETM_MERGE_GPM modes and finer-granularity block splitting are skipped if all of the following conditions are satisfied:
Current block size is 64×64, 128×64 or 64×128.
An identical reference block is found in a reference picture.
The QP of reference picture is not larger than that of current picture.
   2.21. Luma Mapping with Chroma Scaling (LMCS)

In VVC, a coding tool called the luma mapping with chroma scaling (LMCS) is added as a new processing block before the loop filters. LMCS has two main components: 1) in-loop mapping of the luma component based on adaptive piecewise linear models; 2) for the chroma components, luma-dependent chroma residual scaling is applied. FIG. 28 shows the LMCS architecture from decoder's perspective. The light-blue shaded blocks in FIG. 28 indicate where the processing is applied in the mapped domain; and these include the inverse quantization, inverse transform, luma intra prediction and adding of the luma prediction together with the luma residual. The unshaded blocks in FIG. 28 indicate where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. The light-yellow shaded blocks in FIG. 28 are the new LMCS functional blocks, including forward and inverse mapping of the luma signal and a luma-dependent chroma scaling process. Like most other tools in VVC, LMCS can be enabled/disabled at the sequence level using an SPS flag.

2.21.1 Luma Mapping with Piecewise Linear Model

The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signalled using a piecewise linear model with 16 equal pieces. InvMap function does not need to be signalled and is instead derived from the FwdMap function.

The luma mapping model is signalled in the adaptation parameter set (APS) syntax structure with aps_params_type set equal to 1 (LMCS_APS). Up to 4 LMCS APS's can be used in a coded video sequence.

Only 1 LMCS APS can be used for a picture. The luma mapping model is signalled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signalled number of codewords is used to calculate the scaling factor and adjust the mapping function accordingly for that piece. At the slice level, an LMCS enable flag is signalled to indicate if the LMCS process as depicted in FIG. 28 is applied to the current slice. If LMCS is enabled for the current slice, an aps_id is signalled in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ].

The InputPivot[ ] and MappedPivot[ ] are computed as follows (assuming 10-bit video):
1) OrgCW=64
2) For i=0:16, InputPivot[i]=i*OrgCW
3) For i=0:16, MappedPivot[i] is calculated as follows: MappedPivot[0]=0;
   for (i=0; i<16; i++)
      MappedPivot[i+1]=MappedPivot[i]+SignalledCW[i]
         where SignalledCW[i] is the signalled number of codewords for the i-th piece.

As shown in FIG. 28, for an inter-coded block, motion compensated prediction is performed in the mapped domain. In other words, after the motion-compensated prediction block Y_{pred} is calculated based on the reference signals in the DPB, the FwdMap function is applied to map the luma prediction block in the original domain to the mapped domain, Y′_{pred}=FwdMap(Y_{pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Y̅ᵢ=InvMap(Yᵣ)). The InvMap function is applied to both intra- and inter-coded luma blocks.

The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT[Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces). Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$F w d M a p ( {Y}_{p r e d} ) = ( ( b 2 - b 1 ) / ( a 2 - a 1 ) ) * ( {Y}_{p r e d} - a 1 ) + b 1$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, VVC imposes a bitstream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e. MappedPivot[i+1]>>(BitDepth_{Y}−5) shall not be equal to MappedPivot[i]>>(BitDepth_{Y}−5). Thanks to such bitstream constraint, the InvMap function can also be carried out using a simple right bit-shift by 5 bits (which corresponds 32 equal-sized pieces) in order to figure out the piece to which the sample value belongs.

### 2.21.2 Luma-Dependent Chroma Residual Scaling

Chroma residual scaling is designed to compensate for the interaction between the luma signal and its corresponding chroma signals. Whether chroma residual scaling is enabled or not is also signalled at the slice level. If luma mapping is enabled, an additional flag is signalled to indicate if luma-dependent chroma residual scaling is enabled or not. When luma mapping is not used, luma-dependent chroma residual scaling is disabled. Further, luma-dependent chroma residual scaling is always disabled for the chroma blocks whose area is less than or equal to 4.

Chroma residual scaling depends on the average value of top and/or left reconstructed neighbouring luma samples of the current VPDU. If the current CU is inter 128×128, inter 128×64 and inter 64×128, then the chroma residual scaling factor derived for the CU associated with the first VPDU is used for all chroma transform blocks in that CU. Denote avgYr as the average of the reconstructed neighbouring luma samples (see FIG. 28). The value of C_{ScaleInv} is computed in the following steps:
1) Find the index Y_{Idx} of the piecewise linear model to which avgYr belongs based on the InvMap function.
2) C_{ScaleInv}=cScaleInv[Y_{Idx}], where cScaleInv[ ] is a 16-piece LUT pre-computed based on the value of SignalledCW[i] and a offset value signalled in APS for chroma residual scaling process.

Unlike luma mapping, which is performed on the sample basis, C_{ScaleInv} is a constant value for the entire chroma block. With C_{ScaleInv}, chroma residual scaling is applied as follows.

$$Encoder side : {C}_{Res S c a l e} = {C}_{Res} * {C}_{S c a l e} = {C}_{Res} / {C}_{ScaleInv} \\ Decoder side : {C}_{Res} = {C}_{Res S c a l e} / {C}_{S c a l e} = {C}_{Res S c a l e} * {C}_{ScaleInv}$$

### 2.21.3 Encoder-Side LMCS Parameter Estimation

A non-normative reference implementation is provided in the VTM encoder to estimate the LMCS model parameters. Because VTM anchors handle SDR, HDR PQ and HDR HLG differently, the reference algorithm in VTM13 is designed differently for SDR, HDR PQ and HDR HLG sequences. For SDR and HDR HLG sequences, the encoder algorithm is based on local luma variance and optimized for PSNR metrics. For HDR PQ sequences, the encoder algorithm is based on luma values and optimized for wPSNR (weighted PSNR) metrics.

2.22. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The mmvd candidate flag is signalled to specify which one is used between the first and second merge candidates.

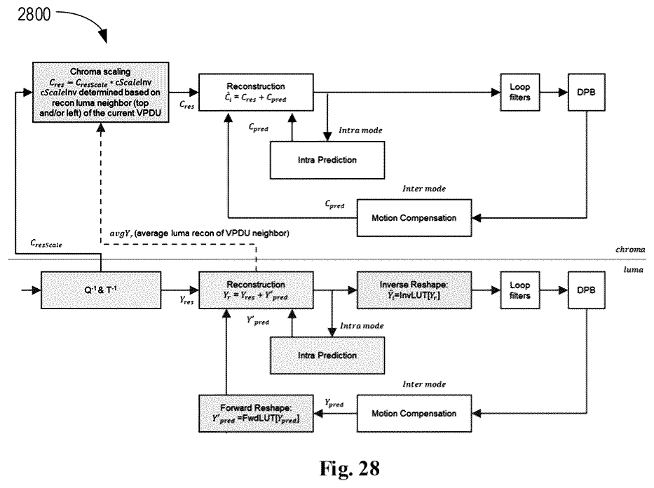

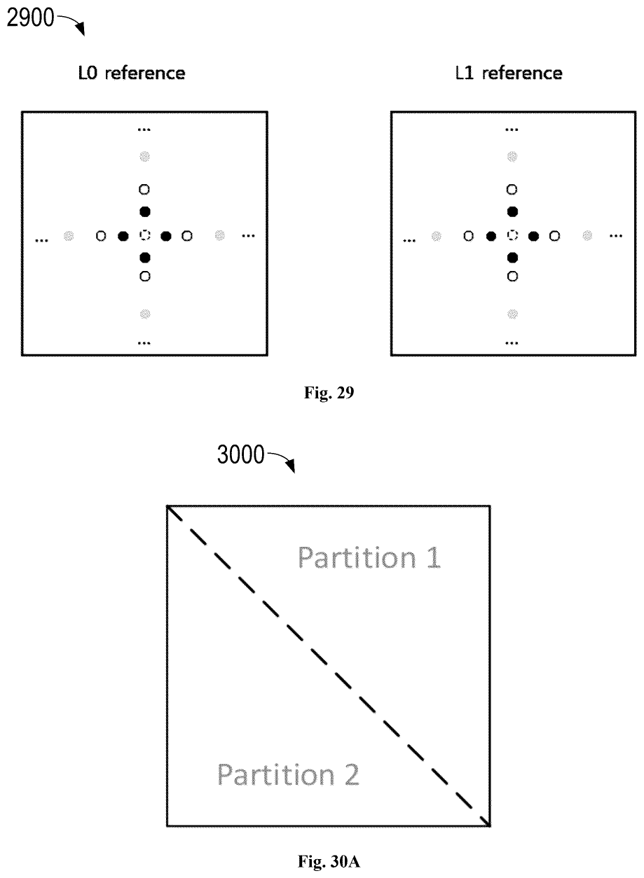

Distance index specifies motion magnitude information and indicate the pre-defined offset from the starting point. As shown in FIG. 29, an offset is added to either horizontal component or vertical component of starting MV. The relation of distance index and pre-defined offset is specified in Table 2-2.

TABLE 2-2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2-3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2-3 specifies the sign of MV offset added to the list0 MV component of starting MV and the sign for the list1 MV has opposite value. Otherwise, if the difference of POC in list 1 is greater than list 0, the sign in Table 2-3 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 6. If the POC difference of L1 is greater than L0, the MVD for list 0 is scaled in the same way. If the starting MV is uni-predicted, the MVD is added to the available MV.

MMVD is also known as Ultimate Motion Vector Expression (UMVE).

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.23. Triangle Partition for Inter Prediction

In VVC, a triangle partition mode (TPM) is supported for inter prediction. The triangle partition mode is only applied to CUs that are 8×8 or larger. The triangle partition mode is signalled using a CU-level flag as one kind of merge mode, with other merge modes including the regular merge mode, the MMVD mode, the CIIP mode and the subblock merge mode.

When this mode is used, a CU is split evenly into two triangle-shaped partitions, using either the diagonal split or the anti-diagonal split (shown in FIGS. 30A and 30B). Each triangle partition in the CU is inter-predicted using its own motion; only uni-prediction is allowed for each partition, that is, each partition has one motion vector and one reference index. The uni-prediction motion constraint is applied to ensure that same as the conventional bi-prediction, only two motion compensated prediction are needed for each CU. The uni-prediction motion for each partition is derived using the process described in 2.23.1.

If triangle partition mode is used for the current CU, then a flag indicating the direction of the triangle partition (diagonal or anti-diagonal), and two merge indices (one for each partition) are further signalled. The number of maximum TPM candidate size is signalled explicitly at slice level and specifies syntax binarization for TMP merge indices. After predicting each of the triangle partitions, the sample values along the diagonal or anti-diagonal edge are adjusted using a blending processing with adaptive weights. This is the prediction signal for the whole CU, and transform and quantization process will be applied to the whole CU as in other prediction modes. Finally, the motion field of a CU predicted using the triangle partition mode is stored as in 2.23.3.

The triangle partition mode is not used in combination with SBT, that is, when the signalled triangle mode is equal to 1, the cu_sbt_flag is inferred to be 0 without signalling.

### 2.23.1 Uni-Prediction Candidate List Construction

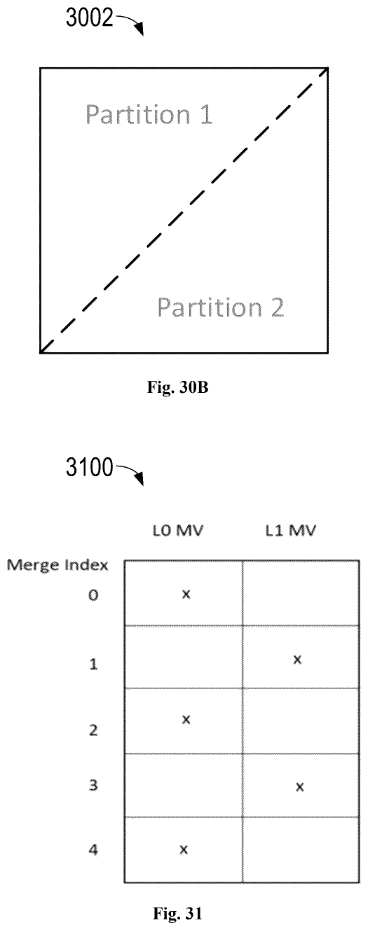

The uni-prediction candidate list is derived directly from the merge candidate list constructed according to the extended merge prediction process in 2.1. Denote n as the index of the uni-prediction motion in the triangle uni-prediction candidate list. The LX motion vector of the n-th extended merge candidate, with X equal to the parity of n, is used as the n-th uni-prediction motion vector for triangle partition mode. These motion vectors are marked with “x” in FIG. 31. In case a corresponding LX motion vector of the n-the extended merge candidate does not exist, the L(1−X) motion vector of the same candidate is used instead as the uni-prediction motion vector for triangle partition mode.

### 2.23.2 Blending Along the Triangle Partition Edge

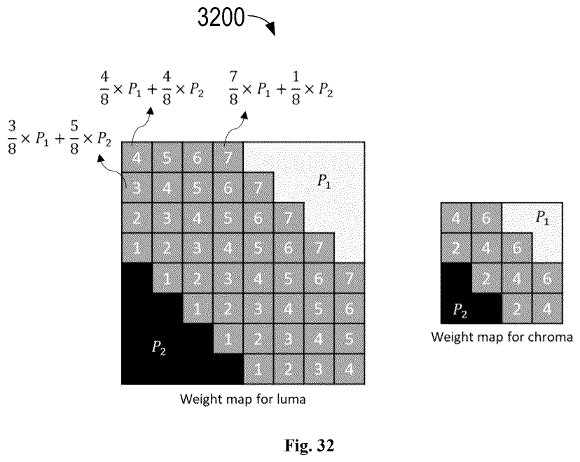

After predicting each triangle partition using its own motion, blending is applied to the two prediction signals to derive samples around the diagonal or anti-diagonal edge. The following weights are used in the blending process:
⅞, 6/8, ⅝, 4/8, ⅜, 2/8, ⅛} for luma and { 6/8, 4/8, 2/8} for chroma, as shown in FIG. 32.

### 2.23.3 Motion Field Storage

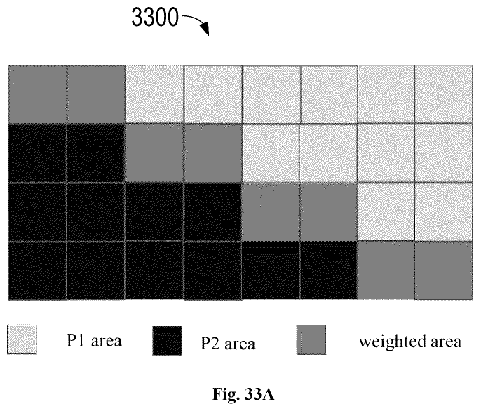

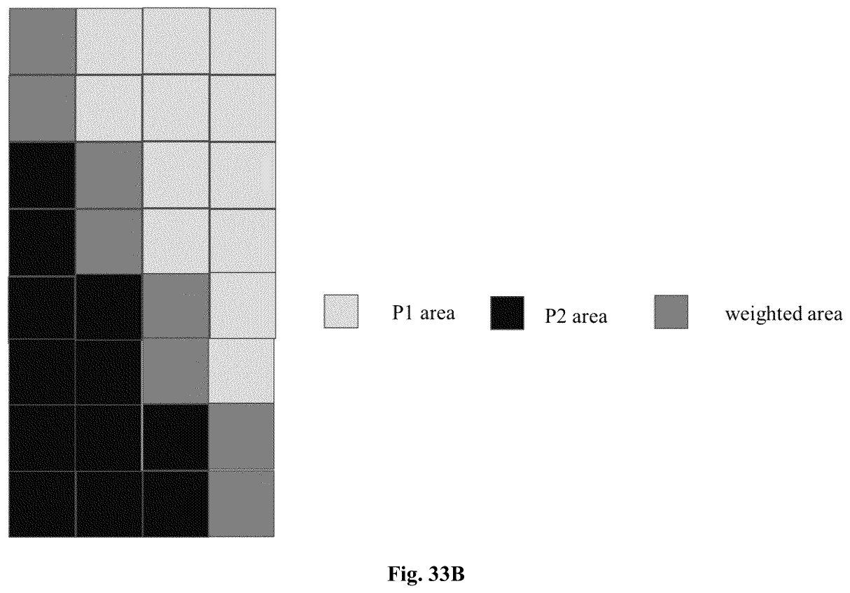

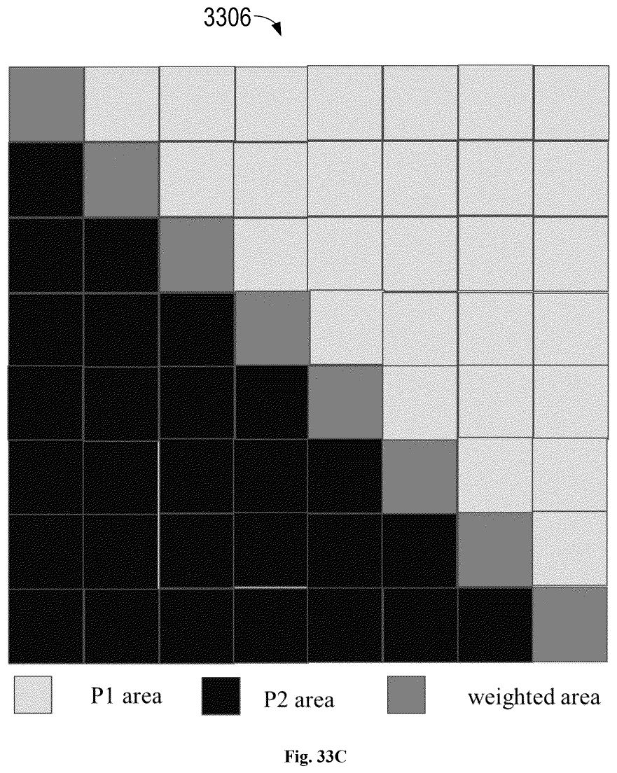

The motion vectors (Mv1 and Mv2 in FIGS. 33A-33C) of the triangular prediction units are stored in 4×4 grids. For each 4×4 grid, either uni-prediction or bi-prediction motion vector is stored depending on the position of the 4×4 grid in the CU. As shown in FIGS. 33A-33C, uni-prediction motion vector, either Mv1 or Mv2, is stored for the 4×4 grid located in the non-weighted area (that is, not located at the diagonal edge). On the other hand, a bi-prediction motion vector is stored for the 4×4 grid located in the weighted area. The bi-prediction motion vector is derived from Mv1 and Mv2 according to the following rules:
1) If Mv1 and Mv2 are from different reference picture lists (one from L0 and the other from L1), then Mv1 and Mv2 are simply combined to form the bi-prediction motion vector.
2) Otherwise, if Mv1 and Mv2 are from the same list, only uni-prediction motion Mv2 is stored.

### 2.23.4 Motion Vector Storing Process for Triangle Merge Mode (Alternative Description)

The variables numSbX and numSbY specifying the number of 4×4 blocks in the current coding block in horizontal and vertical direction are set equal to numSbX=cbWidth>>2 and numSbY=cbHeight>>2.

Where cbWidth and cbHeight specifying the width and the height of the current coding block in luma samples,

The variable minSb is set equal to min(numSbX, numSbY)−1.

The variable cbRatio is derived as follows:

$$cbRatio = ( cbWidth > cbHeight ) ? ( cbWidth / cbHeight ) : ( cbHeight / cbWidth ) .$$

For each 4×4 subblock at subblock index (xSbIdx, ySbIdx) with xSbIdx=0 . . . numSbX−1, and ySbIdx=0 . . . numSbY−1, the following applies:
The variables xIdx and yIdx are derived as follows:

$$xIdx = ( cbWidth > cbHeight ) ? ( xSbIdx / cbRatio ) : xSbIdx \\ yIdx = ( cbWidth > cbHeight ) ? ySbIdx : ( ySbIdx / cbRatio )$$

The variable sType is derived as follows:
   If triangleDir is equal to 0, the following applies:

$$sType = ( xIdx == yIdx ) ? 2 : ( ( xIdx > yIdx ) ? 0 : 1 )$$

Otherwise (triangleDir is equal to 1), the following applies:

$$sType = ( xIdx + yIdx == min Sb ) ? 2 : ( ( xIdx + yIdx < min Sb ) ? 0 : 1 )$$

where triangleDir specifies the partition direction.

As shown in FIG. 33, sType equal to 0 corresponds to P1 area; sType equal to 1 corresponds to P2 area; sType equal to 2 corresponds to the weighted area.

The motion information of P1 area is denoted as (Mv1,refIdx1); the motion information of P2 area is denoted as (Mv2,refIdx2).
Depending on the value of sType, the following assignments are made:
   If sType is equal to 0, the motion information of the 4×4 subblock is (Mv1,refIdx1).
   If sType is equal to 1, the motion information of the 4×4 subblock is (Mv2,refIdx2).
   Otherwise (sType is equal to 2), the following applies:
   1) If Mv1 and Mv2 are from different reference picture lists (one from L0 and the other from L1), then Mv1 and Mv2 are simply combined to form the bi-prediction motion vector.
   2) Otherwise, if Mv1 and Mv2 are from the same list, only uni-prediction motion Mv2 is stored.

### 2.24. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m,n∈{3 . . . 6} excluding 8×64 and 64×8.

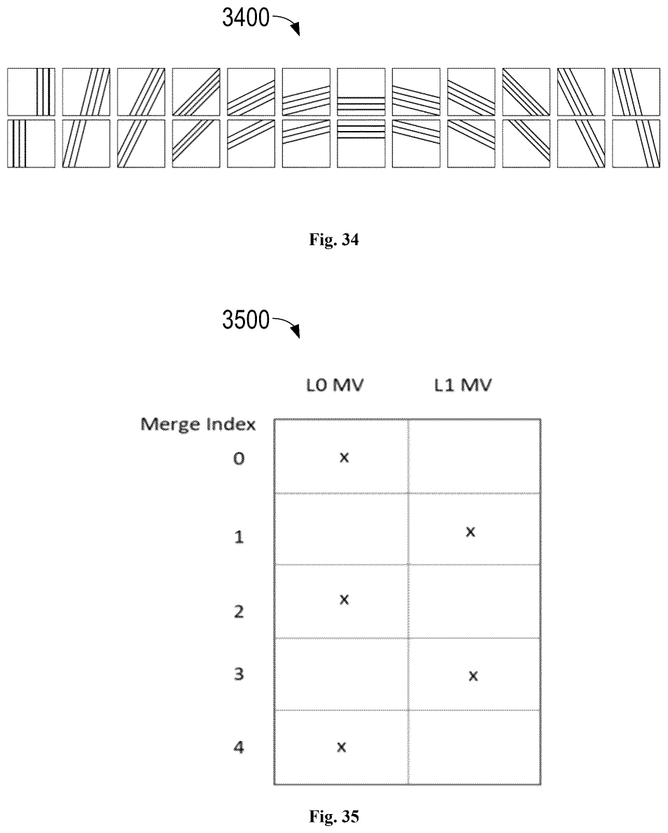

When this mode is used, a CU is split into two parts by a geometrically located straight line (FIG. 34). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 2.24.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.24.2. This is the prediction signal for the whole CU, and transform and quantization process will be applied to the whole CU as in other prediction modes. Finally, the motion field of a CU predicted using the geometric partition modes is stored as in 2.24.3.

### 2.24.1 Uni-Prediction Candidate List Construction

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 35. In case a corresponding LX motion vector of the n-the extended merge candidate does not exist, the L(1−X) motion vector of the same candidate is used instead as the uni-prediction motion vector for geometric partitioning mode.

### 2.24.2 Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 1 )$$

$${ρ}_{j} = {ρ}_{x , j} cos ( {φ}_{i} ) + {ρ}_{y , j} sin ( {φ}_{i} ) \qquad ( 2 - 2 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 3 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 4 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 2 - 5 )$$

$${w}_{0} ( x , y ) = \frac{Clip 3 ( 0 , 8 , ( wIdx L ( x , y ) + 4 ) ≫ 3 )}{8} \qquad ( 2 - 6 )$$

$${w}_{1} ( x , y ) = 1 - {w}_{0} ( x , y ) \qquad ( 2 - 7 )$$

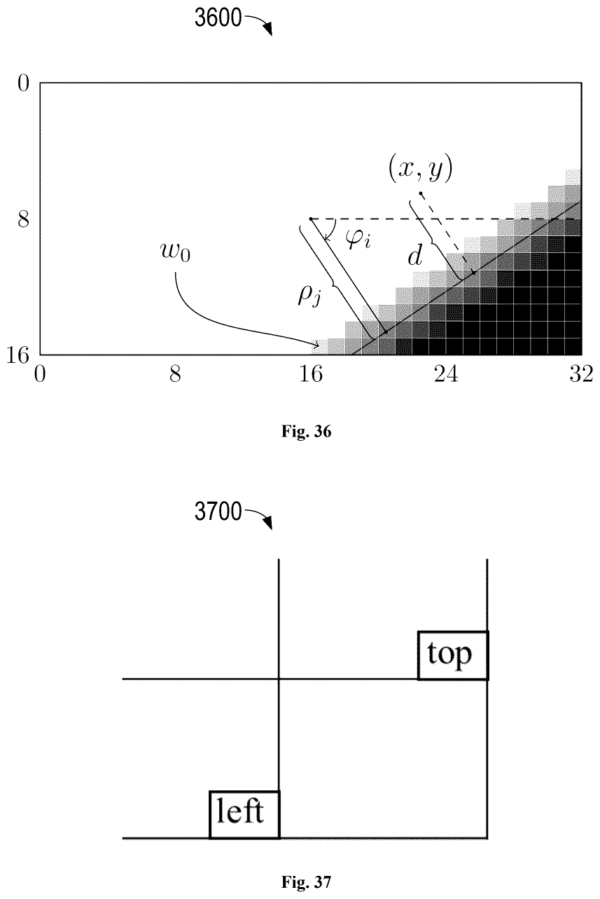

The partIdx depends on the angle index i. One example of weigh w₀ is illustrated in FIG. 36.

### 2.24.3 Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 8 )$$

where motionIdx is equal to d(4×+2, 4y+2), which is recalculated from equation (2-1). The partIdx depends on the angle index i.

If sType is equal to 0 or 1, Mv1 or Mv2 are stored in the corresponding motion field, otherwise if sType is equal to 2, a combined My from Mv1 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.25. Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 37) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{i n t e r} + w t * {P}_{i n t r a} + 2 ) ≫ 2.$$

### 2.26. Decoder Side Intra Mode Derivation (DIMD)

When DIMD is applied, two intra modes are derived from the reconstructed neighbor samples, and those two predictors are combined with the planar mode predictor with the weights derived from the gradients. Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.27. IBC Motion Candidates

The detailed solutions below should be considered as examples to explain general concepts. These solutions should not be interpreted in a narrow way. Furthermore, these solutions can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

The non-adjacent spatial candidates of current coding block are adjacent spatial candidates of a virtual block in the ith search round (as shown in FIG. 9). The width and height of the virtual block for the ith search round are calculated by: newWidth=i×2×gridX+W, newHeight=i×2×gridY+H. Obviously, the virtual block is the current block if the search round i is 0.

In the following, a BV predictor also is a BV candidate. The skip mode also is the merge mode.

The BV candidates can be divided into several groups according to some criterions. Each group is called a subgroup. For example, take adjacent spatial and temporal BV candidates as a first subgroup and take the remaining BV candidates as a second subgroup; In another example, take the first N (N≥2) BV candidates as a first subgroup, take the following M (M≥2) BV candidates as a second subgroup, and take the remaining BV candidates as a third subgroup.

### On Usage of a BV Candidate

1. A BV candidate (e.g. BV searching point or BV predictor) is disallowed to be used in the coding/decoding process of a block if it is invalid.
   a. In one example, only if a BV candidate is valid, it may be used in the coding/decoding process of a block.
      i. For example, only if a BV candidate is valid, it may be used for BV search or BV prediction.
   b. In one example, whether to use a BV candidate in the coding/decoding process of a block may be dependent on a validation check of the BV candidate.
      i. In one example, before inserting a new BV candidate into a BV candidate list, a validation check of the BV candidate needs to be performed.
   c. Only if a BV candidate is valid, it may be inserted into an IBC candidate list.
      i. In one example, the IBC candidate list may be the IBC merge candidate list.
      ii. In one example, the IBC candidate list may be the IBC AMVP candidate list.
      iii. In one example, the IBC candidate list may be the IBC template matching candidate list.
      iv. In one example, the IBC candidate list may be the intra template matching candidate list.
      v. In one example, the IBC candidate list may be the IBC MMVD candidate list.
      vi. In one example, the IBC candidate list may be the IBC GPM candidate list.
      vii. In one example, the IBC candidate list may be the IBC TPM candidate list.
      viii. In one example, the IBC candidate list may be any list related to IBC coded blocks, i.e., the same procedure is applied.
         (i) Alternatively, whether to allow an invalid BV candidate to be added to an IBC candidate list may be dependent on the decoded information (e.g., IBC mode).
   d. Only if a BV candidate is valid, it may be used for hash-based search for IBC.
   e. Only if a BV candidate is valid, it may be used for block matching based local search for IBC.
   f. Only if a BV candidate is valid, it may be used for intra template matching.
   g. Alternatively, furthermore, the above mentioned BV candidates may be those from specific neighboring blocks (e.g., adjacent or non-adjacent) or HMVP tables or some virtual candidates generated from these BV candidates.
   h. Alternatively, furthermore, the above mentioned BV candidates may exclude some default candidates (e.g., the default zero vectors).
   i. Alternatively, furthermore, when a BV candidate is marked as invalid, a virtual candidate derived from the invalid BV candidate may be used instead.
      i. In one example, the virtual candidate may be derived by adding an offset to the invalid BV candidate.
      ii. In one example, the virtual candidate may be derived by applying a clipping function to the invalid BV candidate.

### On Validation Check of a BV Candidate

2. In one example, a BV candidate may be determined to be valid when it meets one of or a combination of at least one of the following conditions.
   a. The corresponding reference block is already reconstructed inside the current picture.
   b. The corresponding reference block is located in the same CTU row as current block.
   c. The corresponding reference block is located in the same tile/subpicture as current block.
   d. The corresponding reference block is located in the same slice as current block.
   e. The BV candidate satisfies the block vector constraints (e.g. which is described in 2.4.2 and 2.4.3).
   f. The BV candidate satisfies the IBC virtual buffer conditions (e.g. which is described in 2.4.4).
3. In one example, a BV candidate may be determined to be invalid when it violates one of or a combination of at least one of the conditions in bullet 2.

### On BV Candidate List

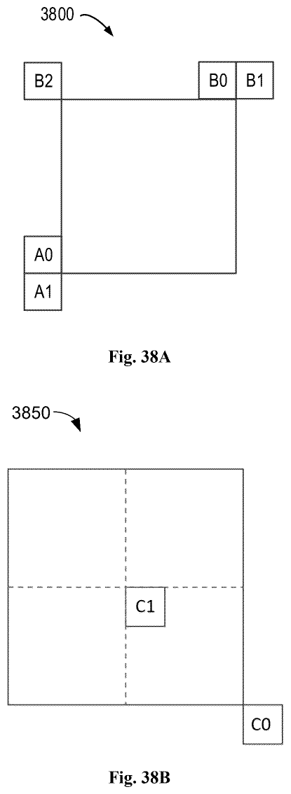

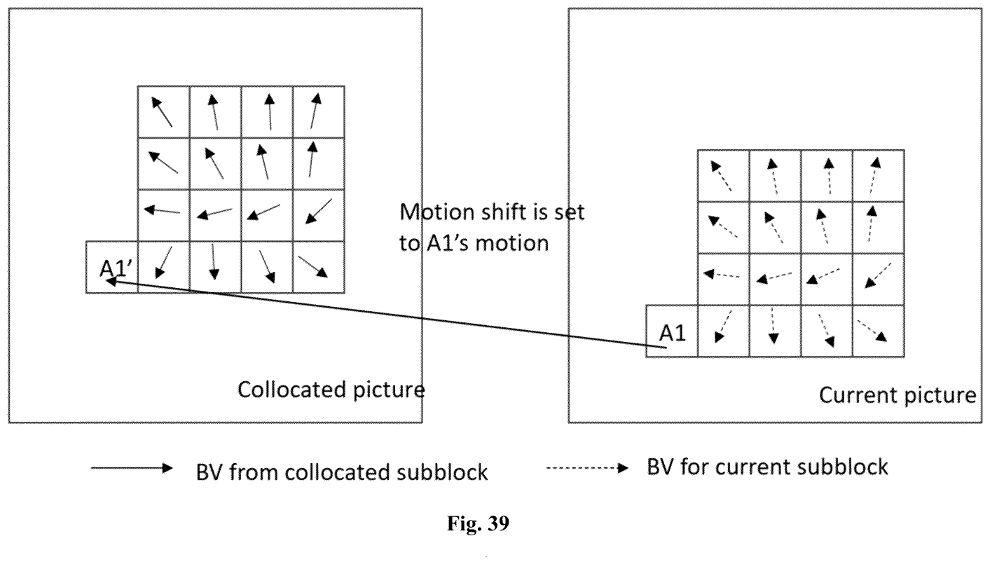

4. A BV candidate may be derived/obtained from a non-adjacent block.
   a. In one example, the distances between non-adjacent spatial candidates and current coding block may be based on the width and height of current coding block (e.g. FIG. 9 or FIG. 10, gridX=W, gridY=H).
      i. Alternatively, the distances between non-adjacent spatial candidates and current coding block may be multiple of a constant value.
         (i) For example, the multiplication factor is dependent on the search round index (e.g. the multiplication factor is i for the ith search round) and gridX=M, gridY=N (M and N are constant values).
   b. In one example, the non-adjacent spatial candidates may be inserted after the TMVP candidate.
      i. Alternatively, the non-adjacent spatial candidates may be inserted after the adjacent spatial candidates and before TMVP candidate.
5. A BV candidate may come from a spatial neighboring block, a temporal neighboring block, HMVP, pairwise, and/or STMVP candidates.
   a. In one example, the spatial candidates may consist of adjacent and/or non-adjacent spatial candidates.
      i. In one example, the adjacent spatial candidates may consist of left and/or above and/or above-right and/or bottom-left and/or above-left spatial candidates (an example is shown in FIG. 38A).
   b. In one example, for the TMVP candidate, the position for the temporal candidate is selected between candidates C0 and C1, as depicted in FIG. 38B. If CU at position C0 is not available, is intra coded, is outside of the current row of CTUs or its BV is invalid for current block, position C1 is used. Otherwise, position C0 is used in the derivation of the TMVP candidate.
      i. Alternatively, for the TMVP candidate, both candidates C0 and C1, as depicted in FIG. 38B, can be used.
         (i) For example, the order is C0->C1.
         (ii) Alternatively, the order is C1->C0.
   c. In one example, for the pairwise candidate, pairwise average candidates are generated by averaging predefined pairs of candidates in the existing BV candidate list, and the predefined pairs are defined as {(0, 1), (0, 2), (1, 2), (0, 3), (1, 3), (2, 3)}, where the numbers denote the BV candidate indices to the BV candidate list.
      i. In one example, the number of pairwise candidates is P. P is an integer from 0 to 6.
      ii. In one example, the pairwise candidates may be inserted after HMVP.
   d. In one example, for the STMVP candidate, it is generated by averaging predefined E spatial BV candidates and predefined G temporal BV candidates.
      i. In one example, E is less than or equal to the number of spatial candidates (F) inserted into the current BV candidate list before STMVP.
      ii. In one example, the predefined E spatial BV candidates may be the first E spatial BV candidates among the F spatial candidates inserted into the current BV candidate list before STMVP.
         (i) Alternatively, the predefined E spatial BV candidates may be the selected E spatial BV candidates among the F spatial candidates inserted into the current BV candidate list before STMVP.
      iii. In one example, E is 2, G is 1.
      iv. In one example, STMVP may be inserted before the above-left spatial BV candidate.
      v. In one example, STMVP may be inserted after the pairwise candidate.
   e. In one example, the BV candidate inserting order is adjacent spatial->HMVP->pairwise.
   f. In one example, the BV candidate inserting order is adjacent spatial->temporal->HMVP->pairwise.
   g. In one example, the BV candidate inserting order is adjacent spatial->temporal->non-adjacent spatial->HMVP->pairwise.
   h. In one example, the BV candidate inserting order is adjacent spatial->non-adjacent spatial->HMVP->pairwise.
   i. In one example, the BV candidate inserting order is adjacent spatial (STMVP is inserted before the above-left spatial BV candidate)->temporal->non-adjacent spatial->HMVP->pairwise.
6. A BV candidate list may also consist of clipped BV candidates.
   a. In one example, if a BV candidate is invalid from the sense of the 3^{rd} bullet, it may be converted to a valid BV following a given rule and then inserted into the BV candidate list.
      i. In one example, a BV candidate may be converted to the nearest valid BV candidate.
      ii. In one example, a BV candidate may be converted to the nearest valid BV candidate from a predefined BV candidate set.
   b. In one example, if a non-zero BV candidate is invalid, it may be clipped to the nearest valid BV and then inserted into the BV candidate list.
   c. In one example, if a non-zero BV candidate is invalid, it may be clipped to the nearest valid BV from a predefined BV candidate set and then inserted into the BV candidate list.
      i. In one example, the predefined BV candidate set may consist of (−m*W,0), (0,−n*H), (−m*H,0), (0,−n*W). m and n are positive values.
   d. In one example, the clipped BV candidates may be inserted after the non-clipped BV candidates.
7. The BV candidate list can be used as IBC merge/AMVP candidate list.
   a. Alternatively, the BV candidate list can be used to derive IBC merge/AMVP candidate list.
      i. In one example, for IBC merge mode, the first R entries of the BV candidate list will be used to construct the IBC merge candidate list; for IBC AMVP mode, the first S entries of the BV candidate list will be used to construct the IBC AMVP candidate list.
         (i) In one example, R is 6, S is 2.
8. In one example, subblock-based temporal block vector prediction (SbTBVP) may be supported as a BV candidate or a BV prediction mode.
   a. Similar to the SbTMVP, SbTBVP uses the BV motion field in the collocated picture to improve block vector prediction and IBC merge mode for CUs in the current picture. The same collocated picture used by TMVP is used for SbTBVP.
   b. In one example, SbTBVP applies a motion shift before fetching the temporal BV information from the collocated picture, where the motion shift is obtained from the motion vector from one of the spatial neighboring blocks of the current CU (an example is shown in FIG. 39).
      i. In one example, if A1 has a motion vector that uses the collocated picture as its reference picture, this motion vector is selected to be the motion shift to be applied. If no such motion is identified, then the motion shift is set to (0, 0).
      ii. In one example, other spatial candidate positions (e.g. A0, B0, B1, B2) can be used to derive the motion shift.
         (i) In one example, the checking order may be A1->B1->B0->A0->B2.
         (ii) In one example, the checking order may be B1->A1->B0->A0->B2.
         (iii) In one example, the checking order may be A0->A1->B0->B1->B2.
   c. In one example, after deriving the motion shift, for each sub-CU, the BV information of its corresponding block (the smallest motion grid that covers the center sample) in the collocated picture is used to derive the BV information for the sub-CU (The example in FIG. 39) assumes the motion shift set to block A1's motion).

### On Reordering of BV Candidate List

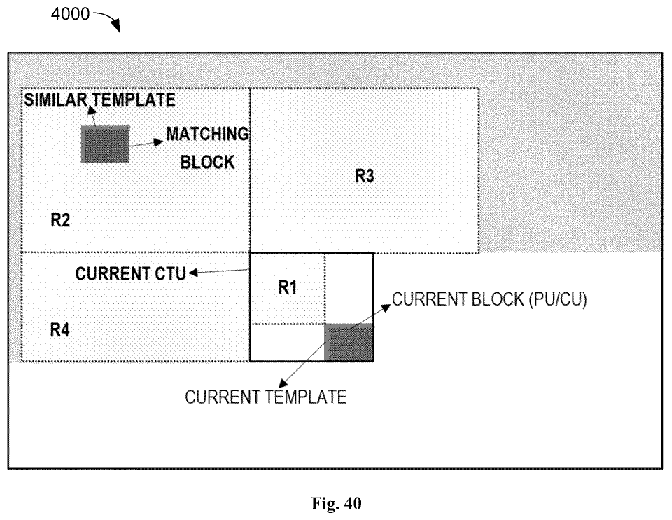

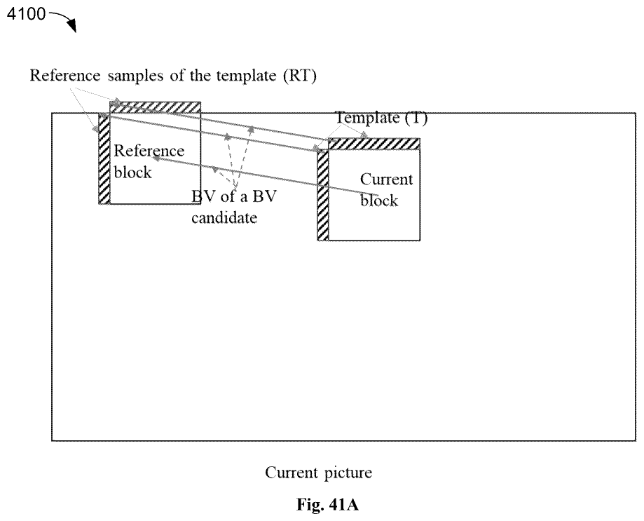

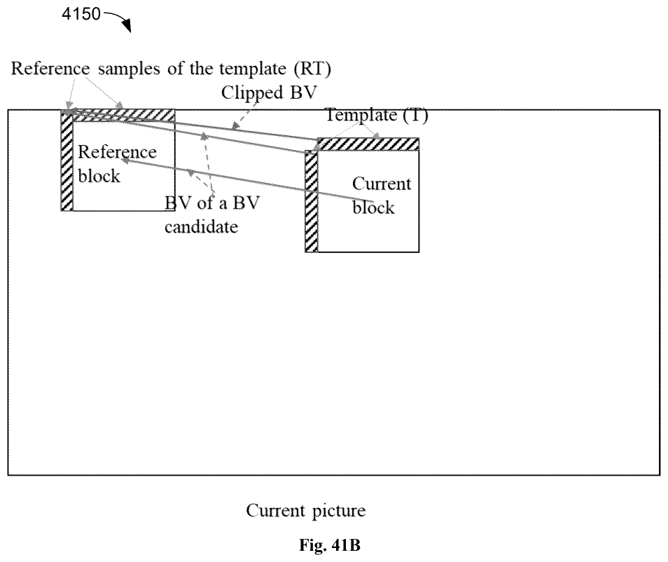

9. An initial BV candidate list may be firstly derived, followed by a reordering/refined process. And the reordered/refined list is utilized in the coding/decoding process of a block.
   a. In one example, the BV candidate list may be the IBC merge candidate list.
   b. In one example, the BV candidate list may be the IBC AMVP candidate list.
   c. In one example, the BV candidate list may be the IBC template matching candidate list.
   d. In one example, the BV candidate list may be the intra template matching candidate list.
   e. In one example, the BV candidate list may be the IBC MMVD candidate list.
   f. In one example, the BV candidate list may be the IBC GPM candidate list.
   g. In one example, the BV candidate list may be the IBC TPM candidate list.
   h. Alternatively, the reordering/refined process may be not applied to the IBC AMVP candidate list.
   i. Alternatively, the reordering/refined process may be not applied to the IBC GPM candidate list.
   j. Alternatively, the reordering/refined process may be not applied to the IBC TPM candidate list.
   k. In one example, the reordering/refined process may be applied to all kinds of IBC coded blocks, i.e., the same procedure is applied.
      i. Alternatively, whether to apply the reordering/refined process may be dependent on the decoded information (e.g., IBC mode).
         (i) In one example, it is applied to IBC merge/skip mode, but not applied to IBC AMVP mode.
10. The BV candidates can be adaptively rearranged in the final BV candidate list according to one or some criterions.
   a. In one example, partial or full process of current BV candidate list construction process is firstly invoked, followed by the reordering of candidates in the list.
      i. Alternatively, candidates in a first subgroup may be reordered and they should be added before those candidates in a second subgroup wherein the first subgroup is added before the second subgroup.
   b. In one example, all the BV candidates in the BV candidate list may be reordered together (i.e. no subgroup).
      i. Alternatively, partial of the BV candidates in the BV candidate list may be reordered together (i.e. no subgroup).
         (i) The BV candidates to be reordered may be selected based on coding information or signaling.
   c. In one example, the criterion may be based on template matching cost.
      i. In one example, the cost function between current template and reference template may be:
         (i) SAD/MR-SAD;
         (ii) SATD/MR-SATD;
         (iii) SSD/MR-SSD;
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
      ii. In one example, the current template and reference template may consist of samples in the mapped domain if LMCS is enabled.
         (i) Alternatively, the current template and reference template may consist of samples in the original domain.
      iii. In one example, BV candidates in each subgroup may be reordered ascendingly according to cost values based on template matching.
      iv. In one example, if only above template is available for current block, the template matching reorder can only use the above template.
      v. In one example, if only left template is available for current block, the template matching reorder can only use the left template.
      vi. In one example, if both above and left templates are available for current block, the template matching reorder can use the left template, the above template, or both above and left templates.
      vii. In one example, the template matching procedure may comprise one component such as luma.
         (i) Alternatively, the template matching procedure may comprise multiple components such as luma and chroma.
         a) In one example, the total template matching cost may be calculated as a weighted sum of template matching costs on different color components.
      viii. In one example, the width of the left template and/or the height of the above template may be fixed.
         (i) In one example, the width of the left template may be 1.
         (ii) In one example, the height of the above template may be 1.
      ix. In one example, the BV for locating the reference template may be clipped.
         (i) In one example, if the reference template is outside the current picture (as shown in FIG. 41A), the BV for locating the reference template may be clipped to make the reference template locating inside the current picture. The clip operation will not change the BV of the corresponding BV candidate. An example is shown in FIG. 41B.
      x. In one example, if the reference template is outside the current picture (as shown in FIG. 41A), the corresponding BV candidate can still be reordered.
         (i) In one example, if the reference template is outside the current picture, it can be padded from the nearest samples inside the current picture.
      xi. In one example, the reference template should be already reconstructed inside the current picture.
         (i) In one example, if the reference template is not reconstructed or outside the current picture, the corresponding BV candidate may be not reordered.
      xii. In one example, the samples included in the reference template should be available (e.g., being reconstructed and within the same slice/tile/IBC virtual buffer).
         (i) Alternatively, furthermore, if some or all samples included in the reference template are unavailable, the above methods that handle reference template outside current picture may be applied.
   d. In one example, whether to and/or how to reorder the BV candidates may depend on the category of the BV candidates.
   e. In one example, the BV candidates to be reordered can be the BV candidates in the final BV candidate list.
      i. Alternatively, the BV candidates to be reordered can be partial/all the adjacent spatial BV candidates even it may not be included in the final BV candidate list.
      ii. Alternatively, the BV candidates to be reordered can be partial/all the non-adjacent spatial BV candidates even it may not be included in the final BV candidate list.
      iii. Alternatively, the BV candidates to be reordered can be partial/all the HMVP BV candidates even it may not be included in the final BV candidate list.
      iv. Alternatively, the BV candidates to be reordered can be partial/all the pairwise average BV candidates even it may not be included in the final BV candidate list.
      v. Alternatively, the BV candidates to be reordered can be partial/all the STMVP BV candidates even it may not be included in the final BV candidate list.
11. The template shape may be adaptive.
   a. In one example, the template may only comprise neighboring samples left to the current block.
   b. In one example, the template may only comprise neighboring samples above to the current block.
   c. In one example, the template shape is selected according to the CU shape.
   d. In one example, the width of the left template is selected according to the CU height.
      i. For example, if H<=M, then the left template size is w1×H; otherwise, the left template size is w2×H.
   e. In one example, M, w1, and w2 are set equal to 8, 1, and 2, respectively.
   f. In one example, the height of the above template is selected according to the CU width.
      i. For example, if W<=N, then the above template size is W×h1; otherwise, the above template size is W×h2.
         (i) In one example, N, h1, and h2 are set equal to 8, 1, and 2, respectively.
   g. In one example, the width of the left template is selected according to the CU width.
      i. For example, if W<=N, then the left template size is w1×H; otherwise, the left template size is w2×H.
         (i) In one example, N, w1, and w2 are set equal to 8, 1, and 2, respectively.
   h. In one example, the height of the above template is selected according to the CU height.
      i. For example, if H<=M, then the above template size is W×h1; otherwise, the above template size is W×h2.
         (i) In one example, M, h1, and h2 are set equal to 8, 1, and 2, respectively.
   i. In one example, samples of the template and the reference samples of the template samples may be subsampled or downsampled before being used to calculate the cost.
      i. Whether to and/or how to do subsampling may depend on the CU dimensions.
      ii. In one example, no subsampling is performed for the short side of the CU.
12. In one example, the cost disclosed in bullet 10 may be derived for a first BV candidate, which may be or may not be put into a BV candidate list.
   a. In one example, whether to put the first BV candidate into the BV candidate list may depend on the cost derived for the first BV candidate.
   b. In one example, whether to put the first BV candidate into the BV candidate list may depend on a comparison between a first cost derived for the first BV candidate and a second cost derived for a second BV candidate, which may be or may not be put into a BV candidate list.
13. In one example, for the intra TMP, the L-shaped template can be replaced with the above and left templates which excluding the above-left part (an example is shown in FIG. 40).
   a. In one example, if only above template is available for current block, the intra TMP can only use the above template.
   b. In one example, if only left template is available for current block, the intra TMP can only use the left template.
   c. In one example, if both above and left templates are available for current block, the intra TMP can use the left template, the above template, or both above and left templates.
      2.28. On Motion Vector Difference (MVD) Sign Prediction and Extended Merge with MVD (MMVD) Reordering and MMVD Coding

The detailed solutions below should be considered as examples to explain general concepts. These solutions should not be interpreted in a narrow way. Furthermore, these solutions can be combined in any manner.

The methods disclosed below may be applied to MMVD, and extensions of MMVD (e.g., the affine MMVD or GPM MMVD (GMVD), MMVD for IBC mode, MMVD for affine IBC mode). In the following descriptions, the terminology ‘MMVD’ may be utilized to represent a coding tool wherein partial of motion information (e.g., reference picture index, prediction direction from List 0/1, and base motion vectors) is inherited from a candidate while indication of some additional refinement of refined motion information (e.g., refined my differences) is further signaled in the bitstream.

### On Extension of Directions Used in MMVD Design.

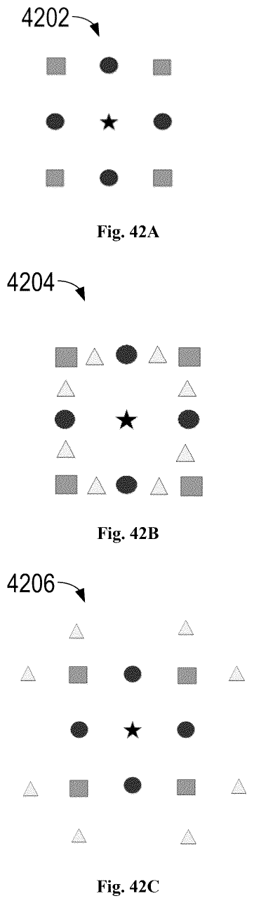

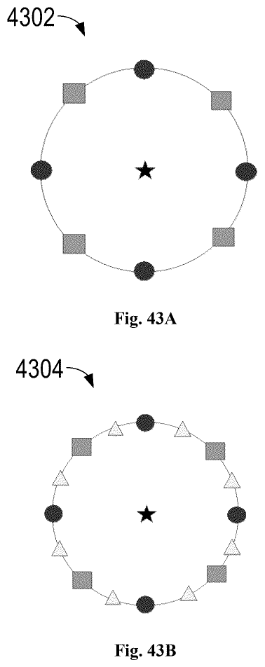

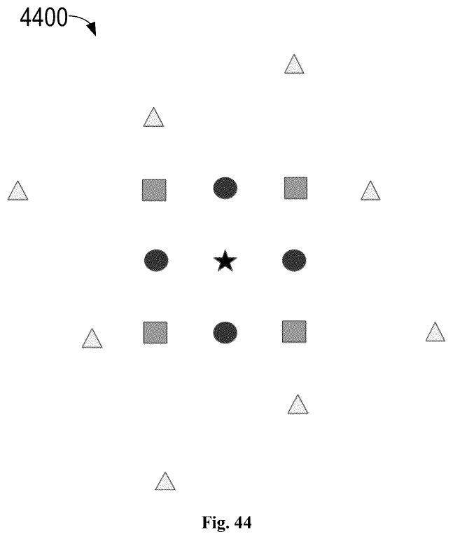

1. Slash/asymmetric directions or diagonal directions may be utilized for MMVD coded blocks.
   a. The diagonal direction may be defined as M*pi/N wherein M and N are both non-zero integers, M<N.
      i. In one example as depicted in FIG. 42A with square dot, at least one of the four diagonal direction positions could be added to the original four horizontal and vertical directions.
      ii. In one example as depicted in FIG. 42B with square dots and triangle dots, at least one of the additional 8 directions could be added to the previous 8 directions at angles k*pi/8.
      iii. In one example as depicted in FIG. 42C with square dots and triangle dots, at least one of the additional 8 directions could be added to the previous 8 directions at angles k*pi/8, with asymmetric distance offset.
      iv. In one example, at least one of the additional 16 directions could be added to the previous 16 directions at angles k*pi/16.
      v. In one example as depicted in FIG. 43 with square dots and triangle dots, at least one of the additional 4 or 8 directions could be added to the previous 4 or 8 directions at angles k*pi/8, with exact similar distance offset around a circle.
   b. Asymmetric angles and/or with asymmetric distances may be utilized in the MMVD design.
      i. One example is as depicted in FIG. 44, wherein square dots and triangle dots present the additional directions.
   c. The directions mentioned above may be added as additional directions in addition to those in the prior art.
      i. Alternatively, it may be used to replace at least one of the existing directions defined in the prior art.
   d. In one example, the additional asymmetric/slash offset or additional diagonal directions for MMVD and/or its extensions (e.g., affine MMVD) may be indicated by an index to be coded jointly or separately for the directional and distance offsets.
      i. In one example, the index may be coded with truncated binary/binary code.
      ii. In one example, the index may be all coded using truncated unary code.
      iii. In one example, the index may be all coded using Rice or exponential Golomb code of order k which k could be 0, 1, or any number.
         (i) In one example, the rice code with parameter 1, 2, 4, 8 or any other number may be used.
      iv. In one example, the prefix and suffix of the codes may be coded in any combination of bypass and context coded bin.
      v. In one example, the index could be coded in bypass mode.
      vi. In one example, the index could be coded in context mode.
      vii. In one example, at least one bin of the index (such as only the first bin) may be context coded.
      viii. In one example, the first N bins may be context coded. The context coded may share the same context or have independent context.
2. Whether to and/or how many directions should be utilized may be signaled or derived on-the-fly (e.g., according to decoded information).
   a. In one example additional directions could be added only for some particular block sizes.
      i. In one example additional direction may be added to blocks with width*height>C1.
         (i) An example for C1 could be 64 or 256.
      ii. In one example additional direction may be added to blocks with width*height<C1.
         (i) An example for C1 could be 64 or 256.
      iii. In one example additional direction may be added to blocks with width>C1 and/or height>C2.
         (i) An example for C1 and C2 could be 16 and 32 respectively.
      iv. In one example additional direction may be added to blocks with width<C1 and/or height<C2.
         (i) An example for C1 and C2 could be 16 and 32 respectively.
      v. The thresholds C1/C2 mentioned above may be pre-defined or signaled in the bitstream.
   b. In one example, whether to apply additional directions and/or which additional directions to be used may be based on the picture resolution and/or reference picture list and/or low-delay check flag.
   c. In one example, whether to apply additional directions and/or which additional directions to be used, may be signaled from an encoder to a decoder such as in SPS/PPS/VPS/APS/slice header/picture header/CTU/CU/PU, etc.
      i. For example, pictures at low temporal layers may use more directions, and/or pictures at high temporal layers may use fewer directions.
   FIGS. 42A-42C illustrate adding diagonal angles, where square dots represent new pi/4 diagonal angels (FIG. 42A), adding pi/8 angles, where square and triangle dots represent the new pi/8 angels, with roughly similar size (FIG. 42B), or different size (FIG. 42C).
   FIGS. 43A-43B illustrate adding diagonal angles, where square dots represent new pi/4 diagonal angels (FIG. 43A), adding pi/8 angles, where square and triangle dots represent the new pi/8 angels, with exact similar distance around a circle.

### On Extension of Distance Offsets Used in MMVD Design.

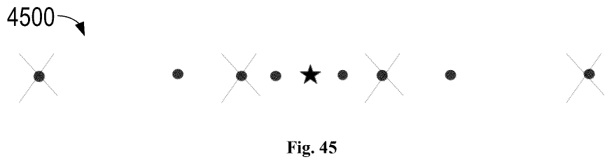

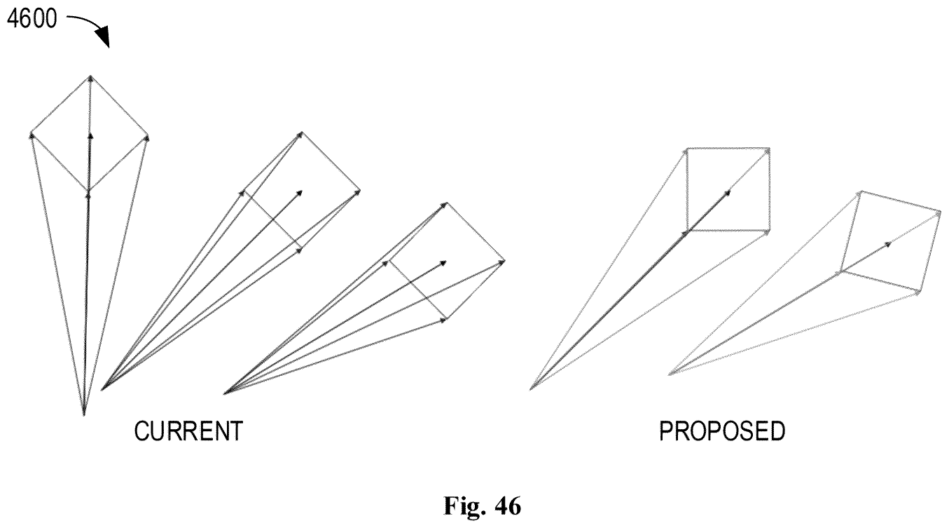

3. It is proposed that at least one extra distance could be added to or at least one existing distance could be removed from the original distance set (or candidate list) for MMVD mode and/or extensions of MMVD mode.
   a. It is proposed that at least one extra distance offset could be added to the original 8 distance offsets for MMVD and/or GMVD and 5 original distance offsets for Affine MMVD refinement candidates.
   b. Alternatively, at least one distance offset may be removed from the original 8 distance offsets for MMVD and 5 original distance offsets for Affine MMVD refinement candidates.
   c. In one example, at least one additional distance offset could be added between and/or beyond the original 8 MMVD distance offsets. The number of additional distance offsets could be 4 or 8 or any other number.
   d. In one example, at least one additional distance offset could be added between and/or beyond the original 5 Affine MMVD distance offsets. The number of additional distance offsets could be 4, 5, or 8 or any other number.
   e. In one example, at least one additional distance offset could be added only between two distance offsets, which are both smaller than a threshold.
   f. In one example, at least one additional distance offset could be added only between two distance offsets, which are both larger than a threshold.
   g. In one example some distance offsets could be removed, and the number of the distance offsets could be reduced to N (e.g. 3, or 4, or 5).
   h. In one example, every other distance offset could be removed starting removal from the 2^{nd} distance offset as depicted in FIG. 45.
   i. In one example, every other distance offset could be removed starting removal from the first distance offset.
   j. In one example, the first half distance offsets (e.g., idx 0, 1, 2, 3 for MMVD) could be removed.
   k. In one example, the second half (e.g., idx 4, 5, 6, 7 for MMVD) could be removed.
   l. In one example the final offsets which may be indicated as a joint index for all offsets or divided to 2 indexes for directional and distance offset, may be coded with Truncated unary code, or truncated binary code, or Rice code of parameter R or Exponential Golomb code of order k, with any combination of bypass and context coded bin.
4. The initial distance offset candidate list may be pre-defined or signaled or derived on-the-fly.
   a. In one example, depending on the block size, initial distance offset candidate list may be chosen.
      i. As an example, one set of distance offsets is chosen for blocks with width*height>C and a different set is chosen for the remaining.
5. It is proposed that whether to apply additional direction(s) and/or additional offset(s), and/or which additional direction(s) and/or additional offset(s) should be applied, could be dependent on the original base motion vector direction and/or its magnitude, for MMVD and/or extensions of MMVD (e.g. Affine MMVD and/or GMVD).
   a. In one example, the initial offset could be determined by the base MV magnitude.
      i. MV magnitude may be derived by MVx and MVy. E.g., MV magnitude is calculated as |MVx|+|MVy|.
      ii. MV magnitude may be derived by MVx and MVy. E.g., MV magnitude is calculated as (MVx)\hat{ }2+(MVy)\hat{ }2.
      iii. If both the Ref0 and Ref1 are available, the magnitude may be a weighted average of the MV length of each of the Ref list MV.
      iv. For Affine MMVD, the top-left control point MV magnitude of the base affine MVs could be used to determine the initial offset with those methods specified in i, ii, iii.
   b. In one example, the initial distance offset for MV magnitude>C1 could be larger than the initial distance offset for MV magnitude<CL.
      i. In one example, the initial distance offset for MV magnitude>C1 could be N times of the initial distance offset for MV magnitude<C1, where C1 for example could be 50 pixels, and N for example could be 2.
   c. In one example, at least one directional offset could be derived from the base MV. For Affine MMVD, the top-left control point MV of the base affine MVs could be used to derive the additional directional offset.
      i. In one example, this directional offset could be precise, such as being parallel or perpendicular to that of the original base MV as depicted in FIG. 46.
      ii. In one example, an additional directional offset could be approximated, such as if the base MV direction is between pi/8 and 3pi/8, diagonal directional offset could be used, otherwise vertical/horizontal directional offset would be used.
      iii. directional offsets may replace the offsets in the original design of MMVD/GMVD/affine MMVD.
         I. Alternatively, directional offsets may be added to be used together with the original design of MMVD/GMVD/affine MMVD.

### MMVD Reordering

6. It is proposed the base motion candidates and/or motion candidates after refinement (e.g., by adding the MVD) for MMVD mode and/or extensions of MMVD (e.g., the affine MMVD or GPM MMVD (GMVD), MMVD for IBC mode, MMVD for affine IBC mode) mode may be reordered.
   a. In one example, the reordering process should be performed before the MMVD refinement method being interpreted from at least one syntax elements.
   b. In one example, the N1 refinement steps as well as N2 directions as well as N3 base candidates which construct N1*N2*N3 possibilities may be reordered together.
      i. N1 may be 4, 5, 8, 16 or any other number. N2 may be 2, 4, 6, 8, 16, 32 or any other numbers. N3 maybe 1, 2, 3, 4, or any other numbers.
   c. In one example, N possible refinement positions (could be asymmetric for direction, or step, or no clear direction or steps) as well as N3 base candidates which construct N*N3 possibilities may be reordered together.
   d. In one example, the reordering process could be done for each base candidate separately.
      i. For example, the N1 refinement steps as well as N2 directions which construct N1*N2 possibilities may be reordered together, for each base candidate.
      ii. For example, if there are total of N possible refinement positions (could be asymmetric for direction, or step, or no clear direction or steps) may be reordered together, for each base candidate.
      iii. In one example, the base candidates may be reordered in advance. Afterwards, the refinement of the first base candidate is further applied.
         (i) For example, the N1 refinement steps as well as N2 directions which construct N1*N2 possibilities may be reordered together, for the first base candidate.
         (ii) For example, if there are total of N possible refinement positions (could be asymmetric for direction, or step, or no clear direction or steps) may be reordered together, for the first base candidate.
   e. In one example, the reordering process could be done for candidates with a same base candidate and a same direction separately. For example, the N1 refinement steps may be reordered together, for candidates with a same base candidate and a same direction independently.
   f. In one example, the reordering process could be done for candidates with a specified base candidate and a specified direction separately. For example, the N1 refinement steps may be reordered together, for candidates with a specified base candidate and a specified direction independently.
   g. In one example, the reordering process could be done for candidates with a same base candidate and a same refinement step separately. For example, the N2 directions may be reordered together, for candidates with a same base candidate and a same refinement step independently.
   h. In one example, the reordering process could be done for candidates with a specified base candidate and a specified refinement step separately. For example, the N2 directions may be reordered together, for candidates with a specified base candidate and a specified refinement step independently.
   i. In one example any subgroup of the possible options could be reordered just inside of that subgroup.
      i. In one example, the subgroup is divided from all the candidates for MMVD according to the direction.
      ii. In one example, the subgroup is divided from all the candidates for MMVD according to the distance.
      iii. In one example, the subgroup is divided from all the candidates for MMVD according to the base candidate.
      iv. In one example, the subgroup is divided from all the candidates for MMVD according to any combinations of direction, distance, and the base candidate.
   j. In one example reordering process may be applied sequentially based on the characteristics.
      i. As an example, first reordering process for base candidates may be performed. Next reordering process for directions may be performed with a fixed distance offset. Finally reordering process for the distance offsets may be performed.
      ii. Alternatively, first reordering process for base candidates may be performed. Next reordering process for each direction and distance combination with a same base candidate may be performed.
      iii. Alternatively, first reordering process for base candidates may be performed. Next reordering process for each direction and distance combination with a specified (e.g., the first) base candidate may be performed.
   k. In one example, the reordered MMVD and/or its extensions (e.g., affine MMVD) may be indicated by an index to be signaled,
      i. In one example, the index may be all coded using truncated unary code.
      ii. In one example, the index may be all coded using truncated binary/binary code.
      iii. In one example, the index may be all coded using Rice or exponential Golomb code of order k which k could be 0, 1, or any number.
         (i) In one example, the rice code with parameter 1, 2, 4, 8 or any other number may be used.
      iv. In one example, the prefix and suffix of the codes may be coded in any combination of bypass and context coded bin.
      v. In one example, the index could be coded in bypass mode.
      vi. In one example, the index could be coded in context mode.
      vii. In one example, at least one bin of the index (such as only the first bin) may be context coded.
         (i) In one example, the first N bins may be context coded. The context coded may share the same context or have independent context.
   l. In one example, base candidate indexes may be coded separately such as in truncated unary or truncated binary in context or bypass coded bins. The remaining directions and distances may be coded as described above.
   m. In one example, after reordering the MMVD candidates, only keep the top N numbers with the lowest costs. N could be any integers. Only the new limited options will be coded.
      i. In one example after reordering the MMVD candidates, only keep the top half with the lowest costs. Only the new limited options will be coded.
      ii. In one example after reordering the MMVD candidates, only keep the top ¼^{th} with the lowest costs. Only the new limited options will be coded.
      iii. In one example after reordering the MMVD candidates, only keep the top ⅛^{th} with the lowest costs. Only the new limited options will be coded.
      iv. In one example after reordering the MMVD candidates, only keep the top 1/16^{th} with the lowest costs. Only the new limited options will be coded.
   n. In one example, only candidates with cost smaller than F*bestCost may be selected. F maybe any number such as 1.2, 2, 2.5, . . . and bestCost is the best (e.g., smallest) template matching cost of the candidates.
   o. In one example, any combination of selecting candidates based on a fixed ratio from best template matching cost, or choosing top N, or limiting based on the block size and/or base MV magnitude and/or base MVdirection may be used.
   p. In one example, the reordering process may be limited to a special block size. As an example, reordering may be applied for blocks with width*height>C and reordering may not be applied for the remaining.
   q. In one example, after reordering process, only the best MMVD candidate may be selected, and no additional index signaling may be necessary.
7. The reordering may be based on a template matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
      i. In one example, the cost may be calculated based on SAD and Boundary_SAD.
         (i) In one example, the cost may be calculated as (SAD+w*Boundary_SAD). w may be pre-defined or signaled or derived according to decoded information.
   c. In one example K1 rows on the top and/or K2 columns on the left and/or K1*K2 samples/pixels on the corner may be used as the template.
      i. K1 and K2 could be any number; as an example, K1 and K2 could be 1, 2, 3, width/2, height/2, width, height.
      ii. Alternatively, only K1 rows on the top are used as the template.
      iii. Alternatively, only K2 columns on the left are used as the template.
      iv. Alternatively, K1 rows on the top and K2 columns on the left are used as the template.
   d. The template matching procedure may comprise one component such as luma.
      i. Alternatively, the template matching procedure may comprise multiple components such as luma and chroma.
         (i) In one example, the total template matching cost may be calculated as a weighted sum of template matching costs on different color components.
   e. In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$RT = ( ( {2}^{N} - w ) * R {T}_{0} + w * {RT}_{1} + {2}^{N - 1} ) ≫ N , for example , N = 3 .$$

f. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.
g. In one example, if the Local Illumination Compensation (LIC) flag of the merge candidate is true, the reference samples of the template are derived with LIC method.
   i. Alternatively, the reference samples of the template are derived without LIC.
h. In one example, when deriving the reference samples of the template, the motion vectors of the merge candidate are rounded to the integer pixel accuracy, where the integer motion vector may be its nearest integer motion vector.
i. In one example, when deriving the reference samples of the template, N-tap interpolation filtering is used to get the reference samples of the template at sub-pixel positions. For example, N may be 2, 4, 6, 8, or 12.
8. Early termination of reordering process may be applied.
   a. In one example, only candidates associated with a certain direction may be further checked under certain conditions are satisfied.
   b. In one example, only candidates associated with a certain distance offset, but different directions may be further checked under certain conditions are satisfied.

### On MVD Sign Prediction

9. It is proposed a sign of MVD, for Advanced Motion Vector Prediction (AMVP) mode and/or its extensions (e.g., affine AMVP), MMVD mode and/or extensions of MMVD (e.g., the affine MMVD or GPM MMVD (GMVD), MMVD for IBC mode, MMVD for affine IBC mode) mode may be predicted (or reordered).
   a. In one example the sign of MVD horizontal component (MVx) may be predicted.
   b. In one example the sign of MVx may be predicted (reordered), and one flag is coded to determine whether the prediction is correct or not.
   c. In one example the sign of MVD vertical component (MVy) may be predicted.
   d. In one example the sign of MVy may be predicted (reordered), and one flag is coded to determine whether the prediction is correct or not.
   e. In one example the signs of the MVx and MVy may be predicted jointly. More precisely, there are 4 possible combinations for the MVx and MVy signs: (+,+), (+,−), (−,+), (−,−). After prediction no extra information may be coded.
   f. In one example, the possible combinations may depend on whether MVx and/or MVy is equal to zero.
   g. In one example the signs of the MVx and MVy may be predicted (reorders), and one flag is coded to determine if the first option chosen or the second. This flag may be context coded or bypass coded.
   h. In one example the signs of the MVx and MVy may be predicted (reordered), and the top N (e.g. N=2, 3, . . . ) options may be signaled with an index which is coded with a non-fixed length code (e.g. Unary or Truncated Unary code, or Binary code). The index may be context coded or bypass coded.
      i. In one example, if a first option is before a second option after reordering, the code length of the first option should be no longer than that of the second option.
   i. In one example, the sign of MVx and/or MVy may be coded with a context coding, wherein the context may be determined by a prediction of MVx and/or MVy.
   j. In one example, the sign of MVx and/or MVy may be coded with a context coding, wherein the context may be dependent on the magnitude of the MVD component.
   k. In one example, the information indicating whether a prediction is correct or not for a MVx and/or a MVy may be signaled conditionally.
      i. In one example, the information may not be signaled if the MVx and/or the MVy is equal to zero.
   l. In one example, the sign of MVx and/or MVy may not be signaled explicitly, but set equal to the prediction value implicitly.
10. The sign prediction (or reordering) of MVD may be based on a template matching approach or bilateral matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. In one example, build MV candidates by creating combination between possible signs and absolute MVD value and add it to the MV predictor. Derive MVD sign prediction cost for each derived MV candidate based on template matching cost or bilateral matching cost and sort the MVD signs ascendingly according to cost values.
      i. In one example, the true MVD sign used finally may be the MVD sign with the smallest MVD sign prediction cost.
      ii. In one example, the true MVD sign used finally may be selected among the first N (e.g. N=2, 3, . . . ) MVD signs in the sorted MVD sign list.
         (i) In one example, the selected MVD sign (i.e. the true MVD sign used finally) may be signaled with a flag or an index. And the flag or index may be context coded or bypass coded.

### On Combination of MVD Sign Prediction and MMVD Reordering

11. It is proposed that any of MVD sign prediction for AMVP mode and/or its extensions (e.g., affine AMVP), MMVD mode and/or its extensions may be combined with any MMVD reordering for MMVD mode and/or extensions of MMVD (e.g., the affine MMVD or GPM MMVD (GMVD), MMVD for IBC mode, MMVD for affine IBC mode).
   a. In one example any MVD sign prediction for AMVP may be combined with any MMVD reordering for MMVD.
   b. In one example any MVD sign prediction for affine AMVP may be combined with any MMVD reordering for affine MMVD.
   c. In one example any MVD sign prediction for AMVP and affine AMVP may be combined with any MMVD reordering for MMVD and affine MMVD.
   d. In one example any MVD sign prediction for AMVP and affine AMVP and affine MMVD, may be combined with any MMVD reordering for MMVD.
   e. In one example any MVD sign prediction for AMVP and affine AMVP and MMVD, may be combined with any MMVD reordering for affine MMVD or its other extensions.
   f. In one example both sign prediction and MMVD reordering, may be applied on MV simultaneously. For example, sign prediction would be applied on MMVD sign, and MMVD reordering may be applied on MMVD magnitude or its base.
   g. In one example, sign prediction may be applied to MVD coding methods excluding MMVD (such as AMVP), but MMVD reordering may be applied to MMVD mode.

### On MMVD for Bi-Prediction Base Candidate

Denote the MVD candidate list of list X (e.g., X=0) as {MvdLXᵢ} wherein i is in the range of [0, M−1] and M is the total number of allowed MVD candidates for list X. The MVD candidate list of list Y (e.g., Y=1−x) as {MvdLYⱼ} wherein j is in the range of [0, N−1] and N is the total number of allowed MVD candidates for list Y.
12. Instead of always signaling the MVD information for list 0, it is proposed to signal the MVD information for list 1.
   a. Alternatively, whether to signal it for list 0 or list 1 may be further indicated in the bitstream or determined on-the-fly (e.g., according to the reference picture information of the base candidate).
13. It is proposed that N and M may be unequal.
   a. In one example, N and/or M may be pre-defined or determined on-the-fly or signalled.
14. It is proposed that the MMVD for bi-prediction may be modified to:
   b. In one example List 0 and list 1 having their own independent MVD wherein the MvdLYᵢ is not derived from the MvdLXᵢ using the prior art.
   c. In one example only List 0 has MVD and List 1 has no MVD (0).
   d. In one example only List 1 has MVD and List 0 has no MVD(0).
   e. In one example only the reference picture with closest distance to current picture may have MMVD, and the other one has no MVD (0).
   f. In one example only the reference picture with further distance to current picture may have MMVD, and the other one has no MVD (0).
   g. In one example, only the reference direction (List 0 or List 1) whose MV has larger cost may have MVD.
      i. In one example, only the reference direction (List 0 or List 1) whose MV has the smaller cost may have MVD.
      ii. In one example, the cost may be the template matching cost corresponding to the MV of one reference list (List 0 or List 1).
      iii. In one example, the cost may be the bilateral matching cost corresponding to the MV of one reference list (List 0 or List 1).
   h. In one example only the reference ahead of the current picture may have MVD.
   i. In one example only the reference after the current picture may have MVD.
   j. In one example depending on the reference block's MV size or angle, only one may have MVD.
   k. In one example bi-prediction candidates may be converted to a uni candidate and MVD may apply on it.
   l. In one example, among both List 0 and List 1 have MVD, only List 0 has MVD, only List 1 has MVD, which one is finally used may be determined by RD decision and signaled to the decoder.
15. It is proposed to the final MVDs of list 0 and list 1 may be (MvdLXᵢ, MvdLYᵢ) pairs wherein i is unequal to j.
   m. In one example, for all (MvdLXᵢ, MvdLYᵢ) pairs with i being equal or unequal to j, the template costs may be calculated. and the pair which gives the smallest template cost may be selected as the final MVDs for list 0 and list 1.
      i. Alternatively, furthermore, early termination may be applied to reduce number of pairs to be checked.
16. It is proposed to determine the final MVD of list 0 and list 1 separately.
   n. In one example, instead of calculating the template cost based on the (MvdLXⱼ, MvdLYⱼ) pair, the template cost may be calculated for each candidate in list 0 and list 1 independently.
      i. Alternatively, furthermore, the MvdLXⱼ with the smallest template cost may be used as the final MVD for list X.
17. It is proposed to add zero MVD to the MVD candidate list in MMVD design.

### On Template Reference Samples

18. It is proposed that a first interpolation filter used to generate the template reference samples for MMVD reordering and/or MVD sign prediction may be different from a second interpolation filter used to generate the reference samples for inter-prediction.
   o. For example, the first interpolation filter may have less taps that the second interpolation filter.
   p. For example, the first interpolation filter may be a bi-linear filter or a 4-tap filter.
   q. In one example 12-tap interpolation filter may be used.
19. It is proposed that a first interpolation filter used to generate the template reference samples for MMVD reordering and/or MVD sign prediction may be different from a second interpolation filter used to generate the r template reference samples for another coding tool, e.g., TM-based merge candidate list.
20. It is proposed a modified MV (e.g., an estimation for MV magnitude) may be used for MVD sign prediction or MMVD reordering.
   r. In one example nearest integer estimation may be used for prediction/reordering.
   s. In one example nearest half pxl estimation may be used for prediction/reordering.
   t. In one example nearest 4-pxl estimation may be used for prediction/reordering.

### On Extension of Number of the Base Candidates Used in MMVD

21. It is proposed that at least one extra base candidate could be added to the original base candidates for MMVD and/or its extensions (e.g., affine MMVD).
   a. Alternatively, at least one existing base candidate could be removed from the original base candidates for MMVD and/or its extensions (e.g., affine MMVD).
   b. In one example depending on the block size, additional base candidates may be added.
   c. In one example depending on the picture resolution, additional base candidates may be added.
   d. In one example depending on the similarity/difference between the original base candidates, additional ones may be added.
   e. Alternatively, depending on the block size and/or the temporal level and/or the picture resolution and/or the similarity/difference between the original base candidates, at least one existing base candidate may be removed from the original base candidates.
   f. The base candidate index may be coded with truncated unary code, or truncated binary code, or Rice code of parameter R or Exponential Golomb code of order k, with any combination of bypass and context coded bin.
      i. Alternatively, it may be combined with the offset index and be coded jointly.

### On Early Termination of Cost Calculation

22. It is proposed that there may be an early termination on cost calculation for a first candidate or candidate position.
   a. In one example, if the cost of the left template samples is higher than the maximum allowable cost, the cost calculation for the above template samples may be skipped.
   b. In one example, if the cost of the above template samples is higher than the maximum allowable cost, the cost calculation for the left template samples may be skipped.
   c. In one example, depending on the width and height of the block, the longer template side cost may be calculated first, and if the cost is higher than the maximum allowable cost, the cost calculation for the shorter template side may be skipped.
   d. In one example, the maximum allowable cost mentioned above may be a fixed number.
   e. In another example, the maximum allowable cost mentioned above may be variable and may be a function of the block size, width, height, a fixed threshold, last cost, best cost, etc.
   f. In one example, if selecting N candidates (such as with the lowest costs) from M candidates, the maximum allowable cost mentioned above may be the Nth lowest cost.
   g. In another example the maximum allowable cost mentioned above may be the cost of a second candidate or candidate position.
      i. In one example, the second candidate or candidate position may be with the k-th lowest cost when calculating the cost of the first candidate or candidate position.

### On Affine MMVD

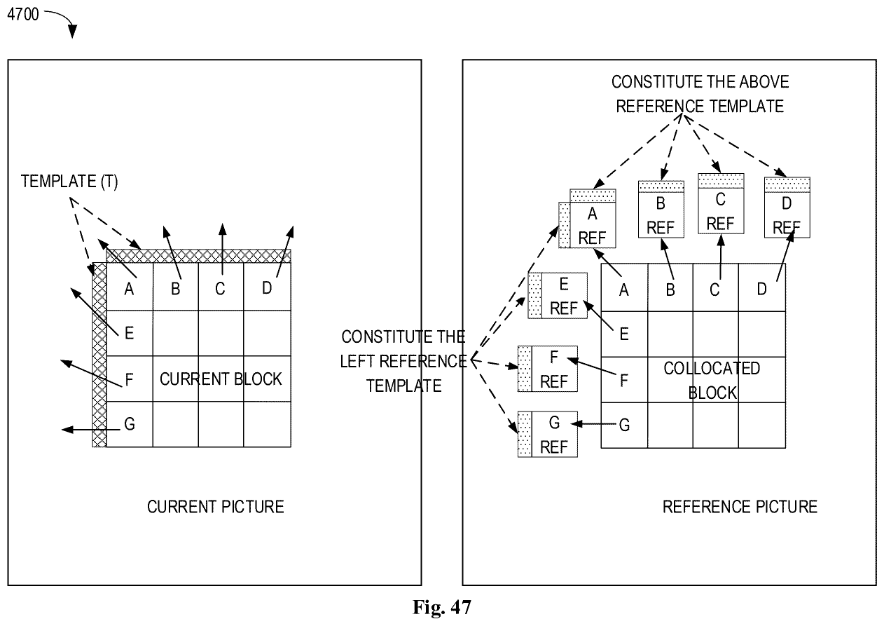

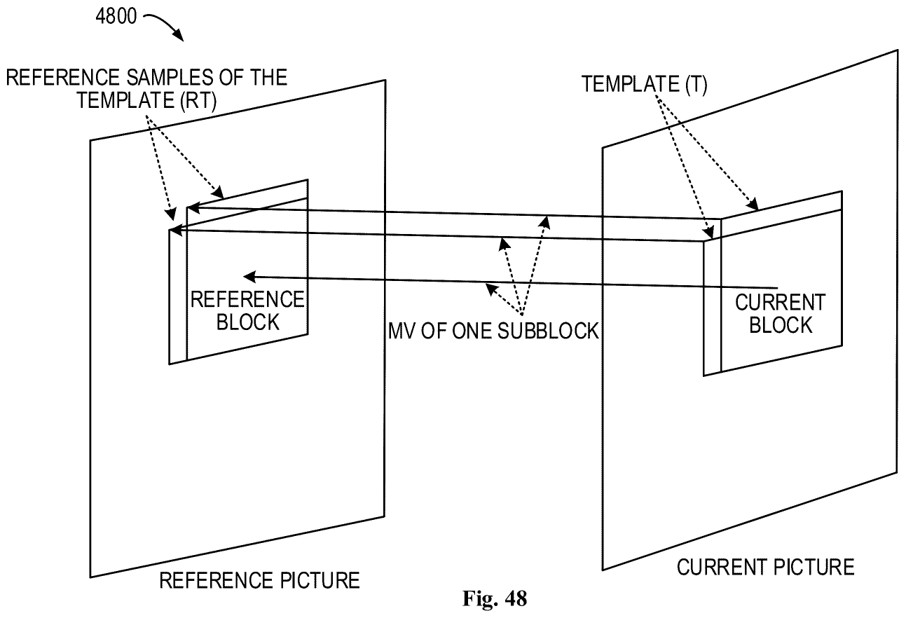

23. It is proposed that there may be some simplification on affine MMVD reference template derivation. For subblock-based merge candidates with subblock size equal to Wsub*Hsub, the above template comprises several sub-templates with the size of Wsub×L, and the left template comprises several sub-templates with the size of L×Hsub. As shown in FIG. 47. the motion information of the subblocks in the first row and the first column of current block is used to derive the reference samples of each sub-template.
   a. In one example the prediction may be calculated for each 4×4 subblocks.
   b. In one example the prediction may be calculated for each 8×8 subblocks.
   c. In one example the prediction may be calculated for each min(4, width)×min(4, height) subblocks.
   d. In one example the prediction may be calculated for each (width/2)×(height/2) subblocks.
   e. In one example the prediction may be calculated for each (width)×(height) subblocks (as shown in FIG. 48).
   f. In one example there may be no LIC application for affine MMVD.
   g. In one example there may be no LIC application when calculating the cost for affine MMVD.
24. It is proposed that whether to check the affine MMVD options or not at encoder side may depends on the affine merge cost.
   a. In one example if the best affine merge cost is on the top N merge or non merge costs, the affine MMVD options may be checked in encoder. Otherwise, they may be skipped. N could be any number such as 1, 3, 5, 10, 20, . . .
   b. In one example if the best affine cost is not on top N costs, the affine MMVD options may be checked in encoder. Otherwise, they may be skipped. N could be any number such as 1, 3, 5, 10, 20, . . . .
   c. In another example if the best affine cost is smaller than the alpha*cost_t, the affine MMVD options may be checked in encoder. Otherwise, they may be skipped. Alpha could be any positive real number such as 0.7, 1, 1.25, 1.73, . . . and cost may be the best non affine cost, or the N′th best cost, where N may be any integer number such as 5, 10.
   d. In another example if the best affine cost is bigger than the alpha*cost_t, the affine MMVD options may be checked in encoder. Otherwise, they may be skipped. Alpha could be any positive real number such as 0.7, 1, 1.25, 1.73, . . . and cost may be the best non affine cost, or the N′th best cost, where N may be any integer number such as 5, 10.

### On Step Size of MMVD and Additional Directions

25. It is proposed the initial step size may depend on the video resolution.
   a. In one example, the initial step size of the videos with width*height>C may be N times of the initial step size of the videos with width*height<=C, where C could be any integer number such as 10\hat{ }5, or any other numbers, and N may be any numbers such as 2, 4, . . .
   b. In one example there may be several thresholds for deciding the initial step size of MMVD. For example, for videos with width*height>C1 the initial step size would be L1. Otherwise for videos with width*height>C2 the initial step size would be L2. Otherwise for videos with width*height>C3 the initial step size would be L3, and so on, where C1>C2> . . . and L1>L2> . . . may be any integers.
   c. In one example, the initial step size may be signaled by or derived from at least one syntax element, such as in SPS/PPS/picture header/slice header/tile/CTU/etc.
26. It is proposed the initial step size may depend on the delta POC.
   a. In one example initial step size for blocks with delta POC>C may be N times the initial step size for blocks with delta POC<=C.
      i. In one example C may be 2 or 4 or any other integer number.
      ii. In one example N may be 2, 3 or any other integer number.
   b. Delta POC may be calculated as the absolute difference between POC of the current picture and the reference picture.
27. It is proposed the number of directions may depend on the step size.
   a. In one example the smallest step size, may have N1 directions and the remaining step sizes may have N2 directions, where N1 and N2 may be any integers. One example would be N1=8 and N2=16.
   b. In one example for the first 2 smallest step size, may have N1 directions and the remaining step sizes may have N2 directions, where N1 and N2 may be any integers. One example would be N1=8 and N2=16.
   c. In one example for the first M (e.g., M≥1) smallest step size, may have N1 directions and the remaining step sizes may have N2 directions, where N1 and N2 may be any integers. One example would be N1=8 and N2=16.

### On MMVD Flag Coding

28. It is proposed MMVD flag or affine MMVD flag may be coded with at least one context (the context index may be denoted as “ctx”).
   a. In one example, ctx may depend on information (such as coding mode/block dimensions etc.) parsed before paring the current MMVD flag or affine MMVD flag.
   b. In one example the ctx may depend on the MMVD flag of at least one neighboring block.
      i. In one example if at least one of the above or left block of current block uses MMVD, the ctx would be 1, otherwise the ctx would be 0.
      ii. In one example if both above and left block of current block uses MMVD, the ctx would be 2. If at only one of the above or left block of current block uses MMVD, the ctx would be 1, otherwise the ctx would be 0.
   c. In one example the ctx may depend on the skip flag of the current block.
      i. In one example if the current block is skip the ctx would be 0 or 1, otherwise the ctx would be 1 or 0.
   d. In one example the ctx may depend on the prediction direction of the current block.
      i. In one example if the current block is uni-prediction, the ctx would be 0, otherwise if it is bi-prediction the ctx would be 1.
   e. In one example any combination of the above scenarios may be applied, and several possible ctx may be available.
   f. Alternatively, MMVD flag or affine MMVD flag may be bypass coded.

### General Aspects

29. Whether to and/or how to apply the methods described above may be dependent on coded information.
   g. In one example, the coded information may include block sizes and/or temporal layers, and/or slice/picture types, colour component, et al.
30. Whether to and/or how to apply the methods described above may be indicated in the bitstream.
   h. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   i. The indication of enabling/disabling or which method to be applied may be signaled at PB/TB/CB/PU/TU/CU/VPDU/CTU/CTU row/slice/tile/sub-picture/other kinds of region contain more than one sample or pixel.

### 2.29. IBC Mode Extension

The detailed solutions below should be considered as examples to explain general concepts. These solutions should not be interpreted in a narrow way. Furthermore, these solutions can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

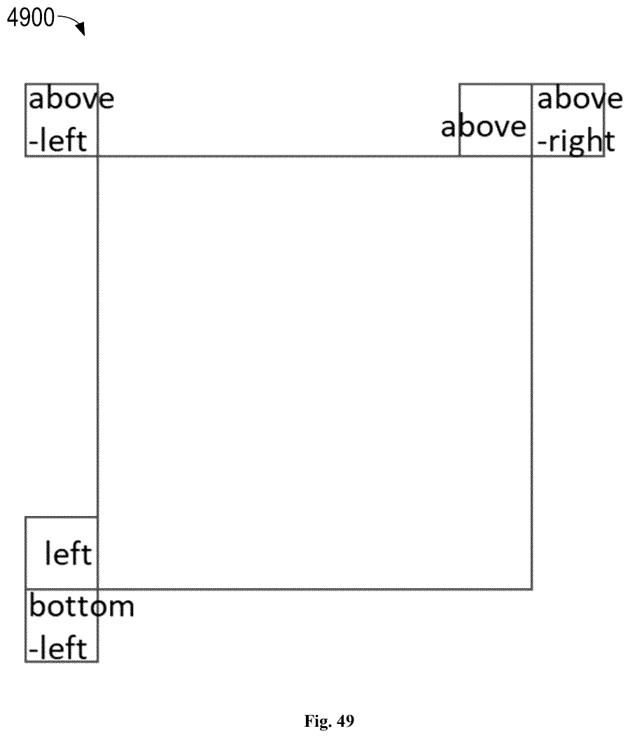

In the following, Mv1 and Mv2 are the motion vectors from the first part and the second part of the triangle or geometric partition.
1. In one example, the IBC merge mode with block vector differences (MBVD) may be used.
   a. In MBVD, a BV may be derived based on an IBC merge candidate which may be further refined by the signaled BVDs information.
   b. In one example, the BVDs information may include one or multiple IBC merge candidate indices, one or multiple indications (such as indices) to specify motion magnitude(s), and one or multiple indications (such as indices) for indication of motion direction(s).
      i. In MBVD mode, at least one from the candidates in the IBC merge list is selected to be used as BV basis. At least one MBVD candidate index is signaled to specify which candidate(s) is (are) used among the IBC merge candidates.
         (i) In one example, a MBVD candidate index is signaled to specify which one is used among the first N IBC merge candidates.
         a) In one example, N is set to 2.
         b) In one example, the candidate index may be binarized as a truncated code, with the maximum value equal to N−1.
         (ii) In one example, the IBC merge candidates may be reordered before being used.
      ii. In one example, a distance index specifies motion magnitude information and indicates the pre-defined offset from the starting point.
         (i) An offset may be added to either horizontal component or vertical component of starting MV.
         (ii) An offset may be added to both horizontal component and vertical component of starting MV.
         (iii) In one example, the distance set may be {1-pel, 2-pel, 4-pel, 8-pel, 16-pel, 32-pel}.
         (iv) In one example, the distance set may be {1-pel, 2-pel, 4-pel, 8-pel, 16-pel, 32-pel, 64-pel, 128-pel}.
         (v) In one example, the distance set may be {1-pel, 2-pel, 3-pel, 4-pel, 6-pel, 8-pel, 16-pel}.
         (vi) In one example, the distance set may be {1-pel, 2-pel, 3-pel, 4-pel, 6-pel, 8-pel, 16-pel, 32-pel, 64-pel}.
         (vii) In one example, the relation of distance index and pre-defined offset is specified in Table 2-4.
         (viii) In one example, the relation of distance index and pre-defined offset is specified in Table 2-5.
         (ix) In one example, the relation of distance index and pre-defined offset is specified in Table 2-6.
         (x) In one example, the relation of distance index and pre-defined offset is specified in Table 2-7.
         (xi) In one example, the relation of distance index and pre-defined offset may be signaled from encoder to decoder at sequence/picture/slice/CTU/CU level.
         (xii) The index may be binarized with unary coding, truncated unary coding, exponential-Golomb code, truncated exponential-Golomb code, fixed length code or any other binarization method.
      iii. In one example, a direction index represents the direction of the BVD relative to the starting point. The direction index can represent of the M BVD directions.
         (i) In one example, M is set to 4.
         a) In one example, 4 horizontal/vertical directions may be used.
         b) In one example, 4 diagonal directions may be used.
         c) In one example, the relation of direction index and pre-defined direction is specified in Table 2-8. For direction index of 0, (offset, 0) is the BVD; for direction index of 1, (−offset, 0) is the BVD; for direction index of 2, (0, offset) is the BVD; for direction index of 3, (0, −offset) is the BVD.
         d) In one example, the relation of direction index and pre-defined direction is specified in Table 2-9. For direction index of 0, (offset, offset) is the BVD; for direction index of 1, (offset, −offset) is the BVD; for direction index of 2, (−offset, offset) is the BVD; for direction index of 3, (−offset, −offset) is the BVD.
         (ii) In one example, M is set to 8.
         a) In one example, 4 horizontal/vertical directions plus 4 diagonal directions may be used.
         b) In one example, the relation of direction index and pre-defined direction is specified in Table 2-10.
         (iii) The index may be binarized with unary coding, truncated unary coding, exponential-Golomb code, truncated exponential-Golomb code, fixed length code or any other binarization method.
      iv. In one example, the number of distances and/or directions for MBVD of a block may be decided by
         (i) The resolution of a picture.
         (ii) The configuration of the coding process.
         (iii) The BVDs of the neighboring blocks of the block.
         a) In one example, the above and left neighboring blocks (depicted in FIG. 49) may be used.
         b) In one example, the adjacent spatial neighboring blocks including left and/or above and/or above-right and/or bottom-left and/or above-left spatial neighboring blocks (an example is shown in FIG. 49) may be used.
         (iv) Alternatively, the number of distances and/or directions for MBVD may be signaled from encoder to decoder at sequence/picture/slice/CTU/CU level.
   c. In one example, the candidates/directions/magnitudes in MBVD which may produce a BV out of the valid range of BV may be excluded from the candidate/directions/magnitudes set to be selected or signaled.
      i. Alternatively, a BV generated in MBVD may be clipped to be in the valid range.
      ii. Alternatively, a BV generated in MBVD must be in the valid range in a conformance bitstream.

TABLE 2-4
The relation of distance index and pre-defined offset

| Distance IDX | 0 | 1 | 2 | 3 | 4 | 5 |
|---|---|---|---|---|---|---|
| Offset (in unit of | 1 | 2 | 4 | 8 | 16 | 32 |
| luma sample) | | | | | | |

TABLE 2-5
The relation of distance index and pre-defined offset

| Distance IDX | 0 | 1 | 2 | 3 | 4 | 5 | 6 | 7 |
|---|---|---|---|---|---|---|---|---|
| Offset (in unit of | 1 | 2 | 4 | 8 | 16 | 32 | 64 | 128 |
| luma sample) | | | | | | | | |

TABLE 2-6
The relation of distance index and pre-defined offset

| Distance IDX | 0 | 1 | 2 | 3 | 4 | 5 | 6 |
|---|---|---|---|---|---|---|---|
| Offset (in unit of | 1 | 2 | 3 | 4 | 6 | 8 | 16 |
| luma sample) | | | | | | | |

TABLE 2-7
The relation of distance index and pre-defined offset

| Distance IDX | 0 | 1 | 2 | 3 | 4 | 5 | 6 | 7 | 8 |
|---|---|---|---|---|---|---|---|---|---|
| Offset (in unit of | 1 | 2 | 3 | 4 | 6 | 8 | 16 | 32 | 64 |
| luma sample) | | | | | | | | | |

TABLE 2-8
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

TABLE 2-9
Sign of MV offset specified by direction index

| Direction IDX | 00 | 01 | 10 | 11 |
|---|---|---|---|---|
| x-axis | + | + | − | − |
| y-axis | + | − | + | − |

TABLE 2-10
Sign of MV offset specified by direction index

| Direction IDX | 000 | 001 | 010 | 011 | 100 | 101 | 110 | 111 |
|---|---|---|---|---|---|---|---|---|
| x-axis | + | − | N/A | N/A | + | + | − | − |
| y-axis | N/A | N/A | + | − | + | − | + | − |

2. In one example, a new CIIP prediction mode (called CIIP_N) combines at least one IBC prediction signal and at least one prediction signal, generated by a second prediction method.
   a. The second prediction method may be intra-prediction or inter-prediction.
   b. The second prediction signal and IBC prediction signal may be combined by weighted averaging.
      i. The CIIP_N prediction is formed as:

$${P}_{CIIP\_N} = ( ( {2}^{N} - w t ) * {P}_{IBC} + w t * {P}_{s e c} + offset ) ≫ N .$$

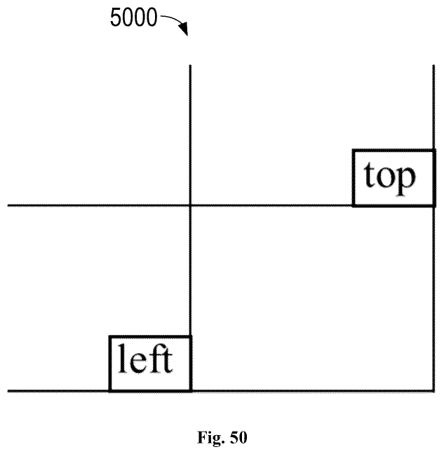

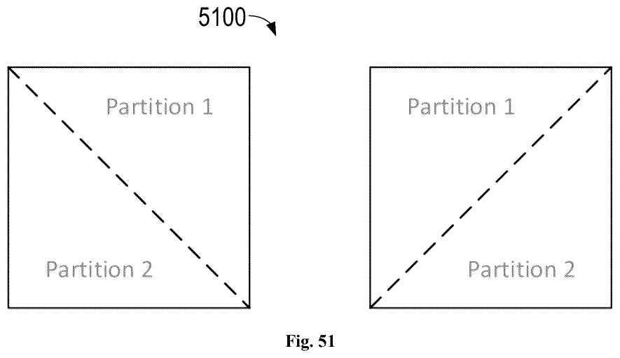

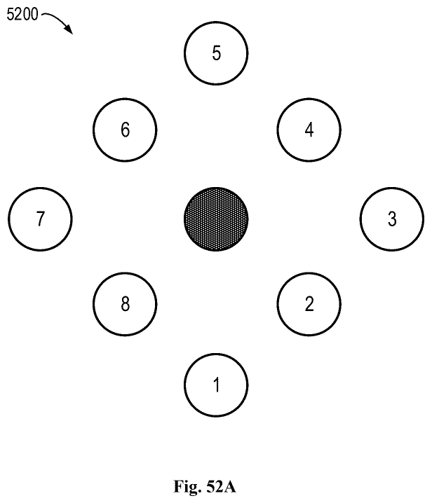

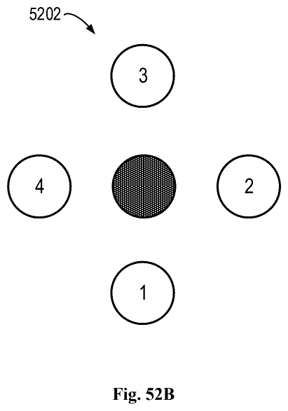

ii. In one example, offset is an integer such as 2^{N}>>1
iii. In one example, N=2.
iv. In one example, the weight value may be predefined.
   (i) In one example, wt is set to 2.
v. In one example, the weight value may be position-dependent for each sample.
   (i) For example, for some positions wt=2^{N}.
   (ii) For example, for some positions, wt=0.
vi. In one example, the weight value may be signaled from encoder to decoder.
c. The IBC prediction signal in the CIIP_N mode P_{IBC} may be derived using the same IBC prediction process applied to regular IBC merge mode.
d. The second prediction signal P_{sec} may be derived following the regular intra prediction process, and the combined mode is named as CIIP_N1.
   i. In one example, the intra prediction mode may be the planar mode.
   ii. In one example, the intra prediction mode may be the intra prediction mode which is implicitly derived by DIMD method.
   iii. In one example, the intra prediction mode may be the intra prediction mode which is implicitly derived by TIMD method.
   iv. In one example, the weight value may be calculated depending on the coding modes of the neighbouring blocks.
      (i) In one example, the weight value may be calculated depending on the coding modes of the top and left neighbouring blocks (depicted in FIG. 50) as follows:
      If the top neighbor is available and intra coded, then set isIntraTop to 1, otherwise set isIntraTop to 0;
      If the left neighbor is available and intra coded, then set isIntraLeft to 1, otherwise set isIntraLeft to 0;
      If (isIntraLeft+isIntraTop) is equal to 2, then wt is set to 3;
      Otherwise, if (isIntraLeft+isIntraTop) is equal to 1, then wt is set to 2;
      Otherwise, set wt to 1.
e. The second prediction signal P_{sec} may be derived using the same inter prediction process applied to regular merge mode, and the combined mode is named as CIIP_N2.
   i. In one example, the weight value may be calculated depending on the coding modes of the neighbouring blocks.
      (i) In one example, the weight value may be calculated depending on the coding modes of the top and left neighbouring blocks (depicted in FIG. 50) as follows:
      If the top neighbor is available and IBC coded, then set isIBCTop to 1, otherwise set isIBCTop to 0;
      If the left neighbor is available and IBC coded, then set isIBCLeft to 1, otherwise set isIBCLeft to 0;
      If (isIBCLeft+isIBCTop) is equal to 2, then wt is set to 1;
      Otherwise, if (isIBCLeft+isIBCTop) is equal to 1, then wt is set to 2;
      Otherwise, set wt to 3.
f. In CIIP_N mode, one from the candidates in the IBC merge list is selected to be used for IBC prediction. An IBC candidate index may be signaled to specify which one is used among the IBC merge candidates.
   i. In one example, an IBC candidate index is signaled to specify which one is used among the first N IBC merge candidates.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before being used.
   ii. In one example, an IBC candidate index is signaled to specify which one is used among the first N IBC merge candidates in the ascending order of SATD-cost values.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before calculating the SATD-cost.
g. In CIIP_N2 mode, one from the candidates in the regular merge list is selected to be used for inter prediction. A merge candidate index may be signaled to specify which one is used among the regular merge candidates.
   i. In one example, a merge candidate index is signaled to specify which one is used among the first N regular merge candidates.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before being used.
   ii. In one example, a merge candidate index is signaled to specify which one is used among the first N regular merge candidates in the ascending order of SATD-cost values.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before calculating the SATD-cost.
h. In one example, whether to and/or how to use the CIIP_N mode may be dependent on the coding information such as block dimensions/QP/neighboring block mode, etc.
   i. In one example, when a block is coded in IBC merge mode, if the block contains at least P luma samples (that is, block width times block height is equal to or larger than P), an additional flag is signaled to indicate if the CIIP_N mode is applied to the current block.
      (i) In one example, P is set to 64.
   ii. In one example, when a block is coded in IBC merge mode, if both block width and block height are less than Q luma samples, an additional flag is signaled to indicate if the CIIP_N mode is applied to the current block.
      (i) In one example, Q is set to 128.
      (ii) In one example, Q is set to 64.
   iii. In one example, the above two conditions may be used together.
i. In one example, whether to and/or how to use the CIIP_N2 mode may be dependent on the coding information such as block dimensions/QP/neighboring block mode, etc.
   i. In one example, when a block is coded in regular merge mode, if the block contains at least P luma samples (that is, block width times block height is equal to or larger than P), an additional flag is signaled to indicate if the CIIP_N2 mode is applied to the current block.
      (i) In one example, P is set to 64.
   ii. In one example, when a block is coded in regular merge mode, if both block width and block height are less than Q luma samples, an additional flag is signaled to indicate if the CIIP_N2 mode is applied to the current block.
      (i) In one example, Q is set to 128.
      (ii) In one example, Q is set to 64.
   iii. In one example, the above two conditions may be used together.
3. In one example, a triangle partition mode may be supported for IBC prediction (called TPM_IBC).
   a. When this mode is used, a block is split evenly into two triangle-shaped partitions, using either the diagonal split or the anti-diagonal split (FIG. 51).
   b. Each triangle partition in the block is IBC-predicted using its own motion.
   c. The uni-prediction motion for each partition is derived from a uni-prediction IBC candidate list.
      i. In one example, the uni-prediction IBC candidate list is derived directly from partial or full of an IBC merge candidate list.
      ii. In one example, the uni-prediction IBC candidate list may be reordered before being used.
   d. After predicting each of the triangle partitions, the sample values along the diagonal or anti-diagonal edge may be adjusted using a blending processing with adaptive weights.
      i. In one example, the weights may be adaptively decided by the distances between a sample and the splitting line.
         (i) An example is shown in section 2.23.2.
      ii. Alternatively, the sample values along the diagonal or anti-diagonal edge may not be adjusted using a blending processing. Instead, a sample along the diagonal or anti-diagonal edge can only be predicted by one of the two predictions.
   e. For motion field storage of TPM_IBC, if sType is equal to 0 or 1, Mv1 or Mv2 are stored in the corresponding motion field, otherwise if sType is equal to 2, Mv2 is stored.
      i. In one example, the sType calculation is the same as that for inter TPM.
   f. For signaling of TPM_IBC, the following applies:
      i. The TPM_IBC mode is signaled using a CU-level flag as one kind of IBC merge mode.
      ii. If TPM_IBC mode is used for the current CU, then a flag indicating the direction of the triangle partition (diagonal or anti-diagonal), and two merge indices (one for each partition) are further signaled.
      iii. If TPM_IBC mode is used for the current CU, then a triangle partition index indicating the partition mode of the triangle partition, and two merge indices (one for each partition) are further signalled.
4. In one example, a geometric partitioning mode may be supported for IBC prediction (called GPM_IBC).
   a. When this mode is used, a block is split into two parts by a geometrically located straight line (e.g. FIG. 34). The location of the splitting line is mathematically derived from the angle and offset parameters of a specific partition.
   b. Each part of a geometric partition in the block is IBC-predicted using its own motion.
   c. The uni-prediction motion for each partition is derived from a uni-prediction IBC candidate list.
      i. In one example, the uni-prediction IBC candidate list is derived directly from partial or full of an IBC merge candidate list.
      ii. In one example, the uni-prediction IBC candidate list may be reordered before being used.
   d. After predicting each of part of the geometric partition, the sample values along the geometric partition edge may be adjusted using a blending processing with adaptive weights.
      i. In one example, the weights may be adaptively decided by the distances between a sample and the splitting line.
         (i) An example is shown in section 2.24.2.
      ii. Alternatively, the sample values along geometric partition edge may not be adjusted using a blending processing. Instead, a sample along the geometric partition edge can only be predicted by one of the two predictions.
   e. For motion field storage of GPM_IBC, if sType is equal to 0 or 1, Mv1 or Mv2 are stored in the corresponding motion field, otherwise if sType is equal to 2, Mv2 is stored.
      i. In one example, the sType calculation is the same as that for inter GPM.
   f. For signaling of GPM_IBC, the following applies:
      i. The GPM_IBC mode is signaled using a CU-level flag as one kind of IBC merge mode.
      ii. If GPM_IBC mode is used for the current CU, then a geometric partition index indicating the partition mode of the geometric partition (angle and offset), and two merge indices (one for each partition) are further signalled.
5. In one example, TM_AMVP for IBC (called TM_AMVP_IBC) is supported.
   a. In TM_AMVP_IBC mode, K IBC MVP candidates are determined based on template matching to pick up the one which reaches the first K minimum difference between current block template and reference block template from the IBC AMVP list.
      i. A selected set of start-point candidates consists of the K IBC MVP candidates.
   b. TM may perform only for the selected set of start-point candidates for MV refinement.
      i. TM refines a start-point candidate, starting from full-pel MVD precision (or 4-pel for 4-pel AMVR mode) within a search range.
         (i) In one example, refine it within a [−8, +8]-pel search range by using iterative diamond search. M search rounds will be used until the center searching point has the minimum matching cost for diamond search pattern as shown in FIG. 52A.
         a) In one example, M is MAX_UINT.
         b) In one example, M is 375.
      ii. The selected start-point candidate may be further refined by using cross search with full-pel MVD precision (or 4-pel for 4-pel AMVR mode).
         (i) In one example, one search round is used for cross search pattern as shown in FIG. 52B.
   c. In one example, TM_AMVP_IBC may generate K refined IBC AMVP candidates, and one of them may be selected and the selection may be signaled from encoder to decoder.
      i. In one example, K=1, and no selection information is signaled.
      ii. In one example, if at least one refined IBC AMVP candidates by template matching are available, they are used as the TM_AMVP_IBC candidates. Otherwise, the first K existing IBC AMVP candidates without refinement are used.
      iii. In one example, the selected refined IBC AMVP candidate is used as the starting point for block matching based local search of IBC mode.
   d. Alternatively, the derived BV by TM_IBC is used as the starting point for block matching based local search of IBC mode.
   e. For example, when IBC AMVR is enabled, the refined IBC AMVP candidate in one MVD precision may be reused in another MVD precisions.
      i. In one example, the refined IBC AMVP candidate in full-pel MVD precision may be reused in 4-pel MVD precisions.
6. In one example, TM_merge for IBC (called TM_merge_IBC) is supported.
   a. In TM_merge_IBC mode, K IBC merge candidates are determined based on template matching to pick up the one which reaches the first K minimum difference between current block template and reference block template from the IBC merge list.
      i. A selected set of start-point candidates consists of the K IBC merge candidates.
   b. TM may perform only for the selected set of start-point candidates for MV refinement.
      i. TM refines a start-point candidate, starting from full-pel MVD precision (or 4-pel for 4-pel AMVR mode) within a search range.
         (i) In one example, refine it within a [−8, +8]-pel search range by using iterative diamond search. M search rounds will be used until the center searching point has the minimum matching cost for diamond search pattern as shown in FIG. 52A.
         a) In one example, M is MAX_UINT.
         b) In one example, M is 375.
      ii. The selected start-point candidate may be further refined by using cross search with full-pel MVD precision (or 4-pel for 4-pel AMVR mode).
         (i) In one example, one search round is used for cross search pattern as shown in FIG. 52B.
   c. In one example, TM_merge_IBC may generate K refined IBC merge candidates, and one of them may be selected and the selection may be signaled from encoder to decoder.
      i. In one example, K=1, and no selection information is signaled.
      ii. In one example, if at least one refined IBC merge candidates by template matching are available, they are used as the TM_merge_IBC candidates. Otherwise, TM_merge_IBC mode is invalid.
      iii. In one example, the best TM refined IBC merge candidate is selected by a criterion.
         (i) In one example, the criterion is RD decision.
   d. Alternatively, TM performs for each IBC merge candidate for MV refinement. And then the best TM refined IBC merge candidate is selected by a criterion.
      i. In one example, the criterion is RD decision.
         2.30. IBC with Template Matching

It is proposed to also use Template Matching with IBC for both IBC merge mode and IBC AMVP mode.

In this proposal, the IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

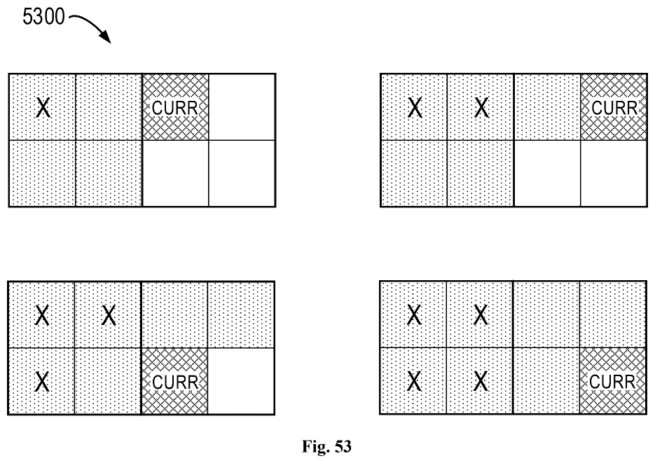

The Template Matching refinement for both IBC-TM merge and AMVP modes is quite simple since IBC motion vectors are constrained (i) to be integer and (ii) within a reference region as shown in FIG. 53. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

### 2.31. BVP Candidate Adjustment Based on IBC Reference Region

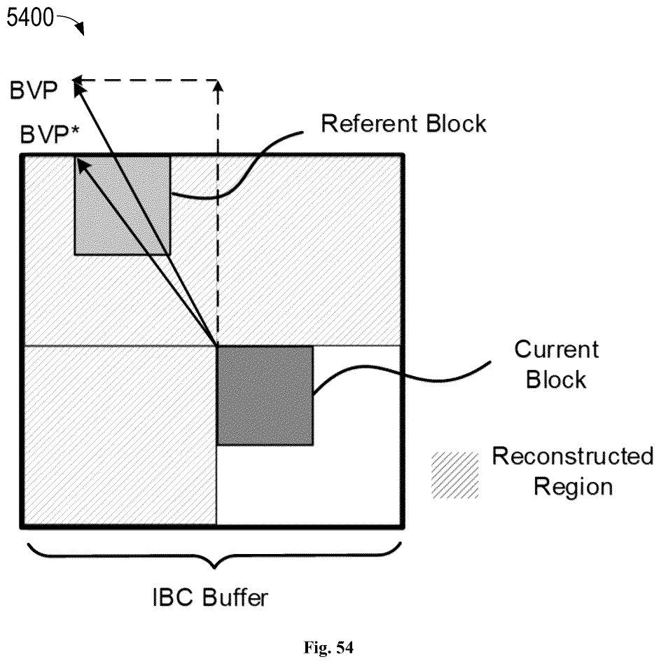

It is proposed to clip the BVP candidates that are pointing outside of the IBC reference region before they are validated for inclusion in the IBC Merge/AMVP list. The method proposes the clipping of one or both components of an invalid candidate to the nearest IBC buffer boundaries, as is shown in FIG. 54, where BVP* represent the clipped BVP candidate:

This proposal also includes a second method to replace the zero vectors' candidates used to pad the IBC Merge/AMVP list, with a set of BVP candidates located in the IBC reference region. A zero vector is invalid as a block vector in IBC merge mode, and consequently, it is discarded as BVP.

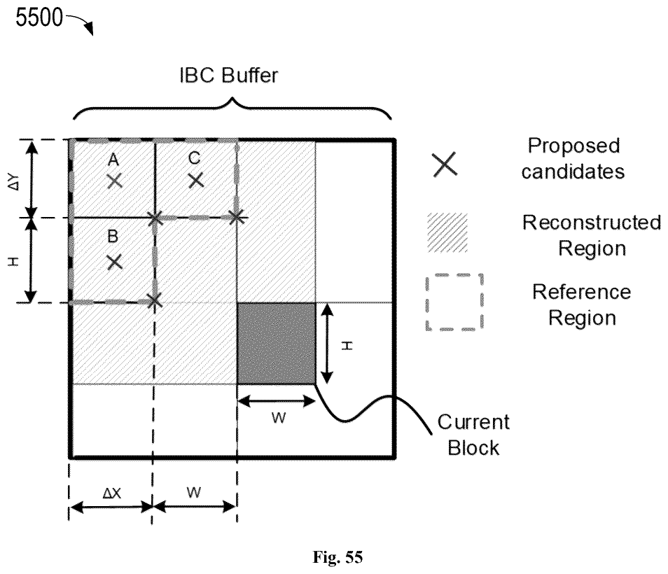

With the aim to cover the reference region in a uniform way, three of the candidates are located on the nearest corners of the reference region. The other three candidates are located in the middle of the three sub-regions (A, B, and C) whose coordinates are determined by width, and height of the current block and the ΔX and ΔY parameters, as is depicted in FIG. 55.

### 2.32. Encoding Algorithms for IBC Merge Mode

Rate distortion optimization (RDO) is an important method in video coding. It is based on the Lagrange optimization technique. With the proper choice of parameters, optimal trade-off between rate and distortion can be achieved. In HEVC, VVC and ECM, a full RDO method based on CABAC bit rate estimation and SSD distortion cost is used. However, the cost is very high in real-time video encoder hardware.

To save computation overhead, two-pass operations are performed. In the first pass, fast RDO is done. In the second pass, full RDO is performed. In fast RDO, the bits are roughly estimated (e.g., equal to IBC/IBC_TM merge index plus 1 or IBC/IBC_TM merge index), and the distortion is calculated by the sum of absolute difference (SAD) or the sum of absolute transformed difference (SATD). Although fast RDO is not accurate, it is still able to prune the less probable cases. Fast RDO selects up to a predefined number (e.g., numIBCMrgSATDCand) of modes from IBC merge modes and/or IBC_TM merge modes and/or IBC_MBVD merge modes. Then, the full RDO costs are estimated and compared for these modes. In full RDO process, all the residues are transformed, quantized, inverse quantized, and inverse transformed to produce the reconstructed differences. Distortion is then calculated by the sum of squared difference (SSD). The prediction information and residue coefficients will go through CABAC bit estimator to obtain bit rate if estimated mode is selected. After that, final decision between the modes is made by Lagrangian cost with SSD distortion and estimated CABAC bit rate to optimize the trade-off.

### 3. Problems

The current design of IBC mode can be further improved.

More IBC based modes can be supported to improve the coding efficiency of IBC mode.

### 4. Detailed Solutions

The detailed solutions below should be considered as examples to explain general concepts. These solutions should not be interpreted in a narrow way. Furthermore, these solutions can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

W and H are the width and height of current block (e.g., luma block).

For an IBC coded block, a block vector (BV) is used to indicate the displacement from the current block to a reference block, which is already reconstructed inside the current picture.

In the following, a BV predictor also is a BV candidate. The skip mode also is the merge mode.

A BV candidate may be determined to be valid when it meets one of or a combination of at least one of the following conditions.
1) The corresponding reference block is already reconstructed inside the current picture.
2) The corresponding reference block is located in the same CTU row as current block.
3) The corresponding reference block is located in the same tile/subpicture as current block.
4) The corresponding reference block is located in the same slice as current block.
5) The BV candidate satisfies the block vector constraints (e.g., which is described in 2.4.2 and 2.4.3).
6) The BV candidate satisfies the IBC virtual buffer conditions (e.g., which is described in 2.4.4).

A BV candidate may be determined to be invalid when it violates one of or a combination of at least one of the above conditions.

The non-adjacent spatial candidates of current coding block are adjacent spatial candidates of a virtual block in the ith search round (as shown in FIG. 9). The width and height of the virtual block for the ith search round are calculated by: newWidth=i×2×gridX+W, newHeight=i×2×gridY+H. Obviously, the virtual block is the current block if the search round i is 0.

If CU at a temporal position is not available or is intra coded or is outside of the current row of CTUs or its BV (if has) is invalid for current block, the temporal position is treated as invalid; otherwise, the temporal position is treated as valid.

The motion candidates can be divided into several groups according to some criterions. Each group is called a subgroup. For example, take adjacent spatial and temporal motion candidates as a first subgroup and take the remaining motion candidates as a second subgroup; In another example, take the first N (N≥2) motion candidates as a first subgroup, take the following M (M≥2) motion candidates as a second subgroup, and take the remaining motion candidates as a third subgroup. For example, the motion candidates can be divided into several groups according to the motion candidate type.

Note that the proposed methods may be applied to merge candidate list construction process for inter coded blocks (e.g., translational motion), affine coded blocks, TM coded blocks, GPM coded blocks, ADMVR coded block or IBC coded blocks; or other motion candidate list construction process (e.g., normal AMVP list; affine AMVP list; TM AMVP list; IBC AMVP list; HMVP table).

Note that the proposed methods may be applied to regular merge/AMVP candidate list after the DMVR/multi-pass DMVR process.

Note that the proposed methods may be applied to ADMVR merge candidate list after the DMVR/multi-pass DMVR process.

Note that the proposed methods may be applied to TM merge/AMVP candidate list after block-based bilateral matching refinement and/or template matching refinement and/or subblock-based bilateral matching refinement.

In the following, one motion candidate may be determined as a duplicate of another motion candidate in case:
1) The two motion candidates are totally the same in the reference directions, reference picture indices, affine model (for affine motion) and motion vectors or block vectors or partial or all CPMVs according to the motion type (inter or IBC or affine).
Or
2) The two motion candidates are totally the same in the reference directions, reference picture indices, affine model (for affine motion). But the difference of motion vectors or block vectors or partial or all CPMVs according to the motion type (inter or IBC or affine) of the two motion candidates may be within a threshold or a range (they will be both referred as “threshold” in the document).

The difference of motion vectors may be defined as the value or the absolute value of horizontal and/or vertical component of the motion vector difference of the two motion candidates in reference list 0 and/or reference list 1.

The difference of block vectors may be defined as the value or the absolute value of horizontal and/or vertical component of the block vector difference of the two motion candidates in reference list 0.

The difference of one CPMV may be defined as the value or the absolute value of horizontal and/or vertical component of the motion vector difference of this CPMV of the two motion candidates in reference list 0 and/or reference list 1.

The threshold may be adaptively set according to the coding mode of current block (e.g., TM merge, affine merge, regular merge, IBC merge, ADMVR merge, etc.), and/or current block size, and/or candidate type (e.g., adjacent spatial, adjacent temporal, non-adjacent spatial, non-adjacent temporal, HMVP, pairwise, or STMVP, etc.), and/or fractional bits of motion vector, and/or QP, and/or the reference index or the reference POC of current block, and/or other coding information of current block.

In this disclosure, a motion candidate may refer to a MV candidate or a BV candidate.

In this disclosure, a motion candidate list may refer to a MV candidate list or a BV candidate list.

Specifically,
i. In one example, a motion candidate list may be the TM merge/AMVP list after block-based bilateral matching refinement and/or template matching refinement and/or subblock-based bilateral matching refinement.
ii. In one example, a motion candidate list may be the regular merge/AMVP list after the DMVR/multi-pass DMVR process.
iii. In one example, a motion candidate list may be the ADMVR merge list after the DMVR/multi-pass DMVR process.
iv. In one example, a motion candidate list may be the GPM merge list after the template matching refinement process (e.g., AGPMList, LGPMList, or LAGPMList).
v. In one example, a motion candidate list may be the regular merge/AMVP list.
vi. In one example, a motion candidate list may be the TM merge/AMVP list.
vii. In one example, a motion candidate list may be the affine merge/AMVP list.
viii. In one example, a motion candidate list may be the IBC merge/AMVP list.
ix. In one example, a motion candidate list may be the ADMVR merge list.
x. In one example, a motion candidate list may be the GPM merge list.
xi. In one example, a motion candidate list may be the TPM merge list.
xii. In one example, a motion candidate list may be the MMVD merge list.
xiii. In one example, a motion candidate list may be the IBC template matching candidate list.
xiv. In one example, a motion candidate list may be the intra template matching candidate list.
xv. In one example, a motion candidate list may be the IBC MMVD candidate list.
xvi. In one example, a motion candidate list may be the IBC GPM candidate list.
xvii. In one example, a motion candidate list may be the IBC TPM candidate list.
xviii. In one example, a motion candidate list may be any other motion candidate list.

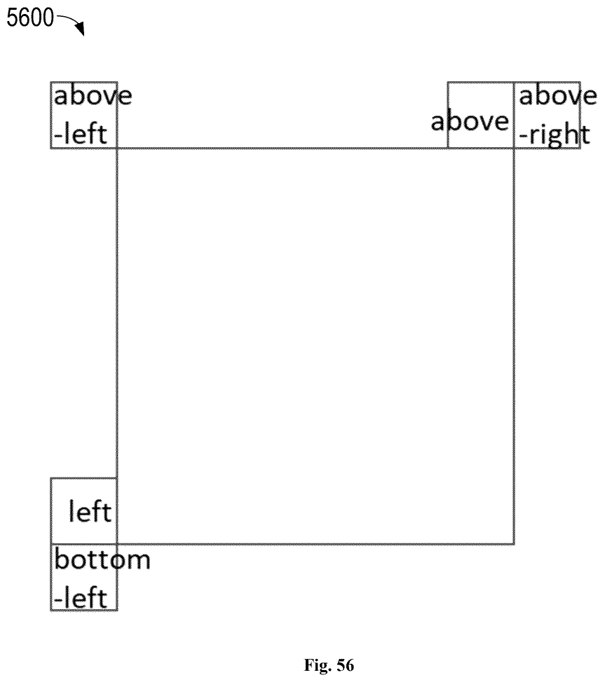

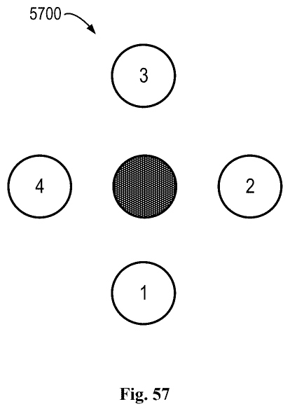

The following solutions are not limited to IBC merge mode.
1. In one example, the IBC merge mode with block vector differences (MBVD a.k.a. IBC MMVD or IBC MBVD) may be used.
   a. In MBVD, a BV may be derived based on one or multiple IBC base candidate(s) which may be further refined by the signaled BVDs information.
      i. In one example, which base candidate to be used may be indicated by one or multiple indications, such as indices.
   b. In MBVD, a BV may be derived based on one or multiple IBC merge candidate(s) which may be further refined by the signaled BVDs information.
      i. The one or multiple IBC merge candidate may be indicated by one or multiple indications (such as indices).
   c. In one example, the BVDs information may include one or multiple indications (such as indices) to specify displacement magnitude(s) and for indication of displacement direction(s).
2. In MBVD mode, at least one from the candidates in an IBC merge list is selected to be used as BV basis (i.e., base candidate).
   a. In one example, the IBC merge list may be the regular IBC merge list of IBC merge mode.
   b. In one example, the IBC merge list may be a new IBC merge list.
      i. The new IBC merge list may be constructed based on the regular IBC merge list.
      ii. The new IBC merge list may be constructed independent of the regular IBC merge list.
   c. In one example, the first N IBC merge candidates of the IBC merge list may be selected to construct an IBC base candidate list.
      i. At least one base candidate index is signaled to specify which base candidate(s) is (are) used among all the IBC base candidates.
      ii. In one example, N may be set to 2.
      iii. In one example, N may be set to 5.
      iv. In one example, the base candidate index may be binarized as a truncated unary code, with the maximum value equal to N−1.
      v. In one example, if N is 1, no base candidate index needs to be signaled.
   d. In one example, partial or all candidates in the IBC merge list may be firstly reordered according to one or some criteria (e.g., template matching cost or bilateral matching cost) before being selected.
   e. In one example, partial or all candidates in the IBC base candidate list may be firstly reordered according to one or some criteria (e.g., template matching cost or bilateral matching cost) before being used.
   f. In one example, only if an IBC candidate is valid, it may be inserted into the IBC merge list and/or IBC base candidate list and/or be treated as an IBC base candidate.
   g. In one example, if an IBC candidate is invalid (e.g., pointing outside of the IBC reference region), the clipping of one or both components of an invalid IBC candidate to the IBC reference region (e.g., nearest IBC reference region boundaries) may be performed, and the clipped IBC candidate may be inserted into the IBC merge list and/or IBC base candidate list and/or be treated as an IBC base candidate.
3. In one example, a distance index specifies displacement magnitude information and/or indicates the pre-defined offset from the starting point of a BV in MBVD.
   a. The starting point of a BV in MBVD may be determined by a base IBC candidate.
      i. The final BV in MBVD may be derived based on the starting point and the displacement magnitude information.
   b. The starting point of a BV in MBVD may be determined by a template (TM-intra, or TM-IBC) candidate.
   c. An offset may be added to either horizontal component or vertical component of starting BV.
   d. An offset may be added to both horizontal component and vertical component of starting BV.
   e. In one example, the distance set may be predefined.
      i. In one example, the distance set may be {1-pel, 2-pel, 4-pel, 8-pel, 16-pel, 32-pel}, the relation of distance index and pre-defined offset is specified in Table 4-1.
      ii. In one example, the distance set may be {1-pel, 2-pel, 4-pel, 8-pel, 16-pel, 32-pel, 64-pel, 128-pel}, the relation of distance index and pre-defined offset is specified in Table 4-2.
      iii. In one example, the distance set may be {1-pel, 2-pel, 3-pel, 4-pel, 6-pel, 8-pel, 16-pel}, the relation of distance index and pre-defined offset is specified in Table 4-3.
      iv. In one example, the distance set may be {1-pel, 2-pel, 3-pel, 4-pel, 6-pel, 8-pel, 16-pel, 32-pel, 64-pel}, the relation of distance index and pre-defined offset is specified in Table 4-4.
      v. In one example, the distance set may be {1-pel, 2-pel, 4-pel, 8-pel, 16-pel, 32-pel, 48-pel, 64-pel, 80-pel, 96-pel, 112-pel, 128-pel}, the relation of distance index and pre-defined offset is specified in Table 4-5.
      vi. In one example, the distance set may be {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, the relation of distance index and pre-defined offset is specified in Table 4-6.
      vii. In one example, the distance set may be {1-pel, 2-pel, 3-pel, 4-pel, 6-pel, 8-pel, 10-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel, 120-pel, 128-pel}, the relation of distance index and pre-defined offset is specified in Table 4-7.
      viii. In one example, the distance set may be {1-pel, 2-pel, 4-pel, 8-pel, 12-pel, 16-pel, 20-pel, 24-pel, 28-pel, 32-pel, 36-pel, 40-pel, 44-pel, 48-pel, 52-pel, 56-pel, 60-pel, 64-pel, 68-pel, 72-pel, 76-pel, 80-pel, 84-pel, 88-pel, 92-pel, 96-pel, 100-pel, 104-pel, 108-pel, 112-pel, 116-pel, 120-pel, 124-pel, 128-pel}, the relation of distance index and pre-defined offset is specified in Table 4-8.
      ix. In one example, the distance set may be {1-pel, 2-pel, 4-pel, 8-pel, 16-pel, 24-pel, 40-pel, 56-pel, 72-pel, 88-pel, 104-pel, 120-pel}, the corresponding distance index may be in the order of {0, 1, 2, 3, 4, 5, 6, 7, 8, 9, 10, 11}.
      x. In one example, the distance set may be {1-pel, 2-pel, 4-pel, 8-pel, 12-pel, 16-pel, 24-pel, 32-pel, 40-pel, 56-pel, 72-pel, 88-pel, 104-pel, 120-pel}, the corresponding distance index may be in the order of {0, 1, 2, 3, 4, 5, 6, 7, 8, 9, 10, 11, 12, 13}.
      xi. In one example, the distance set may be {1-pel, 2-pel, 4-pel, 8-pel, 12-pel, 16-pel, 24-pel, 32-pel, 40-pel, 48-pel, 56-pel, 64-pel, 72-pel, 80-pel}, the corresponding distance index may be in the order of {0, 1, 2, 3, 4, 5, 6, 7, 8, 9, 10, 11, 12, 13}.
      xii. In one example, other distance candidates may be also supported.
   f. In one example, the relation of distance index and pre-defined offset may be signaled from encoder to decoder at sequence/picture/slice/CTU/CU level.
   g. The index may be binarized with unary coding, truncated unary coding, exponential-Golomb code, truncated exponential-Golomb code, fixed length code or any other binarization method.
4. In one example, a direction index represents the direction of the BVD of a BV in MBVD relative to the starting point. The direction index can represent the M BVD directions.
   a. The starting point of a BV in MBVD may be determined by a base IBC candidate.
      i. The final BV in MBVD may be derived based on the starting point and the BVD direction.
      ii. The final BV in MBVD may be derived based on the starting point, the distance and the BVD direction.
   b. The starting point of a BV in MBVD may be determined by a template (TM-intra, or TM-IBC) candidate.
   c. In one example, the number of BVD directions (e.g., M) may be set to 4.
      i. In one example, 4 horizontal/vertical directions may be used.
      ii. In one example, 4 diagonal directions may be used.
      iii. In one example, the relation of direction index and pre-defined direction is specified in Table 4-9. For direction index of 0, (offset, 0) is the BVD; for direction index of 1, (−offset, 0) is the BVD; for direction index of 2, (0, offset) is the BVD; for direction index of 3, (0, −offset) is the BVD.
      iv. In one example, the relation of direction index and pre-defined direction is specified in Table 4-10. For direction index of 0, (offset, offset) is the BVD; for direction index of 1, (offset, −offset) is the BVD; for direction index of 2, (−offset, offset) is the BVD; for direction index of 3, (−offset, −offset) is the BVD.
   d. In one example, the number of BVD directions (e.g., M) may be set to 8.
      i. In one example, 4 horizontal/vertical directions plus 4 diagonal directions may be used.
      ii. In one example, the relation of direction index and pre-defined direction is specified in Table 4-11.
   e. The index may be binarized with unary coding, truncated unary coding, exponential-Golomb code, truncated exponential-Golomb code, fixed length code or any other binarization method.
5. In one example, the final BV in MBVD may be derived as:
   a. In one example, final BV=staring point BV+offset BV, where staring point BV may be determined by a base IBC candidate and offset BV may be derived by the signaled displacement magnitude information and the BVD direction.
6. In one example, the signaled displacement magnitude information and the BVD direction for MBVD may be coded in a same way as displacement magnitude information and the MVD direction for MMVD.
7. In one example, only one index may be signaled to indicate both distance and direction for a MBVD candidate.
   a. The index may be binarized with unary coding, truncated unary coding, exponential-Golomb code, truncated exponential-Golomb code, fixed length code or any other binarization method.
   b. In one example, the index may be all coded using truncated unary code.
   c. In one example, the index may be all coded using truncated binary/binary code.
   d. In one example, the index may be all coded using Rice or exponential Golomb code of order k which k could be 0, 1, or any number.
      i. In one example, the rice code with parameter 1, 2, 4, 8 or any other number may be used.
   e. In one example, the prefix and suffix of the codes may be coded in any combination of bypass and context coded bin.
   f. In one example, the index could be coded in bypass mode.
   g. In one example, the index could be coded in context mode.
   h. In one example, at least one bin of the index (such as only the first bin) may be context coded
      i. In one example, the first N bins may be context coded. The context coded may share the same context or have independent context.
8. In one example, for each IBC base candidate, the corresponding MBVD candidates may be reordered together or in the form of subgroup according to one or some criteria (e.g., template matching cost or bilateral matching cost) before being used.
   a. Alternatively, for at least one IBC base candidate, the corresponding MBVD candidates may be not reordered.
   b. In one example, a predefined ratio or some of the reordered MBVD candidates may be selected to perform the following operations (e.g., SATD process and/or RD process).
   c. In one example, if reordering in the form of subgroup, a predefined ratio or some of the reordered MBVD candidates in each subgroup may be selected to perform the following operations (e.g., SATD process and/or RD process).
   d. In one example, the predefined ratio may be the first 1/N.
      i. In one example, the predefined ratio may be the first 1/N with the lowest template matching SAD costs.
      ii. In one example, the predefined ratio may be the first 1/N with the lowest bilateral matching SAD costs.
      iii. In one example, N may be 2.
      iv. In one example, N may be 4.
      v. In one example, N may be 8.
      vi. In one example, the predefined ratio may be corresponding to the ratio of the maximum number of MBVD candidates for an IBC base candidate.
   e. In one example, if the maximum number of MBVD candidates for each base candidate is M, and N MBVD candidates are selected to perform the following operations (e.g., SATD process and/or RD process), there will be a mapping process from an index of 0−N−1 to an index of 0−M−1.
      i. In one example, only one index of 0−N−1 may be signaled to indicate both distance and direction of a MBVD candidate.
      ii. In one example, N may be the number of the valid MBVD candidates for an IBC base candidate.
      iii. In one example, N may be different for different IBC base candidates.
         (i) In one example, all the IBC base candidates may be divided into B (e.g., B is a positive integer) sets. N may be different for different sets of IBC base candidates and N may be same for a set of IBC base candidates.
         (ii) In one example, N may be same for different sets of IBC base candidates.
      iv. In one example, N may be same for different IBC base candidates.
      v. In one example, N may be decided by the predefined ratio of the maximum number of MBVD candidates for an IBC base candidate.
      vi. In one example, N may be predefined.
         (i) In one example, N may be dependent on the configurations of the coding process (e.g., All Intra (AI), lowdelay_B (LB), lowdelay_P (LP), randomaccess (RA)).
         a) In one example, all the (e.g., four) configurations may be divided into Q (e.g., Q is a positive integer) sets. N may be different for different sets of configurations and N may be same for a set of configurations.
         b) In one example, N may be a first value for a first set of configurations (e.g., All Intra, N=8 or 14) and/or N may be a second value for a second set of configurations (e.g., RA, LB, LP, N=8 or 18).
         c) In one example, N may be a first value for a first set of configurations (e.g., All Intra, N=8 or 14) and/or N may be a second value for a second set of configurations (e.g., RA, N=8 or 18).
         d) Alternatively, N may be same for different sets of configurations (e.g., N=8 for AI, LB, LP, RA).
         (ii) In one example, N may be dependent on picture resolutions.
         a) In one example, all the picture resolutions may be divided into P (e.g., P is a positive integer) sets. N may be different for different sets of picture resolutions and N may be same for a set of picture resolutions.
         b) In one example, N may be a first value for a first set of picture resolutions and/or N may be a second value for a second set of picture resolutions.
         c) In one example, N may be same for different sets of picture resolutions.
         (iii) In one example, N may be dependent on slice types.
         a) In one example, all the slice types may be divided into T (e.g., T is a positive integer) sets. N may be different for different sets of slice types and N may be same for a set of slice types.
         b) In one example, N may be a first value for a first set of slice types (e.g., N=8 or 14 for I slice) and/or N may be a second value for a second set of slice types (e.g., N=8 or 18 for B slice, P slice).
         c) In one example, N may be same for different sets of slice types.
      vii. In one example, N may be signalled from encoder to decoder.
      viii. In one example, N may be adaptively derived according to some temporal and/or coding information.
         (i) In one example, N may be dependent on the number of the valid MBVD candidates for an IBC base candidate.
      ix. In one example, N may be dependent on the coding information of neighboring blocks.
         (i) In one example, N may be dependent on the coding modes of neighboring blocks.
         (ii) In one example, N may be dependent on the number of neighboring blocks with IBC merge mode (e.g., IBCMrgNum).
         a) In one example, all the IBCMrgNums may be divided into N1 (e.g., N1 is a positive integer) sets. N may be different for different sets of IBCMrgNums and N may be same for a set of IBCMrgNums.
         b) In one example, N may be a first value for a first set of IBCMrgNums and/or N may be a second value for a second set of IBCMrgNums.
         c) In one example, N may be same for different sets of IBCMrgNums.
         (iii) In one example, N may be dependent on the number of neighboring blocks with IBC merge/AMVP mode (e.g., IBCNum).
         a) In one example, all the IBCNums may be divided into N2 (e.g., N2 is a positive integer) sets. N may be different for different sets of IBCNums and N may be same for a set of IBCNums.
         b) In one example, N may be a first value for a first set of IBCNums and/or N may be a second value for a second set of IBCNums.
         c) In one example, N may be same for different sets of IBCNums.
         (iv) In one example, the neighboring blocks may include at least one of the five spatial neighbor blocks (shown in FIG. 1) and/or the temporal neighbor block(s) (shown in FIG. 4).
      x. In one example, N may be dependent on other coding parameters.
         (i) In one example, N may be dependent on block sizes.
         a) In one example, all the block sizes may be divided into S1 (e.g., S1 is a positive integer) sets. N may be different for different sets of block sizes and N may be same for a set of block sizes.
         b) In one example, N may be same for different sets of block sizes.
         c) In one example, N keeps same or becomes larger with block size getting bigger.
         (ii) In one example, N may be dependent on temporal layer.
         (iii) In one example, N may be dependent on QP.
      xi. In above examples, only valid MBVD candidates among the N MBVD candidates may be considered in the following process.
   f. In one example, only if a MBVD candidate is valid, it can be selected to perform reordering and/or SATD process and/or RD process.
   g. In one example, if a MBVD candidate is invalid (e.g., pointing outside of the IBC reference region), the clipping of one or both components of an invalid MBVD candidate to the IBC reference region (e.g., nearest IBC reference region boundaries) may be performed, and the clipped MBVD candidate can be selected to perform reordering and/or SATD process and/or RD process.
9. In one example, the number of distances and/or directions for MBVD of a block may be decided by
   a. The resolution of a picture.
   b. The configuration of the coding process.
   c. The BVDs of the neighboring blocks of the block.
      i. In one example, the above and left neighboring blocks (depicted in FIG. 56) may be used.
      ii. In one example, the adjacent spatial neighboring blocks including left and/or above and/or above-right and/or bottom-left and/or above-left spatial neighboring blocks (an example is shown in FIG. 56) may be used.
   d. In one example, the BVD direction may be decided by the BV direction of an IBC base candidate.
      i. In one example, if the BV direction of an IBC base candidate is horizontal, the BVD direction for this IBC base candidate may be horizontal.
      ii. In one example, if the BV direction of an IBC base candidate is vertical, the BVD direction for this IBC base candidate may be vertical.
   e. Alternatively, the number of distances and/or directions for MBVD may be signaled from encoder to decoder at sequence/picture/slice/CTU/CU level.
10. In one example, the candidates/directions/distances in MBVD which may produce a BV out of the valid range of BV may be excluded from the candidate/directions/distances set to be selected or signaled.
   a. Alternatively, a BV generated in MBVD may be clipped to be in the valid range.
   b. Alternatively, a BV generated in MBVD must be in the valid range in a conformance bitstream.
11. In one example, an IBC MBVD merge flag may be signaled to indicate which one is used between IBC MBVD merge mode and regular IBC merge mode.
   a. In one example, the IBC MBVD merge flag may be context coded.
   b. In one example, if IBC-TM merge mode is used, the IBC MBVD merge flag may be coded before the IBC-TM merge flag.
   c. In one example, if IBC-TM merge mode is used, the IBC MBVD merge flag may be coded after the IBC-TM merge flag.
   d. In one example, the IBC MBVD merge flag may be signaled in a CU-level.
12. In one example, the number (e.g., numIBCMrgSATDCand) of modes selected from IBC merge modes and/or IBC_TM merge modes and/or IBC_MBVD merge modes by fast RDO may be predefined.
   a. Alternatively, the number (e.g., numIBCMrgSATDCand) of modes selected from IBC merge modes and/or IBC_TM merge modes and/or IBC_MBVD merge modes by fast RDO may be adaptively derived.
      i. In one example, numIBCMrgSATDCand may be dependent on the coding information of neighboring blocks.
         (i) In one example, numIBCMrgSATDCand may be dependent on the coding modes of neighboring blocks.
         (ii) In one example, numIBCMrgSATDCand may be dependent on the number of neighboring blocks with IBC merge mode (e.g., IBCMrgNum).
         a) In one example, all the IBCMrgNums may be divided into N3 (e.g., N3 is a positive integer) sets. numIBCMrgSATDCand may be different for different sets of IBCMrgNums and numIBCMrgSATDCand may be same for a set of IBCMrgNums.
         b) In one example, numIBCMrgSATDCand may be a first value for a first set of IBCMrgNums and/or numIBCMrgSATDCand may be a second value for a second set of IBCMrgNums.
         c) In one example, numIBCMrgSATDCand may be same for different sets of IBCMrgNums.
         (iii) In one example, numIBCMrgSATDCand may be dependent on the number of neighboring blocks with IBC merge/AMVP mode (e.g., IBCNum).
         a) In one example, all the IBCNums may be divided into N4 (e.g., N4 is a positive integer) sets. numIBCMrgSATDCand may be different for different sets of IBCNums and numIBCMrgSATDCand may be same for a set of IBCNums.
         b) In one example, numIBCMrgSATDCand may be a first value for a first set of IBCNums and/or numIBCMrgSATDCand may be a second value for a second set of IBCNums.
         c) In one example, numIBCMrgSATDCand may be same for different sets of IBCNums.
         (iv) In one example, the neighboring blocks may include at least one of the five spatial neighbor blocks (shown in FIG. 1) and/or the temporal neighbor block(s) (shown in FIG. 4).
   b. Alternatively, the number (e.g., numIBCMrgSATDCand) of modes selected from IBC merge modes and/or IBC_TM merge modes and/or IBC_MBVD merge modes by fast RDO may be signalled from encoder to decoder.
   c. In one example, numIBCMrgSATDCand may be dependent on the configurations of the coding process (e.g., All Intra, lowdelay_B, lowdelay_P, randomaccess).
      i. In one example, all the (e.g., four) configurations may be divided into Q2 (e.g., Q2 is a positive integer) sets. numIBCMrgSATDCand may be different for different sets of configurations and numIBCMrgSATDCand may be same for a set of configurations.
      ii. In one example, numIBCMrgSATDCand may be a first value for a first set of configurations (e.g., All Intra, numIBCMrgSATDCand=3) and/or numIBCMrgSATDCand may be a second value for a second set of configurations (e.g., RA, LB, LP, numIBCMrgSATDCand=4 or 5).
      iii. In one example, numIBCMrgSATDCand may be a first value for a first set of configurations (e.g., All Intra, numIBCMrgSATDCand=3) and/or numIBCMrgSATDCand may be a second value for a second set of configurations (e.g., RA, numIBCMrgSATDCand=4 or 5).
      iv. Alternatively, numIBCMrgSATDCand may be same for different sets of configurations.
   d. In one example, numIBCMrgSATDCand may be dependent on picture resolutions.
      i. In one example, all the picture resolutions may be divided into P2 (e.g., P2 is a positive integer) sets. numIBCMrgSATDCand may be different for different sets of picture resolutions and numIBCMrgSATDCand may be same for a set of picture resolutions.
      ii. In one example, numIBCMrgSATDCand may be a first value for a first set of picture resolutions and/or numIBCMrgSATDCand may be a second value for a second set of picture resolutions.
      iii. In one example, numIBCMrgSATDCand may be same for different sets of picture resolutions.
   e. In one example, numIBCMrgSATDCand may be dependent on slice types.
      i. In one example, all the slice types may be divided into T2 (e.g., T2 is a positive integer) sets. numIBCMrgSATDCand may be different for different sets of slice types and numIBCMrgSATDCand may be same for a set of slice types.
      ii. In one example, numIBCMrgSATDCand may be a first value for a first set of slice types (e.g., I slice, numIBCMrgSATDCand=3) and/or numIBCMrgSATDCand may be a second value for a second set of slice types (e.g., B slice and/or P slice, numIBCMrgSATDCand=4 or 5).
      iii. In one example, numIBCMrgSATDCand may be same for different sets of slice types.
   f. In one example, numIBCMrgSATDCand may be dependent on other coding parameters.
      i. In one example, numIBCMrgSATDCand may be dependent on block sizes.
         (i) In one example, all the block sizes may be divided into S2 (e.g., S2 is a positive integer) sets. numIBCMrgSATDCand may be different for different sets of block sizes and numIBCMrgSATDCand may be same for a set of block sizes.
         (ii) In one example, numIBCMrgSATDCand may be same for different sets of block sizes.
         (iii) In one example, numIBCMrgSATDCand keeps same or becomes larger with block size getting bigger.
      ii. In one example, numIBCMrgSATDCand may be dependent on temporal layer.
      iii. In one example, numIBCMrgSATDCand may be dependent on QP.
13. In one example, the IBC template matching refinement process may only be performed using the cross search pattern (as shown in FIG. 57).

TABLE 4-1
The relation of distance index and pre-defined offset

| Distance IDX | 0 | 1 | 2 | 3 | 4 | 5 |
|---|---|---|---|---|---|---|
| Offset (in unit of | 1 | 2 | 4 | 8 | 16 | 32 |
| luma sample) | | | | | | |

TABLE 4-2
The relation of distance index and pre-defined offset

| Distance IDX | 0 | 1 | 2 | 3 | 4 | 5 | 6 | 7 |
|---|---|---|---|---|---|---|---|---|
| Offset (in unit of | 1 | 2 | 4 | 8 | 16 | 32 | 64 | 128 |
| luma sample) | | | | | | | | |

TABLE 4-3
The relation of distance index and pre-defined offset

| Distance IDX | 0 | 1 | 2 | 3 | 4 | 5 | 6 |
|---|---|---|---|---|---|---|---|
| Offset (in unit of | 1 | 2 | 3 | 4 | 6 | 8 | 16 |
| luma sample) | | | | | | | |

TABLE 4-4
The relation of distance index and pre-defined offset

| Distance IDX | 0 | 1 | 2 | 3 | 4 | 5 | 6 | 7 | 8 |
|---|---|---|---|---|---|---|---|---|---|
| Offset (in unit of | 1 | 2 | 3 | 4 | 6 | 8 | 16 | 32 | 64 |
| luma sample) | | | | | | | | | |

TABLE 4-5
The relation of distance index and pre-defined offset

| Distance IDX | 0 | 1 | 2 | 3 | 4 | 5 | 6 | 7 | 8 | 9 | 10 | 11 |
|---|---|---|---|---|---|---|---|---|---|---|---|---|
| Offset (in unit of | 1 | 2 | 4 | 8 | 16 | 32 | 48 | 64 | 80 | 96 | 112 | 128 |
| luma sample) | | | | | | | | | | | | |

TABLE 4-6
The relation of distance index and pre-defined offset

| Distance IDX | 0 | 1 | 2 | 3 | 4 | 5 | 6 | 7 | 8 | 9 |
|---|---|---|---|---|---|---|---|---|---|---|
| Offset (in unit of | 1 | 2 | 4 | 8 | 12 | 16 | 24 | 32 | 40 | 48 |
| luma sample) | | | | | | | | | | |
| Distance IDX | 10 | 11 | 12 | 13 | 14 | 15 | 16 | 17 | 18 | 19 |
| Offset (in unit of | 56 | 64 | 72 | 80 | 88 | 96 | 104 | 112 | 120 | 128 |
| luma sample) | | | | | | | | | | |

TABLE 4-7
The relation of distance index and pre-defined offset

| Distance IDX | 0 | 1 | 2 | 3 | 4 | 5 | 6 | 7 | 8 | 9 | 10 | 11 |
|---|---|---|---|---|---|---|---|---|---|---|---|---|
| Offset (in unit of | 1 | 2 | 3 | 4 | 6 | 8 | 10 | 12 | 16 | 20 | 24 | 32 |
| luma sample) | | | | | | | | | | | | |
| Distance IDX | 12 | 13 | 14 | 15 | 16 | 17 | 18 | 19 | 20 | 21 | 22 | 23 |
| Offset (in unit of | 40 | 48 | 56 | 64 | 72 | 80 | 88 | 96 | 104 | 112 | 120 | 128 |
| luma sample) | | | | | | | | | | | | |

TABLE 4-8
The relation of distance index and pre-defined offset

| Distance IDX | 0 | 1 | 2 | 3 | 4 | 5 | 6 | 7 | 8 | 9 | 10 | 11 |
|---|---|---|---|---|---|---|---|---|---|---|---|---|
| Offset (in unit of | 1 | 2 | 4 | 8 | 12 | 16 | 20 | 24 | 28 | 32 | 36 | 40 |
| luma sample) | | | | | | | | | | | | |
| Distance IDX | 12 | 13 | 14 | 15 | 16 | 17 | 18 | 19 | 20 | 21 | 22 | 23 |
| Offset (in unit of | 44 | 48 | 52 | 56 | 60 | 64 | 68 | 72 | 76 | 80 | 84 | 88 |
| luma sample) | | | | | | | | | | | | |

| Distance IDX | 24 | 25 | 26 | 27 | 28 | 29 | 30 | 31 | 32 | 33 |
|---|---|---|---|---|---|---|---|---|---|---|
| Offset (in unit of | 92 | 96 | 100 | 104 | 108 | 112 | 116 | 120 | 124 | 128 |
| luma sample) | | | | | | | | | | |

TABLE 4-9
Sign of BV offset specified by direction index

| Direction IDX | 00 | 01 | 10 | 11 |
|---|---|---|---|---|
| x-axis | + | − | N/A | N/A |
| y-axis | N/A | N/A | + | − |

TABLE 4-10
Sign of BV offset specified by direction index

| Direction IDX | 00 | 01 | 10 | 11 |
|---|---|---|---|---|
| x-axis | + | + | − | − |
| y-axis | + | − | + | − |

TABLE 4-11
Sign of BV offset specified by direction index

| Direction IDX | 000 | 001 | 010 | 011 | 100 | 101 | 110 | 111 |
|---|---|---|---|---|---|---|---|---|
| x-axis | + | − | N/A | N/A | + | + | − | − |
| y-axis | N/A | N/A | + | − | + | − | + | − |

### 5. Embodiment

### 5.1. Embodiment 1

In this embodiment, IBC merge mode with block vector differences (a.k.a. IBC-MBVD) is introduced. Similar as regular MMVD mode, in IBC-MBVD, after an IBC base candidate is selected, it is further refined by the signalled BVDs information.

The distance set is {1-pel, 2-pel, 4-pel, 8-pel, 16-pel, 32-pel, 48-pel, 64-pel, 80-pel, 96-pel, 112-pel, 128-pel}, and the BVD directions are two horizontal and two vertical directions.

For both methods, the 5 base candidates are selected from the reordered IBC merge list. And based on the SAD cost between the template (one row above and one column left to the current block) and its reference for each refinement position, all the possible MBVD refinement positions (12×4) for each base candidate are reordered. Finally, the top ¼ refinement positions with the lowest template SAD costs are kept as available positions, consequently for MBVD index coding.

### 5.2. Embodiment 2

In this embodiment, IBC merge mode with block vector differences (a.k.a. IBC-MBVD) is introduced. Similar as regular MMVD mode, in IBC-MBVD, after an IBC base candidate is selected, it is further refined by the signalled BVDs information.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

For both methods, the 5 base candidates are selected from the reordered IBC merge list. And based on the SAD cost between the template (one row above and one column left to the current block) and its reference for each refinement position, all the possible MBVD refinement positions (20×4) for each base candidate are reordered. Finally, the top ¼ refinement positions with the lowest template SAD costs are kept as available positions, consequently for MBVD index coding.

### 5.3. Embodiment 3

In this embodiment, IBC merge mode with block vector differences (a.k.a. IBC-MBVD) is introduced. Similar as regular MMVD mode, in IBC-MBVD, after an IBC base candidate is selected, it is further refined by the signalled BVDs information.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

For both methods, the 5 base candidates are selected from the reordered IBC merge list. And based on the SAD cost between the template (one row above and one column left to the current block) and its reference for each refinement position, all the possible MBVD refinement positions (20×4) for each base candidate are reordered. Finally, the top ¼ of maximum refinement positions with the lowest template SAD costs are kept as available positions, consequently for MBVD index coding.

The number (e.g., numIBCMrgSATDCand) of modes selected from IBC merge modes and/or IBC_TM merge modes and/or IBC_MBVD merge modes by fast RDO for AI is 3; the number (e.g., numIBCMrgSATDCand) of modes selected from IBC merge modes and/or IBC_TM merge modes and/or IBC_MBVD merge modes by fast RDO for RA and LB is 5.

### 5.4. Embodiment 4

Different from embodiment 3, the top 8 refinement positions with the lowest template SAD costs are kept as available positions.

### 5.5. Embodiment 5

Different from embodiment 3, the top 8 refinement positions with the lowest template SAD costs are kept as available positions for AI, the top 18 refinement positions with the lowest template SAD costs are kept as available positions for RA and LB, consequently for MBVD index coding.

### 5.6. Embodiment 6

Different from embodiment 3, the top 14 refinement positions with the lowest template SAD costs are kept as available positions for AI, the top 18 refinement positions with the lowest template SAD costs are kept as available positions for RA and LB, consequently for MBVD index coding.

### 5.7. Embodiment 7

Different from embodiment 3, the top 8 refinement positions with the lowest template SAD costs are kept as available positions for I slice, the top 18 refinement positions with the lowest template SAD costs are kept as available positions for B slice and P slice, consequently for MBVD index coding.

### 5.8. Embodiment 8

Different from embodiment 3, the top 14 refinement positions with the lowest template SAD costs are kept as available positions for I slice, the top 18 refinement positions with the lowest template SAD costs are kept as available positions for B slice and P slice, consequently for MBVD index coding.

More details of the embodiments of the present disclosure will be described below which are related to IBC MBVD. The embodiments of the present disclosure should be considered as examples to explain the general concepts and should not be interpreted in a narrow way. Furthermore, these embodiments can be applied individually or combined in any manner.

As used herein, the term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular. Moreover, the term “motion candidate” may refer to a motion vector (MV) candidate or a block vector (BV) candidate.

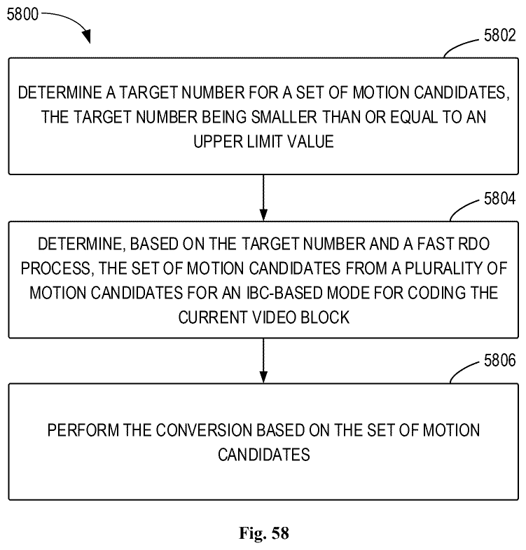

FIG. 58 illustrates a flowchart of a method 5800 for video processing in accordance with some embodiments of the present disclosure. The method 5800 may be implemented during a conversion between a current video block of a video and a bitstream of the video. As shown in FIG. 58, the method 5800 starts at 5802 where a target number for a set of motion candidates is determined. The target number is smaller than or equal to an upper limit value. The target number indicates the number of motion candidates comprised in the set of motion candidate. In some embodiments, the upper limit value may be predefined. Alternatively, the upper limit value may be determined adaptively, which will be described in detail below.

In some embodiments, a first number may be determined based on a sum of the number of valid candidates in an IBC merge list for the current video block and the number of valid candidates in an IBC-TM merge list for the current video block. Furthermore, the target number is generated based on the upper limit value and the first number. By way of example rather than limitation, in accordance with a determination that the first number is larger than or equal to the upper limit value, the upper limit value may be determined to be the target number. In accordance with a determination that the first number is smaller than the upper limit value, the first number may be determined to be the target number. In accordance with a determination that the first number is equal to the upper limit value, either the upper limit value or the first number may be determined to be the target number.

At 5804, based on the target number and a fast rate distortion optimization (RDO) process, the set of motion candidates is determined from a plurality of motion candidates for an IBC-based mode for coding the current video block. By way of example rather than limitation, the IBC-based mode may be an IBC merge mode, an IBC template matching (TM) merge mode, an IBC MBVD mode, an IBC combined inter and intra prediction (CIIP) mode, an IBC geometric partitioning mode (GPM) mode, or the like.

In some embodiments, the fast RDO process may be performed based on a sum of absolute difference (SAD) or a sum of absolute transformed difference (SATD). For example, the distortion used in the fast RDO process may be determined based on SAD, SATD, or the like. The fast RDO process may corresponds to a first pass of a two-pass RDO process. It should be understood that the fast RDO process may refer to any other simplified implementation of the RDO process other than the full RDO process. The scope of the present disclosure is not limited in this respect.

At 5806, the conversion is performed based on the set of motion candidates. In one example, the conversion may include encoding the current video block into the bitstream. Alternatively or additionally, the conversion may include decoding the current video block from the bitstream. It should be understood that the above illustrations are described merely for purpose of description. The scope of the present disclosure is not limited in this respect.

In view of the above, the number of the set of motion candidates selected during the fast RDO process for subsequent process is limited by the upper limit value. Compared with the conventional solution without such an upper limit, the proposed method can advantageously reduce the complexity of subsequent process and thus improve the coding efficiency.

In some embodiments, the upper limit value may be dependent on a target configuration of a coding process for coding the current video block. For example, all of candidate configurations of the coding process may be divided into a plurality of sets of candidate configurations. The upper limit value may be the same for each candidate configuration in a set of candidate configurations among the plurality of sets of candidate configurations.

For example, the plurality of sets of candidate configurations may comprise a first set of candidate configurations and a second set of candidate configurations different from the first set of candidate configurations. If the target configuration is comprised in the first set of candidate configurations, the upper limit value may be equal to a first value, if the target configuration is comprised in the second set of candidate configurations, the upper limit value may be equal to a second value. The first value may be different from the second value. For example, the first value may be 3, while the second value may be 4 or 5. Alternatively, the first value may be the same as the second value. For example, both the first value and the second value may be 4. It should be understood that the above examples are described merely for purpose of description. The scope of the present disclosure is not limited in this respect.

In some examples, the first set of candidate configurations may comprise an all intra (AI) configuration, and the second set of candidate configurations may comprise a random access (RA) configuration. Additionally, the first set of candidate configurations may further comprise a first low-delay configuration (e.g., low-delay B (LB)) and a second low-delay configuration (e.g., low-delay P (LP)). Alternatively, the second set of candidate configurations may further comprise a first low-delay configuration (e.g., low-delay B (LB)) and a second low-delay configuration (e.g., low-delay P (LP)). It should be understood that the above examples are described merely for purpose of description. The scope of the present disclosure is not limited in this respect.

In some embodiments, the upper limit value may be dependent on coding information of neighboring blocks of the current video block. By way of example rather than limitation, the upper limit value may be dependent on coding modes of neighboring blocks of the current video block. By way of example rather than limitation, the neighboring blocks of the current video block may comprise at least one of the following: a spatial neighboring block (as shown in FIG. 4), or a temporal neighboring block (as shown in FIG. 7).

In some embodiments, the upper limit value may be dependent on the block number of neighboring blocks of the current video block that are coded with an IBC merge mode. For example, all of candidate values of the block number may be divided into a plurality of sets of candidate values.

The upper limit value may be the same for each candidate value in a set of candidate values among the plurality of sets of candidate values.

For example, the plurality of sets of candidate values may comprise a first set of candidate values and a second set of candidate values different from the first set of candidate values. If a value of the block number is comprised in the first set of candidate values, the upper limit value may be equal to a first value, if the value of the block number is comprised in the second set of candidate values, the upper limit value may be equal to a second value. The first value may be different from the second value. Alternatively, the first value may be the same as the second value.

In some embodiments, the upper limit value may be dependent on the block number of neighboring blocks of the current video block that are coded with an IBC merge mode or an IBC advanced motion vector prediction (AMVP) mode. The upper limit value may be the same for each candidate value in a set of candidate values among the plurality of sets of candidate values.

For example, all of candidate values of the block number may be divided into a plurality of sets of candidate values. The plurality of sets of candidate values may comprise a first set of candidate values and a second set of candidate values different from the first set of candidate values. If a value of the block number is comprised in the first set of candidate values, the upper limit value may be equal to a first value, if the value of the block number is comprised in the second set of candidate values, the upper limit value may be equal to a second value. The first value may be different from the second value. Alternatively, the first value may be the same as the second value.

In some embodiments, the upper limit value may be dependent on a resolution of a picture comprising the current video block. For example, all of candidate values of the resolution may be divided into a plurality of sets of candidate values. The upper limit value may be the same for each candidate value in a set of candidate values among the plurality of sets of candidate values.

For example, the plurality of sets of candidate values may comprise a first set of candidate values and a second set of candidate values different from the first set of candidate values. If a value of the resolution is comprised in the first set of candidate values, the upper limit value may be equal to a first value, if the value of the resolution is comprised in the second set of candidate values, the upper limit value may be equal to a second value. The first value may be different from the second value. Alternatively, the first value may be the same as the second value.

In some embodiments, the upper limit value may be dependent on a type of a slice comprising the current video block. For example, all of candidate types of the slice may be divided into a plurality of sets of candidate types. the upper limit value may be the same for each candidate type in a set of candidate types among the plurality of sets of candidate types.

For example, the plurality of sets of candidate types may comprise a first set of candidate types and a second set of candidate types different from the first set of candidate types. If the type of the slice is comprised in the first set of candidate types, the upper limit value may be equal to a first value, if the type of the slice is comprised in the second set of candidate types, the upper limit value may be equal to a second value. The first value may be different from the second value. Alternatively, the first value may be the same as the second value. By way of example rather than limitation, the first set of candidate types may comprise intra-coded slice (I-slice), and the second set of candidate types may comprise predicted slice (P-slice) and bidirectional predicted slice (B-slice). It should be understood that the above examples are described merely for purpose of description. The scope of the present disclosure is not limited in this respect.

In some embodiments, the upper limit value may be dependent on a coding parameter of the current video block. The coding parameter may comprise a block size, a temporal layer, a quantization parameter (QP), or the like. For example, all of candidate values of the coding parameter may be divided into a plurality of sets of candidate values. The upper limit value may be the same for each candidate value in a set of candidate values among the plurality of sets of candidate values.

For example, the plurality of sets of candidate values may comprise a first set of candidate values and a second set of candidate values different from the first set of candidate values. If a value of the coding parameter is comprised in the first set of candidate values, the upper limit value may be equal to a first value, if the value of the coding parameter is comprised in the second set of candidate values, the upper limit value may be equal to a second value. The first value may be different from the second value. Alternatively, the first value may be the same as the second value.

In some embodiments, the coding parameter may be a block size. If a value of the block size is equal a first size value, the upper limit value may be equal to a first value, if the value of the block size is equal a second size value, the upper limit value may be equal to a second value. The second size value is larger than the first size value. In one example, the first value may be the same as the second value. That is, the upper limit value may keep same with the block size getting bigger.

Alternatively, the second value may be larger than the first value. That is, the upper limit value may become larger with the block size getting bigger.

In some embodiments, the upper limit value may be indicated in the bitstream.

In some embodiments, a set of MBVD candidates may be selected from a plurality of MBVD candidates associated with a first IBC base candidate for the current video block. The number of MBVD candidates in the set of MBVD candidates is equal to N and N is a positive integer. Moreover, the plurality of motion candidates may be determined based on the set of MBVD candidates.

In some embodiments, all of IBC base candidates for the current video block may be divided into a plurality of sets of IBC base candidates. N may be the same for each IBC base candidate in a set of IBC base candidates among the plurality of sets of IBC base candidates.

For example, the plurality of sets of IBC base candidates may comprise a first set of IBC base candidates and a second set of IBC base candidates different from the first set of IBC base candidates.

If the first IBC base candidate is comprised in the first set of IBC base candidates, N may be equal to a third value, if the first IBC base candidate is comprised in the second set of IBC base candidates, N may be equal to a fourth value. The third value may be different from the fourth value. Alternatively, the third value may be the same as the fourth value.

In some embodiments, N may be predefined. For example, N may be dependent on a target configuration of a coding process for coding the current video block. By way of example, all of candidate configurations of the coding process may be divided into a plurality of sets of candidate configurations. N may be the same for each candidate configuration in a set of candidate configurations among the plurality of sets of candidate configurations.

For example, the plurality of sets of candidate configurations may comprise a first set of candidate configurations and a second set of candidate configurations different from the first set of candidate configurations. If the target configuration is comprised in the first set of candidate configurations, N may be equal to a third value, such as 8, 14, or 20. If the target configuration is comprised in the second set of candidate configurations, N may be equal to a fourth value, such as 8, 18 or 20. The third value may be different from the fourth value. For example, the third value may be 8 and the fourth value may be 20. Alternatively, the third value may be the same as the fourth value. For example, both the third value and the fourth value may be 8. It should be understood that the above examples are described merely for purpose of description. The scope of the present disclosure is not limited in this respect.

In some examples, the first set of candidate configurations may comprise an AI configuration, and the second set of candidate configurations may comprise an RA configuration. Additionally, the first set of candidate configurations may further comprise a first low-delay configuration (e.g., low-delay B (LB)) and a second low-delay configuration (e.g., low-delay P (LP)). Alternatively, the second set of candidate configurations may further comprise a first low-delay configuration (e.g., low-delay B (LB)) and a second low-delay configuration (e.g., low-delay P (LP)). It should be understood that the above examples are described merely for purpose of description. The scope of the present disclosure is not limited in this respect.

In some embodiments, N may be dependent on a resolution of a picture comprising the current video block. For example, all of candidate values of the resolution may be divided into a plurality of sets of candidate values. N may be the same for each candidate value in a set of candidate values among the plurality of sets of candidate values.

For example, the plurality of sets of candidate values may comprise a first set of candidate values and a second set of candidate values different from the first set of candidate values. If a value of the resolution is comprised in the first set of candidate values, N may be equal to a third value, if the value of the resolution is comprised in the second set of candidate values, N may be equal to a fourth value. The third value may be different from the fourth value. Alternatively, the third value may be the same as the fourth value.

In some embodiments, N may be dependent on a type of a slice comprising the current video block. For example, all of candidate types of the slice may be divided into a plurality of sets of candidate types. N may be the same for each candidate type in a set of candidate types among the plurality of sets of candidate types.

For example, the plurality of sets of candidate types comprise a first set of candidate types and a second set of candidate types different from the first set of candidate types. If the type of the slice is comprised in the first set of candidate types, N may be equal to a third value, if the type of the slice is comprised in the second set of candidate types, N may be equal to a fourth value. The third value may be different from the fourth value. Alternatively, the third value may be the same as the fourth value. By way of example rather than limitation, the first set of candidate types may comprise intra-coded slice (I-slice), and the second set of candidate types may comprise predicted slice (P-slice) and bidirectional predicted slice (B-slice). It should be understood that the above examples are described merely for purpose of description. The scope of the present disclosure is not limited in this respect.

In some embodiments, N may be indicated in the bitstream. For example, N may be determined based on at least one of temporal information or coding information of the current video block. In some embodiments, N may be dependent on the number of valid MBVD candidates associated with the first IBC base candidate.

In some embodiments, N may be dependent on coding information of neighboring blocks of the current video block. For example, N may be dependent on coding modes of neighboring blocks of the current video block. By way of example rather than limitation, the neighboring blocks of the current video block may comprise at least one of the following: a spatial neighboring block (as shown in FIG. 4), or a temporal neighboring block (as shown in FIG. 7).

In some embodiments, N may be dependent on the block number of neighboring blocks of the current video block that are coded with an IBC merge mode. For example, all of candidate values of the block number may be divided into a plurality of sets of candidate values. N may be the same for each candidate value in a set of candidate values among the plurality of sets of candidate values.

For example, the plurality of sets of candidate values may comprise a first set of candidate values and a second set of candidate values different from the first set of candidate values. If a value of the block number is comprised in the first set of candidate values, N may be equal to a third value, if the value of the block number is comprised in the second set of candidate values, N may be equal to a fourth value. The third value may be different from the fourth value. Alternatively, the third value may be the same as the fourth value.

In some embodiments, N may be dependent on the block number of neighboring blocks of the current video block that are coded with an IBC merge mode or an IBC AMVP mode. For example, all of candidate values of the block number may be divided into a plurality of sets of candidate values.

N may be the same for each candidate value in a set of candidate values among the plurality of sets of candidate values.

For example, the plurality of sets of candidate values may comprise a first set of candidate values and a second set of candidate values different from the first set of candidate values. If a value of the block number is comprised in the first set of candidate values, N may be equal to a third value, if the value of the block number is comprised in the second set of candidate values, N may be equal to a fourth value. The third value may be different from the fourth value. Alternatively, the third value may be the same as the fourth value.

In some embodiments, N may be dependent on a coding parameter of the current video block. The coding parameter may comprise a block size, a temporal layer, a quantization parameter (QP), or the like. For example, all of candidate values of the coding parameter may be divided into a plurality of sets of candidate values. N may be the same for each candidate value in a set of candidate values among the plurality of sets of candidate values.

For example, the plurality of sets of candidate values may comprise a first set of candidate values and a second set of candidate values different from the first set of candidate values. If a value of the coding parameter is comprised in the first set of candidate values, N may be equal to a third value, if the value of the coding parameter is comprised in the second set of candidate values, N may be equal to a fourth value. The third value may be different from the fourth value. Alternatively, the third value may be the same as the fourth value.

In some embodiments, the coding parameter may be a block size. If a value of the block size may be equal a first size value, N may be equal to a third value, if the value of the block size may be equal a second size value, N may be equal to a fourth value, the second size value being larger than the first size value. The third value may be the same as the fourth value. That is, N may keep same with the block size getting bigger. Alternatively, the fourth value may be larger than the third value. That is, N may become larger with the block size getting bigger.

In some embodiments, the plurality of motion candidates may be determined based on valid MBVD candidates in the set of MBVD candidates. In other words, only valid MBVD candidates may be considered in the subsequent process.

In some embodiments, N may be equal to a predetermined number, and the set of MBVD candidates may comprise the top N MBVD candidates with the lowest template SAD costs. By way of example rather than limitation, the predetermined number may be equal to 8, and the top 8 MBVD candidates with the lowest template SAD costs may be selected. It should be understood that the above examples are described merely for purpose of description. The scope of the present disclosure is not limited in this respect.

In some embodiments, the IBC-based mode may be an IBC-MBVD mode. In one example, a distance set for the IBC-MBVD mode may be {1-pel, 2-pel, 4-pel, 8-pel, 16-pel, 24-pel, 40-pel, 56-pel, 72-pel, 88-pel, 104-pel, 120-pel}. In addition, a distance index set corresponding to the distance set may be {0, 1, 2, 3, 4, 5, 6, 7, 8, 9, 10, 11}. In another example, a distance set for the IBC-MBVD mode may be {1-pel, 2-pel, 4-pel, 8-pel, 12-pel, 16-pel, 24-pel, 32-pel, 40-pel, 56-pel, 72-pel, 88-pel, 104-pel, 120-pel} and a distance index set corresponding to the distance set may be {0, 1, 2, 3, 4, 5, 6, 7, 8, 9, 10, 11, 12, 13}. In a further example, a distance set for the IBC-MBVD mode may be {1-pel, 2-pel, 4-pel, 8-pel, 12-pel, 16-pel, 24-pel, 32-pel, 40-pel, 48-pel, 56-pel, 64-pel, 72-pel, 80-pel}. Furthermore, a distance index set corresponding to the distance set may be {0, 1, 2, 3, 4, 5, 6, 7, 8, 9, 10, 11, 12, 13}.

According to further embodiments of the present disclosure, a non-transitory computer-readable recording medium is provided. The non-transitory computer-readable recording medium stores a bitstream of a video which is generated by a method performed by an apparatus for video processing. In the method, a target number for a set of motion candidates is determined. The target number is smaller than or equal to an upper limit value. Based on the target number and a fast RDO process, the set of motion candidates is determined from a plurality of motion candidates for an IBC-based mode for coding a current video block of the video. Moreover, the bitstream is generated based on the set of motion candidates.

According to still further embodiments of the present disclosure, a method for storing bitstream of a video is provided. According to the method, a target number for a set of motion candidates is determined. The target number is smaller than or equal to an upper limit value. Based on the target number and a fast RDO process, the set of motion candidates is determined from a plurality of motion candidates for an IBC-based mode for coding a current video block of the video. Moreover, the bitstream is generated based on the set of motion candidates, and the bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between the current video block and a bitstream of the video, a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding the current video block; and performing the conversion based on the set of motion candidates.

Clause 2. The method of clause 1, wherein the IBC-based mode comprises one of the following: an IBC merge mode, an IBC template matching (TM) merge mode, or an IBC merge mode with block vector difference (MBVD) mode.

Clause 3. The method of any of clauses 1-2, wherein determining the target number comprises: determining a first number based on a sum of the number of valid candidates in an IBC merge list for the current video block and the number of valid candidates in an IBC-TM merge list for the current video block; and generating the target number based on the upper limit value and the first number.

Clause 4. The method of clause 3, wherein generating the target number comprises: in accordance with a determination that the first number is larger than or equal to the upper limit value, determining the upper limit value to be the target number; and in accordance with a determination that the first number is smaller than the upper limit value, determining the first number to be the target number.

Clause 5. The method of any of clauses 1-4, wherein the fast RDO process is performed based on a sum of absolute difference (SAD) or a sum of absolute transformed difference (SATD).

Clause 6. The method of any of clauses 1-5, wherein the upper limit value is predefined.

Clause 7. The method of any of clauses 1-5, wherein the upper limit value is dependent on a target configuration of a coding process for coding the current video block.

Clause 8. The method of clause 7, wherein all of candidate configurations of the coding process are divided into a plurality of sets of candidate configurations.

Clause 9. The method of clause 8, wherein the plurality of sets of candidate configurations comprise a first set of candidate configurations and a second set of candidate configurations different from the first set of candidate configurations, if the target configuration is comprised in the first set of candidate configurations, the upper limit value is equal to a first value, if the target configuration is comprised in the second set of candidate configurations, the upper limit value is equal to a second value.

Clause 10. The method of clause 9, wherein the first set of candidate configurations comprises an all intra (AI) configuration, and the second set of candidate configurations comprises a random access (RA) configuration.

Clause 11. The method of clause 10, wherein the first set of candidate configurations or the second set of candidate configurations further comprises a first low-delay configuration and a second low-delay configuration.

Clause 12. The method of any of clauses 9-11, wherein the first value is different from the second value.

Clause 13. The method of any of clauses 9-11, wherein the first value is the same as the second value.

Clause 14. The method of any of clauses 8-13, wherein the upper limit value is the same for each candidate configuration in a set of candidate configurations among the plurality of sets of candidate configurations.

Clause 15. The method of any of clauses 1-5, wherein the upper limit value is determined adaptively.

Clause 16. The method of clause 15, wherein the upper limit value is dependent on coding information of neighboring blocks of the current video block.

Clause 17. The method of clause 15, wherein the upper limit value is dependent on coding modes of neighboring blocks of the current video block.

Clause 18. The method of clause 15, wherein the upper limit value is dependent on the block number of neighboring blocks of the current video block that are coded with an IBC merge mode.

Clause 19. The method of clause 18, wherein all of candidate values of the block number are divided into a plurality of sets of candidate values.

Clause 20. The method of clause 19, wherein the plurality of sets of candidate values comprise a first set of candidate values and a second set of candidate values different from the first set of candidate values, if a value of the block number is comprised in the first set of candidate values, the upper limit value is equal to a first value, if the value of the block number is comprised in the second set of candidate values, the upper limit value is equal to a second value.

Clause 21. The method of clause 20, wherein the first value is different from the second value.

Clause 22. The method of clause 20, wherein the first value is the same as the second value.

Clause 23. The method of any of clauses 19-22, wherein the upper limit value is the same for each candidate value in a set of candidate values among the plurality of sets of candidate values.

Clause 24. The method of clause 15, wherein the upper limit value is dependent on the block number of neighboring blocks of the current video block that are coded with an IBC merge mode or an IBC advanced motion vector prediction (AMVP) mode.

Clause 25. The method of clause 24, wherein all of candidate values of the block number are divided into a plurality of sets of candidate values.

Clause 26. The method of clause 25, wherein the plurality of sets of candidate values comprise a first set of candidate values and a second set of candidate values different from the first set of candidate values, if a value of the block number is comprised in the first set of candidate values, the upper limit value is equal to a first value, if the value of the block number is comprised in the second set of candidate values, the upper limit value is equal to a second value.

Clause 27. The method of clause 26, wherein the first value is different from the second value.

Clause 28. The method of clause 26, wherein the first value is the same as the second value.

Clause 29. The method of any of clauses 25-28, wherein the upper limit value is the same for each candidate value in a set of candidate values among the plurality of sets of candidate values.

Clause 30. The method of any of clauses 16-29, wherein the neighboring blocks of the current video block comprises at least one of the following: a spatial neighboring block, or a temporal neighboring block.

Clause 31. The method of any of clauses 1-5, wherein the upper limit value is dependent on a resolution of a picture comprising the current video block.

Clause 32. The method of clause 31, wherein all of candidate values of the resolution are divided into a plurality of sets of candidate values.

Clause 33. The method of clause 32, wherein the plurality of sets of candidate values comprise a first set of candidate values and a second set of candidate values different from the first set of candidate values, if a value of the resolution is comprised in the first set of candidate values, the upper limit value is equal to a first value, if the value of the resolution is comprised in the second set of candidate values, the upper limit value is equal to a second value.

Clause 34. The method of clause 33, wherein the first value is different from the second value.

Clause 35. The method of clause 33, wherein the first value is the same as the second value.

Clause 36. The method of any of clauses 32-35, wherein the upper limit value is the same for each candidate value in a set of candidate values among the plurality of sets of candidate values.

Clause 37. The method of any of clauses 1-5, wherein the upper limit value is dependent on a type of a slice comprising the current video block.

Clause 38. The method of clause 37, wherein all of candidate types of the slice are divided into a plurality of sets of candidate types.

Clause 39. The method of clause 38, wherein the plurality of sets of candidate types comprise a first set of candidate types and a second set of candidate types different from the first set of candidate types, if the type of the slice is comprised in the first set of candidate types, the upper limit value is equal to a first value, if the type of the slice is comprised in the second set of candidate types, the upper limit value is equal to a second value.

Clause 40. The method of clause 39, wherein the first value is different from the second value.

Clause 41. The method of clause 39, wherein the first value is the same as the second value.

Clause 42. The method of any of clauses 38-41, wherein the upper limit value is the same for each candidate type in a set of candidate types among the plurality of sets of candidate types.

Clause 43. The method of any of clauses 1-5, wherein the upper limit value is dependent on a coding parameter of the current video block.

Clause 44. The method of clause 43, wherein the coding parameter comprises one of the following: a block size, a temporal layer, or a quantization parameter (QP).

Clause 45. The method of any of clause 43-44, wherein all of candidate values of the coding parameter are divided into a plurality of sets of candidate values.

Clause 46. The method of clause 45, wherein the plurality of sets of candidate values comprise a first set of candidate values and a second set of candidate values different from the first set of candidate values, if a value of the coding parameter is comprised in the first set of candidate values, the upper limit value is equal to a first value, if the value of the coding parameter is comprised in the second set of candidate values, the upper limit value is equal to a second value.

Clause 47. The method of clause 46, wherein the first value is different from the second value.

Clause 48. The method of clause 46, wherein the first value is the same as the second value.

Clause 49. The method of any of clauses 45-48, wherein the upper limit value is the same for each candidate value in a set of candidate values among the plurality of sets of candidate values.

Clause 50. The method of clause 43, wherein the coding parameter is a block size, if a value of the block size is equal a first size value, the upper limit value is equal to a first value, if the value of the block size is equal a second size value, the upper limit value is equal to a second value, the second size value being larger than the first size value.

Clause 51. The method of clause 50, wherein the first value is the same as the second value.

Clause 52. The method of clause 50, wherein the second value is larger than the first value.

Clause 53. The method of any of clauses 1-52, wherein the upper limit value is indicated in the bitstream.

Clause 54. The method of any of clauses 1-53, further comprising: selecting a set of MBVD candidates from a plurality of MBVD candidates associated with a first IBC base candidate for the current video block, the number of MBVD candidates in the set of MBVD candidates being equal to N and N being a positive integer; and determining the plurality of motion candidates based on the set of MBVD candidates.

Clause 55. The method of clause 54, wherein all of IBC base candidates for the current video block are divided into a plurality of sets of IBC base candidates.

Clause 56. The method of clause 55, wherein the plurality of sets of IBC base candidates comprise a first set of IBC base candidates and a second set of IBC base candidates different from the first set of IBC base candidates, if the first IBC base candidate is comprised in the first set of IBC base candidates, N is equal to a third value, if the first IBC base candidate is comprised in the second set of IBC base candidates, N is equal to a fourth value.

Clause 57. The method of clause 56, wherein the third value is different from the fourth value.

Clause 58. The method of clause 56, wherein the third value is the same as the fourth value.

Clause 59. The method of any of clauses 55-56, wherein N is the same for each IBC base candidate in a set of IBC base candidates among the plurality of sets of IBC base candidates.

Clause 60. The method of clause 54, wherein N is predefined.

Clause 61. The method of clause 60, wherein N is dependent on a target configuration of a coding process for coding the current video block.

Clause 62. The method of clause 61, wherein all of candidate configurations of the coding process are divided into a plurality of sets of candidate configurations.

Clause 63. The method of clause 62, wherein the plurality of sets of candidate configurations comprise a first set of candidate configurations and a second set of candidate configurations different from the first set of candidate configurations, if the target configuration is comprised in the first set of candidate configurations, N is equal to a third value, if the target configuration is comprised in the second set of candidate configurations, N is equal to a fourth value.

Clause 64. The method of clause 63, wherein the first set of candidate configurations comprises an AI configuration, and the second set of candidate configurations comprises an RA configuration.

Clause 65. The method of clause 64, wherein the first set of candidate configurations or the second set of candidate configurations further comprises a first low-delay configuration and a second low-delay configuration.

Clause 66. The method of any of clauses 63-65, wherein the third value is different from the fourth value.

Clause 67. The method of any of clauses 63-65, wherein the third value is the same as the fourth value.

Clause 68. The method of any of clauses 62-67, wherein N is the same for each candidate configuration in a set of candidate configurations among the plurality of sets of candidate configurations.

Clause 69. The method of clause 60, wherein N is dependent on a resolution of a picture comprising the current video block.

Clause 70. The method of clause 69, wherein all of candidate values of the resolution are divided into a plurality of sets of candidate values.

Clause 71. The method of clause 70, wherein the plurality of sets of candidate values comprise a first set of candidate values and a second set of candidate values different from the first set of candidate values, if a value of the resolution is comprised in the first set of candidate values, N is equal to a third value, if the value of the resolution is comprised in the second set of candidate values, N is equal to a fourth value.

Clause 72. The method of clause 71, wherein the third value is different from the fourth value.

Clause 73. The method of clause 71, wherein the third value is the same as the fourth value.

Clause 74. The method of any of clauses 70-73, wherein N is the same for each candidate value in a set of candidate values among the plurality of sets of candidate values.

Clause 75. The method of clause 60, wherein N is dependent on a type of a slice comprising the current video block.

Clause 76. The method of clause 75, wherein all of candidate types of the slice are divided into a plurality of sets of candidate types.

Clause 77. The method of clause 76, wherein the plurality of sets of candidate types comprise a first set of candidate types and a second set of candidate types different from the first set of candidate types, if the type of the slice is comprised in the first set of candidate types, N is equal to a third value, if the type of the slice is comprised in the second set of candidate types, N is equal to a fourth value.

Clause 78. The method of clause 77, wherein the third value is different from the fourth value.

Clause 79. The method of clause 77, wherein the third value is the same as the fourth value.

Clause 80. The method of any of clauses 76-79, wherein N is the same for each candidate type in a set of candidate types among the plurality of sets of candidate types.

Clause 81. The method of clause 54, wherein N is indicated in the bitstream.

Clause 82. The method of clause 54, wherein N is determined based on at least one of temporal information or coding information of the current video block.

Clause 83. The method of clause 54, wherein N is dependent on the number of valid MBVD candidates associated with the first IBC base candidate.

Clause 84. The method of clause 54, wherein N is dependent on coding information of neighboring blocks of the current video block.

Clause 85. The method of clause 54, wherein N is dependent on coding modes of neighboring blocks of the current video block.

Clause 86. The method of clause 54, wherein N is dependent on the block number of neighboring blocks of the current video block that are coded with an IBC merge mode.

Clause 87. The method of clause 86, wherein all of candidate values of the block number are divided into a plurality of sets of candidate values.

Clause 88. The method of clause 87, wherein the plurality of sets of candidate values comprise a first set of candidate values and a second set of candidate values different from the first set of candidate values, if a value of the block number is comprised in the first set of candidate values, N is equal to a third value, if the value of the block number is comprised in the second set of candidate values, N is equal to a fourth value.

Clause 89. The method of clause 88, wherein the third value is different from the fourth value.

Clause 90. The method of clause 88, wherein the third value is the same as the fourth value.

Clause 91. The method of any of clauses 87-90, wherein N is the same for each candidate value in a set of candidate values among the plurality of sets of candidate values.

Clause 92. The method of clause 54, wherein N is dependent on the block number of neighboring blocks of the current video block that are coded with an IBC merge mode or an IBC AMVP mode.

Clause 93. The method of clause 92, wherein all of candidate values of the block number are divided into a plurality of sets of candidate values.

Clause 94. The method of clause 93, wherein the plurality of sets of candidate values comprise a first set of candidate values and a second set of candidate values different from the first set of candidate values, if a value of the block number is comprised in the first set of candidate values, N is equal to a third value, if the value of the block number is comprised in the second set of candidate values, N is equal to a fourth value.

Clause 95. The method of clause 94, wherein the third value is different from the fourth value.

Clause 96. The method of clause 94, wherein the third value is the same as the fourth value.

Clause 97. The method of any of clauses 93-96, wherein N is the same for each candidate value in a set of candidate values among the plurality of sets of candidate values.

Clause 98. The method of any of clauses 84-97, wherein the neighboring blocks of the current video block comprises at least one of the following: a spatial neighboring block, or a temporal neighboring block.

Clause 99. The method of clause 54, wherein N is dependent on a coding parameter of the current video block.

Clause 100. The method of clause 99, wherein the coding parameter comprises one of the following: a block size, a temporal layer, or a QP.

Clause 101. The method of any of clause 99-100, wherein all of candidate values of the coding parameter are divided into a plurality of sets of candidate values.

Clause 102. The method of clause 101, wherein the plurality of sets of candidate values comprise a first set of candidate values and a second set of candidate values different from the first set of candidate values, if a value of the coding parameter is comprised in the first set of candidate values, N is equal to a third value, if the value of the coding parameter is comprised in the second set of candidate values, N is equal to a fourth value.

Clause 103. The method of clause 102, wherein the third value is different from the fourth value.

Clause 104. The method of clause 102, wherein the third value is the same as the fourth value.

Clause 105. The method of any of clauses 101-104, wherein N is the same for each candidate value in a set of candidate values among the plurality of sets of candidate values.

Clause 106. The method of clause 99, wherein the coding parameter is a block size, if a value of the block size is equal a first size value, N is equal to a third value, if the value of the block size is equal a second size value, N is equal to a fourth value, the second size value being larger than the first size value.

Clause 107. The method of clause 106, wherein the third value is the same as the fourth value.

Clause 108. The method of clause 106, wherein the fourth value is larger than the third value.

Clause 109. The method of any of clauses 54-108, wherein determining the plurality of motion candidates comprising: determining the plurality of motion candidates based on valid MBVD candidates in the set of MBVD candidates.

Clause 110. The method of clause 54, wherein N is equal to a predetermined number, and the set of MBVD candidates comprises the top N MBVD candidates with the lowest template SAD costs.

Clause 111. The method of clause 110, wherein the predetermined number is equal to 8.

Clause 112. The method of any of clauses 1-111, wherein the IBC-based mode is an IBC-MBVD mode, and a distance set for the IBC-MBVD mode is {1-pel, 2-pel, 4-pel, 8-pel, 16-pel, 24-pel, 40-pel, 56-pel, 72-pel, 88-pel, 104-pel, 120-pel}.

Clause 113. The method of clause 112, wherein a distance index set corresponding to the distance set is {0, 1, 2, 3, 4, 5, 6, 7, 8, 9, 10, 11}.

Clause 114. The method of any of clauses 1-111, wherein the IBC-based mode is an IBC-MBVD mode, and a distance set for the IBC-MBVD mode is {1-pel, 2-pel, 4-pel, 8-pel, 12-pel, 16-pel, 24-pel, 32-pel, 40-pel, 56-pel, 72-pel, 88-pel, 104-pel, 120-pel}.

Clause 115. The method of clause 114, wherein a distance index set corresponding to the distance set is {0, 1, 2, 3, 4, 5, 6, 7, 8, 9, 10, 11, 12, 13}.

Clause 116. The method of any of clauses 1-111, wherein the IBC-based mode is an IBC-MBVD mode, and a distance set for the IBC-MBVD mode is {1-pel, 2-pel, 4-pel, 8-pel, 12-pel, 16-pel, 24-pel, 32-pel, 40-pel, 48-pel, 56-pel, 64-pel, 72-pel, 80-pel}.

Clause 117. The method of clause 116, wherein a distance index set corresponding to the distance set is {0, 1, 2, 3, 4, 5, 6, 7, 8, 9, 10, 11, 12, 13}.

Clause 118. The method of any of clauses 1-117, wherein the conversion includes encoding the current video block into the bitstream.

Clause 119. The method of any of clauses 1-117, wherein the conversion includes decoding the current video block from the bitstream.

Clause 120. An apparatus for video processing comprising a processor and a non-transitory memory with instructions thereon, wherein the instructions upon execution by the processor, cause the processor to perform a method in accordance with any of clauses 1-119.

Clause 121. A non-transitory computer-readable storage medium storing instructions that cause a processor to perform a method in accordance with any of clauses 1-119.

Clause 122. A non-transitory computer-readable recording medium storing a bitstream of a video which is generated by a method performed by an apparatus for video processing, wherein the method comprises: determining a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding a current video block of the video; and generating the bitstream based on the set of motion candidates.

Clause 123. A method for storing a bitstream of a video, comprising: determining a target number for a set of motion candidates, the target number being smaller than or equal to an upper limit value; determining, based on the target number and a fast rate distortion optimization (RDO) process, the set of motion candidates from a plurality of motion candidates for an intra block copy (IBC) based mode for coding a current video block of the video; generating the bitstream based on the set of motion candidates; and storing the bitstream in a non-transitory computer-readable recording medium.

### Example Device

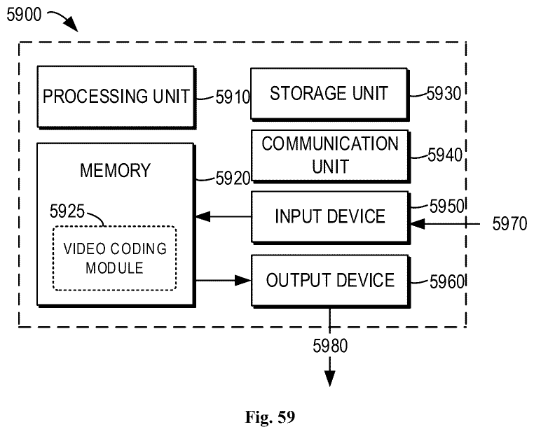

FIG. 59 illustrates a block diagram of a computing device 5900 in which various embodiments of the present disclosure can be implemented. The computing device 5900 may be implemented as or included in the source device 110 (or the video encoder 114 or 200) or the destination device 120 (or the video decoder 124 or 300).

It would be appreciated that the computing device 5900 shown in FIG. 59 is merely for purpose of illustration, without suggesting any limitation to the functions and scopes of the embodiments of the present disclosure in any manner.

As shown in FIG. 59, the computing device 5900 includes a general-purpose computing device 5900. The computing device 5900 may at least comprise one or more processors or processing units 5910, a memory 5920, a storage unit 5930, one or more communication units 5940, one or more input devices 5950, and one or more output devices 5960.

In some embodiments, the computing device 5900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 5900 can support any type of interface to a user (such as “wearable” circuitry and the like).

The processing unit 5910 may be a physical or virtual processor and can implement various processes based on programs stored in the memory 5920. In a multi-processor system, multiple processing units execute computer executable instructions in parallel so as to improve the parallel processing capability of the computing device 5900. The processing unit 5910 may also be referred to as a central processing unit (CPU), a microprocessor, a controller or a microcontroller.

The computing device 5900 typically includes various computer storage medium. Such medium can be any medium accessible by the computing device 5900, including, but not limited to, volatile and non-volatile medium, or detachable and non-detachable medium. The memory 5920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 5930 may be any detachable or non-detachable medium and may include a machine-readable medium such as a memory, flash memory drive, magnetic disk or another other media, which can be used for storing information and/or data and can be accessed in the computing device 5900.

The computing device 5900 may further include additional detachable/non-detachable, volatile/non-volatile memory medium. Although not shown in FIG. 59, it is possible to provide a magnetic disk drive for reading from and/or writing into a detachable and non-volatile magnetic disk and an optical disk drive for reading from and/or writing into a detachable non-volatile optical disk.

In such cases, each drive may be connected to a bus (not shown) via one or more data medium interfaces.

The communication unit 5940 communicates with a further computing device via the communication medium. In addition, the functions of the components in the computing device 5900 can be implemented by a single computing cluster or multiple computing machines that can communicate via communication connections. Therefore, the computing device 5900 can operate in a networked environment using a logical connection with one or more other servers, networked personal computers (PCs) or further general network nodes.

The input device 5950 may be one or more of a variety of input devices, such as a mouse, keyboard, tracking ball, voice-input device, and the like. The output device 5960 may be one or more of a variety of output devices, such as a display, loudspeaker, printer, and the like. By means of the communication unit 5940, the computing device 5900 can further communicate with one or more external devices (not shown) such as the storage devices and display device, with one or more devices enabling the user to interact with the computing device 5900, or any devices (such as a network card, a modem and the like) enabling the computing device 5900 to communicate with one or more other computing devices, if required. Such communication can be performed via input/output (I/O) interfaces (not shown).

In some embodiments, instead of being integrated in a single device, some or all components of the computing device 5900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services.

In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location.

Alternatively, they may be provided from a conventional server or installed directly or otherwise on a client device.

The computing device 5900 may be used to implement video encoding/decoding in embodiments of the present disclosure. The memory 5920 may include one or more video coding modules 5925 having one or more program instructions. These modules are accessible and executable by the processing unit 5910 to perform the functionalities of the various embodiments described herein.

In the example embodiments of performing video encoding, the input device 5950 may receive video data as an input 5970 to be encoded. The video data may be processed, for example, by the video coding module 5925, to generate an encoded bitstream. The encoded bitstream may be provided via the output device 5960 as an output 5980.

In the example embodiments of performing video decoding, the input device 5950 may receive an encoded bitstream as the input 5970. The encoded bitstream may be processed, for example, by the video coding module 5925, to generate decoded video data. The decoded video data may be provided via the output device 5960 as the output 5980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a target number for a set of motion candidates, the target number being smaller than or equal to an upper limit value;
determining, based on the target number and a fast rate distortion optimization (RDO) process, the set of motion candidates from a plurality of motion candidates for an intra block copy (IBC) based mode for coding the current video block; and
performing the conversion based on the set of motion candidates.

2. The method of claim 1, wherein the IBC-based mode comprises one of the following: an IBC merge mode, an IBC template matching (TM) merge mode, or an IBC merge mode with block vector difference (MBVD) mode, or
wherein the fast RDO process is performed based on a sum of absolute difference (SAD) or a sum of absolute transformed difference (SATD), or
wherein the upper limit value is predefined, or
wherein determining the target number comprises:
determining a first number based on a sum of the number of valid candidates in an IBC merge list for the current video block and the number of valid candidates in an IBC-TM merge list for the current video block; and
generating the target number based on the upper limit value and the first number.

3. The method of claim 2, wherein generating the target number comprises:
in accordance with a determination that the first number is larger than or equal to the upper limit value, determining the upper limit value to be the target number; and
in accordance with a determination that the first number is smaller than the upper limit value, determining the first number to be the target number.

4. The method of claim 1, wherein the upper limit value is dependent on a target configuration of a coding process for coding the current video block.

5. The method of claim 4, wherein all of candidate configurations of the coding process are divided into a plurality of sets of candidate configurations, and wherein the plurality of sets of candidate configurations comprise a first set of candidate configurations and a second set of candidate configurations different from the first set of candidate configurations,
if the target configuration is comprised in the first set of candidate configurations, the upper limit value is equal to a first value,
if the target configuration is comprised in the second set of candidate configurations, the upper limit value is equal to a second value.

6. The method of claim 5, wherein the first set of candidate configurations comprises an all intra (AI) configuration, and the second set of candidate configurations comprises a random access (RA) configuration.

7. The method of claim 6, wherein the first set of candidate configurations or the second set of candidate configurations further comprises a first low-delay configuration and a second low-delay configuration.

8. The method of claim 1, wherein the upper limit value is determined adaptively, or
wherein the upper limit value is dependent on a resolution of a picture comprising the current video block, or
wherein the upper limit value is dependent on a type of a slice comprising the current video block, or
wherein the upper limit value is dependent on a coding parameter of the current video block, or
wherein the upper limit value is indicated in the bitstream.

9. The method of claim 1, further comprising:
selecting a set of MBVD candidates from a plurality of MBVD candidates associated with a first IBC base candidate for the current video block, the number of MBVD candidates in the set of MBVD candidates being equal to N and N being a positive integer; and
determining the plurality of motion candidates based on the set of MBVD candidates.

10. The method of claim 9, wherein all of IBC base candidates for the current video block are divided into a plurality of sets of IBC base candidates.

11. The method of claim 10, wherein the plurality of sets of IBC base candidates comprise a first set of IBC base candidates and a second set of IBC base candidates different from the first set of IBC base candidates,
if the first IBC base candidate is comprised in the first set of IBC base candidates, N is equal to a third value,
if the first IBC base candidate is comprised in the second set of IBC base candidates, N is equal to a fourth value.

12. The method of claim 11, wherein the third value is different from the fourth value, or
wherein the third value is the same as the fourth value, or
wherein N is the same for each IBC base candidate in a set of IBC base candidates among the plurality of sets of IBC base candidates.

13. The method of claim 9, wherein N is predefined, or
wherein N is dependent on a target configuration of a coding process for coding the current video block, or
wherein N is dependent on a resolution of a picture comprising the current video block, or
wherein N is dependent on a type of a slice comprising the current video block.

14. The method of claim 9, wherein N is equal to a predetermined number, and the set of MBVD candidates comprises the top N MBVD candidates with the lowest template SAD costs.

15. The method of claim 14, wherein the predetermined number is equal to 8.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
determining a target number for a set of motion candidates, the target number being smaller than or equal to an upper limit value;
determining, based on the target number and a fast rate distortion optimization (RDO) process, the set of motion candidates from a plurality of motion candidates for an intra block copy (IBC) based mode for coding a current video block of the video; and
performing the conversion based on the set of motion candidates.

19. A non-transitory computer-readable storage medium storing instructions that cause a processor to perform acts comprising:
determining a target number for a set of motion candidates, the target number being smaller than or equal to an upper limit value;
determining, based on the target number and a fast rate distortion optimization (RDO) process, the set of motion candidates from a plurality of motion candidates for an intra block copy (IBC) based mode for coding a current video block of the video; and
performing the conversion based on the set of motion candidates.

20. A non-transitory computer-readable recording medium storing a bitstream of a video which is generated by a method performed by an apparatus for video processing, wherein the method comprises:
determining a target number for a set of motion candidates, the target number being smaller than or equal to an upper limit value;
determining, based on the target number and a fast rate distortion optimization (RDO) process, the set of motion candidates from a plurality of motion candidates for an intra block copy (IBC) based mode for coding a current video block of the video; and
generating the bitstream based on the set of motion candidates.
